(19) United States
(12) Patent Application Publication
(10) Pub. No.: US 2021/0163731 A1
(43) Pub. Date: Jun. 3, 2021

(54) TRANSIENT POLYMER FORMULATIONS, ARTICLES THEREOF, AND METHODS OF MAKING AND USING SAME

(71) Applicant: Georgia Tech Research Corporation, Atlanta, GA (US)

(72) Inventors: Paul A. Kohl, Atlanta, GA (US); Anthony Engler, Pearland, TX (US); Jisu Jiang, Atlanta, GA (US); Chi Kin Lo, Atlanta, GA (US); Matthew Warner, Atlanta, GA (US); Oluwadamilola Phillips, Tampa, FL (US)

(21) Appl. No.: 17/042,004

(22) PCT Filed: Mar. 26, 2019
(86) PCT No.: PCT/US2019/024036

§ 371 Date: Sep. 25, 2020

Related U.S. Application Data
(60) Provisional application No. 62/648,088, filed on Mar. 26, 2018.

(51) Int. Cl. C08L 61/02; C08K 5/12; C08K 5/00; C08K 5/3415; C09D 161/02; C08G 2/20; C08J 5/04

(52) U.S. Cl. CPC C08L 61/02; C08K 5/12; C08K 5/0016; C08K 5/3415; C09D 161/02; C08L 27/06; C08J 5/046; C08J 5/043; C08L 2312/00; C08L 2203/16; C08G 2/20

(57) ABSTRACT

Transient polymers and compositions comprising such polymers are described. The polymers are copolymers of phthalaldehyde and one or more additional aldehydes and can degrade/decompose upon exposure to a desired stimulus, like light, heat, sound, or chemical trigger. Films comprising the copolymers and devices comprising surfaces coated with the film are also described.

### CROSS REFERENCE TO RELATED APPLICATIONS

This application claims the benefit of priority to U.S. Provisional Application No. 62/648,088, filed Mar. 26, 2018, which is incorporated by reference herein in its entirety.

### STATEMENT REGARDING FEDERALLY FUNDED RESEARCH

This invention was made with government support under grant numbers HR0011-16-C-0047 and HR0011-16-C-0086 awarded by the Defense Advanced Research Projects Agency. The government has certain rights in the invention.

### FIELD OF THE INVENTION

Transient polymers and compositions comprising such polymers are described. The polymers are copolymers of phthalaldehyde and one or more additional aldehydes and can degrade/decompose upon exposure to a desired stimulus, like light, heat, sound, or chemical trigger. Films comprising the copolymers and devices comprising surfaces coated with the film are also described.

### BACKGROUND

Devices made from polymeric materials are often fabricated with long-life objectives. However, there are devices that have limited mission life or those where recovery of the component is inconvenient or not desired. Such devices can be made from transient polymers where liquification and/or vaporization is preferred over recovery and solid-waste disposal. In addition, there are points during the fabrication of a device where a protective material is needed for a short period of time. After that period of time, the protective material, such as a polymer, is no longer wanted because it has served its purpose and it must be removed.

Transient polymers are those who decompose, dissolve, or depolymerize upon external triggering (such as from an optical, electrical, acoustic, or thermal stimulus), a solvent, or which simply react with time. The goal is to have these devices become invisible on command. Previous studies have shown that polyaldehydes, including poly(phthalaldehyde) and its copolymers with other aldehydes, have a ceiling temperature below room temperature and can be used as transient polymers in fabricating devices. The devices include electronic components (such as printed circuit boards or packages) and larger systems such as drones and parachutes. It has also been shown that there are multiple means of triggering the depolymerization event.

There are multiple objectives in the depolymerization event including: (1) rapid response, (ii) depolymerization into liquid or vapor products at ambient temperature which may be cold (i.e., below the freezing point of water), (iii) remaining stable prior to triggering (i.e., having a long shelf-life prior to triggering), and (iv) achieving adequate mechanical properties (e.g., elastic modulus and toughness) for the device which may be different from those of the pure polymer. Optical triggering with sunlight or artificial light is particularly valuable because of the ease of irradiating a transient polymer with electromagnetic radiation. There are difficulties in simultaneously achieving all the objectives for the transient polymer. For example, at low ambient temperature (e.g., −4° C.) phthalaldehyde (depolymerized product of poly(phthalaldehyde)) is a solid, and chemical reactivity may be slow due to the low temperature. A second example is the mechanical properties of a rigid device are different from those of a foldable or flexible device.

What are thus needed are transient polymers that have suitable mechanical, physical and chemical properties and yet degrade/decompose/dissolve upon exposure to a desired stimulus. Methods of making such polymers and articles comprising such polymers are also needed. The compositions, articles, and methods disclosed herein address these and other needs.

### SUMMARY OF THE INVENTION

Disclosed herein are compounds, compositions, methods for making and using such compounds and compositions. In further aspects, disclosed herein are transient polymers and compositions comprising such polymers. The disclosed polymers can degrade/decompose/dissolve upon exposure to a desired stimulus, like light, heat, sound, solvent, acoustic, or chemical trigger.

Thus, one aspect of the invention relates to a composition comprising:

a) a copolymer, wherein the copolymer comprises a repeating unit as shown in Formula I:

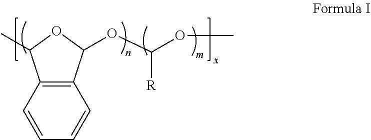

wherein R is substituted or unsubstituted C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R is substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
m is 1 to 100,000;
n is 1 to 100,000; and
x is 1 to 100,000;
b) a plasticizer; and
c) an ionic liquid, wherein the ionic liquid has a weight percent of at least about 40% with respect to the weight of the copolymer.

Another aspect of the invention relates to a film comprising a copolymer, wherein the copolymer comprises a repeating unit as shown in Formula I:

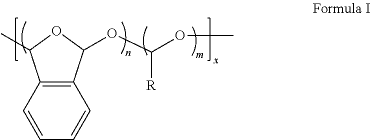

wherein R is substituted or unsubstituted C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R is substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
m is 1 to 100,000;
n is 1 to 100,000; and
x is 1 to 100,000.

Another aspect of the invention relates to an apparatus or device comprising a surface, wherein the surface is at least partially coated with the film of the invention, wherein said film may be later removed. These compositions or devices can comprise additional agents that can alter the physical, chemical, mechanical and/or degradation properties of the copolymers. Examples of such agents disclosed herein are crosslinking agents, crosslinking catalysts, photocatalysts, theremocatalyts, sensitizers, chemical amplifiers, freezing point depressing agent, photo-response delaying agents, and the like.

An additional aspect of the invention relates to a method of transiently protecting a surface from chemical and or physical modification, comprising coating at least part of the surface with the film of the invention.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention

FIG. 1 shows representative NMR spectra of p(PHA-PA) in CDCl₃: (panel a) ¹H-NMR spectra of copolymer series with increasing PA content 3%, 6%, 9%, 12%, 19%, 23%. The arrow shows curves for increasing concentration of PA. Peaks A′ and A″ correspond to the trans and cis configurations of PHA acetal protons; (panel b)¹³C-NMR spectra of p(PHA-PA) and p(PHA) homopolymer. The copolymer is the upper curve (seen at 110 ppm) and the homopolymer is the lower curve.

FIG. 2 shows a reactivity study of PHA based copolymers with aliphatic aldehydes: (panel a) copolymer composition profiles, where the best fit line through the origin is taken as the experimental incorporation ratio; (panel b) Correlation of aliphatic aldehydes' incorporation ratios with their corresponding hydration equilibrium constant (K_{H}).

FIG. 3 shows trends of polyaldehyde copolymers with incorporation of the aliphatic aldehyde (F_{B}): (panel a) Mₙ from GPC; (panel b) copolymerization gravimetric yield.

FIG. 4 shows p(PHA-PAA) copolymer series at different initial monomer concentrations. All copolymerizations were charged with f_{B}=50%.

FIG. 5 shows the storage modulus from DMA frequency sweep of crosslinked p(PHA-UE) films exposed to different doses (mJ/cm²) of light centered at 248 nm.

FIG. 6 shows isothermal TGA traces for p(PHA-TsBA), dotted lines, at several temperatures compared to p(PHA) and p(PHA-BA), solid lines, at 80° C.

FIG. 7 shows DSC measurement of freezing point and melting point of PHA monomer with ramp rate of 5° C./min.

FIG. 8 shows a TGA plot of PPHA with 20 pphr of loadings of various plasticizers.

FIG. 9 shows the effect of individual plasticizer on storage modulus of PPHA films.

FIG. 10 shows the storage modulus for PPHA films containing 70 pphr OMP with different loadings of BEHP.

FIG. 11 shows damping (tan(δ)) for PPHA films containing 70 pphr OMP with different loadings of BEHP.

FIG. 12 shows a tensile test for PPHA films containing 70 pphr OMP with different loadings of BEHP at a strain rate of 10%/min.

FIG. 13a shows yield stress for PPHA films containing 70 pphr OMP with different loadings of BEHP.

FIG. 13b shows percentage strain to break for PPHA films containing 70 pphr OMP with different loadings of BEHP.

FIG. 14 shows freezing point and melting point measured from DSC for PHA mixed with various plasticizer containing various loadings (panels a-d).

FIG. 15 shows oxide growth on c-Si wafers coated or uncoated with PPHA in air before etching.

FIG. 16 shows oxide growth on c-Si wafers coated or uncoated with PPHA in air before etching.

FIG. 17 shows oxide growth on c-Si wafers coated or uncoated with PPHA in air after etching.

FIG. 18 shows oxide growth on c-Si wafers coated or uncoated with PPHA in a glove box before etching.

FIG. 19 shows oxide growth on c-Si wafers coated or uncoated with PPHA in a glove box before etching.

FIG. 20 shows oxide growth on c-Si wafers coated or uncoated with PPHA in a glove box after etching.

FIG. 21 shows the effect of PPHA coating thickness on oxide growth on SiGe wafers.

### DETAILED DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### General Definitions

In this specification and in the claims that follow, reference will be made to a number of terms, which shall be defined to have the following meanings:

Throughout the specification and claims the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the polymer” includes mixtures of two or more such polymers, and the like.

“Optional” or “optionally” means that the subsequently described event or circumstance can or cannot occur, and that the description includes instances where the event or circumstance occurs and instances where it does not.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Unless stated otherwise, the term “about” means within 10% (e.g., within 5%, 2%, or 1%) of the particular value modified by the term “about.”

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### Chemical Definitions

As used herein, the term “composition” is intended to encompass a product comprising the specified ingredients in the specified amounts, as well as any product which results, directly or indirectly, from combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight component Y, X and Y are present at a weight ratio of 2:5, and are present in such ratio regardless of whether additional components are contained in the mixture.

A weight percent (wt. %) of a component, unless specifically stated to the contrary, is based on the total weight of the formulation or composition in which the component is included. Alternatively, a weight percent (wt. %) can be stated with respect to only one component. For example, compounds Y and Z can each be included in a mixture at 5 wt. % with respect to compound X. In this case, if there were 100 g of X, there would be 5 g each of Y and Z.

A mole percent (mol %) of a component, unless specifically stated to the contrary, is based on the total number of moles of each unit of the formulation or composition in which the component is included.

As used herein, “molecular weight” refers to number-average molecular weight which is sometimes measured by ¹H NMR spectroscopy, gel permeation chromatography, or other analytical methods, unless clearly indicated otherwise.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

The term “transient” as used herein with respect to a polymer or film refers to polymer or film that exists temporarily in that can decompose, depolymerize, or change state in response to a trigger at a desired time.

The term “monomer” as used herein refers to one of the constituent units used to synthesize a polymer.

The term “photocatalyst” as used herein refers a molecule, ion, complex, or other chemical unit capable of catalyzing a reaction where the photocatalyst is formed by the absorption of electromagnetic radiation, whether the electromagnetic radiation is absorbed directly by that molecule or another with energy transfer between the two.

The term “thermocatalyst” as used herein refers a molecule, ion, complex, or other chemical unit capable of catalyzing a reaction where the thermocatalyst is formed by the application of heat.

The term “sensitizer” as used herein refers a molecule, ion, complex, or other chemical unit which can absorb energy, such as electromagnetic radiation, and transfer that energy to another chemical unit, such as a photocatalyst or thermocatalyst.

The term “plasticizer” as used herein refers to a substance added to a copolymer composition to produce or promote plasticity and flexibility and to reduce brittleness of the copolymer and/or films comprising the copolymer.

The term “ionic liquid” as used herein refers a molecule (a salt) which is in the form of a liquid at temperatures below 100° C., where at least part of the liquid is in the form of ions.

The term “chemical amplifier” as used herein refers a molecule, ion, complex, or other chemical unit capable of generating one or more of a particular species when activated by a similar species.

The term “acid amplifier” as used herein refers a molecule, ion, complex, or other chemical unit capable of generating one or more Lewis or Bronsted acids when activated by a Lewis or Bronsted acid.

The term “crosslinking catalyst” as used herein refers a molecule, ion, complex, or other chemical unit capable of catalyzing the chemical reaction between two moieties of the polymer resulting in linking two or more parts of the same polymer chain or two or more different chemical chains.

The term “crosslinking agent” as used herein refers a molecule, ion or other chemical unit capable of forming a chemical unit linking two or more parts of the same polymer chain or two or more different chemical chains.

The term “aliphatic” as used herein refers to a non-aromatic hydrocarbon group and includes branched and unbranched, alkyl, alkenyl, or alkynyl groups.

The term “alkyl” as used herein is a branched or unbranched saturated hydrocarbon group of 1 to 20 carbon atoms, e.g., 1 to 12, 1 to 10, or 1 to 8 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “heteroalkyl” as used herein is a branched or unbranched saturated hydrocarbon group of 1-20 carbon atoms, e.g., 1 to 12, 1 to 10, or 1 to 8 carbon atoms, where one or more of the carbon atoms and its attached hydrogen atoms, if any, have been replaced by an O, S, N, or NH. The heteroalkyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described below.

The symbols Aⁿ is used herein as merely a generic substituent in the definitions below.

The term “alkoxy” as used herein is an alkyl group bound through a single, terminal ether linkage; that is, an “alkoxy” group can be defined as —OA¹ where A¹ is alkyl as defined above.

The term “alkenyl” as used herein is a branched or unbranched hydrocarbon group of from 2 to 20 carbon atoms, e.g., 2 to 12, 2 to 10, or 2 to 8 carbon atoms, with a structural formula containing at least one carbon-carbon double bond. Asymmetric structures such as (A¹A₂)C═C(A³A⁴) are intended to include both the E and Z isomers. This may be presumed in structural formulae herein wherein an asymmetric alkene is present, or it may be explicitly indicated by the bond symbol C═C. Non-limiting examples of alkenyl include ethenyl (vinyl), 1-propenyl, 2-propenyl (allyl), iso-propenyl, 2-methyl-1-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-dodecenyl, 2-dodecenyl, 3-dodecenyl, 4-dodecenyl, 5-dodecenyl, 6-dodecenyl, 7-dodecenyl, 8-dodecenyl, 9-dodecenyl, 10-dodecenyl, and 11-dodecenyl. The alkenyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described below.

The term “alkynyl” as used herein is a branched or unbranched hydrocarbon group of 2 to 20 carbon atoms, e.g., 2 to 12, 2 to 10, or 2 to 8 carbon atoms, with a structural formula containing at least one carbon-carbon triple bond. Non-limiting examples of C₂-C₁₂ alkenyl include ethynyl, propynyl, butynyl, pentynyl and the like. The alkynyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described below.

The term “aryl” as used herein is a group that contains any carbon-based aromatic group having 6-10 carbon atoms and including, but not limited to, benzene, naphthalene, phenyl, biphenyl, phenoxybenzene, aceanthrylene, acenaphthylene, acephenanthrylene, anthracene, azulene, chrysene, fluoranthene, fluorene, as-indacene, s-indacene, indane, indene, phenalene, phenanthrene, pleiadene, pyrene, and triphenylene, and the like. The term “heteroaryl” is defined as a group that contains an aromatic group with 6-10 carbon atoms that has at least one heteroatom incorporated within the ring of the aromatic group. Examples of heteroatoms include, but are not limited to, nitrogen, oxygen, sulfur, and phosphorus. Examples of heteroaryls include, but are not limited to, azepinyl, acridinyl, benzimidazolyl, benzothiazolyl, benzindolyl, benzodioxolyl, benzofuranyl, benzooxazolyl, benzothiazolyl, benzothiadiazolyl, benzo[b][1,4]dioxepinyl, 1,4-benzodioxanyl, benzonaphthofuranyl, benzoxazolyl, benzodioxolyl, benzodioxinyl, benzopyranyl, benzopyranonyl, benzofuranyl, benzofuranonyl, benzothienyl (benzothiophenyl), benzotriazolyl, benzo[4,6]imidazo[1,2-a]pyridinyl, carbazolyl, cinnolinyl, dibenzofuranyl, dibenzothiophenyl, furanyl, furanonyl, isothiazolyl, imidazolyl, indazolyl, indolyl, indazolyl, isoindolyl, indolinyl, isoindolinyl, isoquinolyl, indolizinyl, isoxazolyl, naphthyridinyl, oxadiazolyl, 2-oxoazepinyl, oxazolyl, oxiranyl, 1-oxidopyridinyl, 1-oxidopyrimidinyl, 1-oxidopyrazinyl, 1-oxidopyridazinyl, 1-phenyl-1H-pyrrolyl, phenazinyl, phenothiazinyl, phenoxazinyl, phthalazinyl, pteridinyl, purinyl, pyrrolyl, pyrazolyl, pyridinyl, pyrazinyl, pyrimidinyl, pyridazinyl, quinazolinyl, quinoxalinyl, quinolinyl, quinuclidinyl, isoquinolinyl, tetrahydroquinolinyl, thiazolyl, thiadiazolyl, triazolyl, tetrazolyl, triazinyl, and thiophenyl (i.e., thienyl). The term “non-heteroaryl,” which is included in the term “aryl,” defines a group that contains an aromatic group that does not contain a heteroatom. The aryl and heteroaryl group can be substituted or unsubstituted. The aryl and heteroaryl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of 3-10 carbon atoms, e.g., 3-8 or 3-6 carbon atoms. Examples of cycloalkyl groups include, but are not limited to, cyclopropyl, cyclobutyl, cyclopentyl, and cyclohexyl. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein.

The term “heterocycloalkyl” is a type of cycloalkyl group as defined above where at least one of the carbon atoms and its attached hydrogen atoms, if any, are replaced by 0, S, N, or NH. The heterocycloalkyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein.

The term “cycloalkenyl” as used herein is a non-aromatic carbon-based ring composed of 3-10 carbon atoms, e.g., 3-8 or 3-6 carbon atoms, and containing at least one double bond, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like.

The term “heterocycloalkenyl” is a type of cycloalkenyl group as defined above where at least one of the carbon atoms of the ring is substituted with O, S, N, or NH. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” is a short hand notation for C═O, which is also referred to as a carbonyl.

The terms “amine” or “amino” as used herein are represented by the formula NA¹A²A³, where A¹, A², and A³ can be, independently, hydrogen, an alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” as used herein is represented by the formula —C(O)O⁻.

The term “ester” as used herein is represented by the formula —OC(O)A¹ or —C(O)OA¹, where A¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula A¹OA², where A¹ and A² can be, independently, an alkyl, alkenyl, alkynyl, aryl, heteroaryl, cycloalkyl, cycloalkenyl, heterocycloalkyl, or heterocycloalkenyl group described above.

The term “ketone” as used herein is represented by the formula A¹C(O)A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” as used herein refers to the halogens fluorine, chlorine, bromine, and iodine.

The term “hydroxyl” as used herein is represented by the formula —OH.

The term “nitro” as used herein is represented by the formula —NO₂.

The term “cyano” as used herein is represented by the formula —CN

The term “azido” as used herein is represented by the formula —N₃.

The term “sulfonyl” is used herein to refer to the sulfo-oxo group represented by the formula —S(O)₂A¹, where A¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “sulfinyl” is used herein to refer to the sulfo-oxo group represented by the formula —S(O)A¹, where A¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term sulfinic acid” as used herein is represented by the formula —S(O)OH.

The term “sulfonic acid” as used herein is represented by the formula —S(O)₂OH.

The term “phosphonic acid” as used herein is represented by the formula —P(O)(OH)₂.

The term “thiol” as used herein is represented by the formula —SH.

The term “copolymer” is used herein to refer to a macromolecule prepared by polymerizing two or more different monomers. The copolymer can be a random, block, or graph copolymer.

The term “quaternary ammonium” as used herein is represented by the formula NA₄⁺ where A can be hydrogen or hydrocarbons.

The term “sulfonium” as used herein is represented by the formula SA₃⁺ where A can be hydrogen or hydrocarbons.

It is to be understood that the compounds provided herein may contain chiral centers. Such chiral centers may be of either the (R-) or (S-) configuration. The compounds provided herein may either be enantiomerically pure, or be diastereomeric or enantiomeric mixtures. It is to be understood that the chiral centers of the compounds provided herein may undergo epimerization in vivo. As such, one of skill in the art will recognize that administration of a compound in its (R-) form is equivalent, for compounds that undergo epimerization in vivo, to administration of the compound in its (S-) form.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound may, however, be a mixture of stereoisomers.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

As used herein, the symbol “ [symbol] ” (hereinafter can be referred to as “a point of attachment bond”) denotes a bond that is a point of attachment between two chemical entities, one of which is depicted as being attached to the point of attachment bond and the other of which is not depicted as being attached to the point of attachment bond. For example, “ [symbol] ” indicates that the chemical entity “XY” is bonded to another chemical entity via the point of attachment bond. Furthermore, the specific point of attachment to the non-depicted chemical entity can be specified by inference. For example, the compound CH₃-A¹, wherein A¹ is H or “ [symbol] ” infers that when A¹ is “XY”, the point of attachment bond is the same bond as the bond by which A¹ is depicted as being bonded to CH₃.

Reference will now be made in detail to specific aspects of the disclosed materials, compounds, compositions, articles, and methods, examples of which are illustrated in the accompanying Examples.

### Polyaldehyde Copolymers

Polymers with a low ceiling temperature are of value in components where the planned depolymerization of the polymer is desirable. Exemplary devices include polymer-based components and enclosures for electronic sensors, unmanned aircraft, and parachutes. Other applications include drug delivery, dry developing photoresists, temporary spatial placeholders, transient electronics, and recyclable plastics. In each of these devices or applications, it may be desirable to have the polymer disappear through depolymerization and evaporation of the volatile monomer, or simply have the monomer liquid flow harmlessly into the ground. The disappearance of the polymer device avoids disposal in a landfill or avoids detection of even the presence of the device. Depolymerization can be triggered by thermal, chemical, photo, or acoustic events. Polymers where decomposition is a planned event are sometimes called sacrificial polymers.

Polyaldehydes have been shown to have a low ceiling temperature and can be synthesized with a high molecular weight (Schwartz, J. M.; et al., Determination of ceiling temperature and thermodynamic properties of low ceiling temperature polyaldehydes. J. Polym. Sci. Part A: Polym. Chem. 2017, doi:10.1002/pola.28888). However, in order to be useful in specific applications requiring mechanical strength or toughness, the physical properties of the polyaldehyde polymer need to be improved. Poly(phthalaldehyde) has a low ceiling temperature of about −40° C., above which the polymer can rapidly depolymerize back to monomer; however, it has only modest elastic modulus and toughness. One measure of the toughness is the elongation-to-break, which can be measured by stretching it and recording the percent elongation at brittle fracture.

Selecting aldehyde monomers with high vapor pressure at the desired transience temperature, which can also be kinetically trapped as polymers with suitable mechanical properties until triggered (above Tₐ), is challenging. Aliphatic aldehydes have a tendency to form highly crystalline polymers that become insoluble in common organic solvents (Strahan, J. R. Advanced Organic Materials for Lithographic Applications, University of Texas at Austin, 2010; Vogl, O., Polymerization of Higher Adlehydes. IV. Crystalline Isotactic Polyaldehydes: Anionic and Cationic Polymerization. J. Polym. Sci. Part A Polym. Chem. 1964, 2:4607-4620). This insolubility can cause growing chains to precipitate out of solution during polymerization before being kinetically stabilized, especially at high molecular weights. Further, solvent insolubility prevents solvent casting the polymer into its functional shapes. Monomers that form an amorphous polymer, which remain solvent soluble, tend to have low vapor pressure (Id.). Low vapor pressure limits the applications of the transient polymer to situations that allow long times for transience. One approach to avoiding polymer crystallization and long monomer evaporation time is to use copolymers with one monomer that forms amorphous polymers and another that has high vapor pressure. The crystallinity of the polymer can be disrupted by a larger monomer increasing solubility and maintaining moderate vapor pressure at the transient temperature.

High molecular weight polyaldehydes have not been achieved through anionic polymerization of aliphatic aldehydes (Vogl, O.; Bryant, W. Polymerization of Higher Aldehydes. VI. Mechanism of Aldehyde Polymerization. J. Polym. Sci. Part A Poly. Chem. 1964, 2:4633-4645). The acidic a-protons of the aldehyde inhibits chain propagation and acts as a chain transfer agent, creating a new initiation site for polymer propagation (Id.). This interruption of a growing chain causes the molecular weights to be relatively low and creates high dispersity. On the other hand, a cationic growth mechanism is capable of achieving high molecular weight polyaldehydes.

The challenges of preparing and utilizing polyaldehydes are addressed herein, resulting in various transient polyaldehyde copolymers that have sufficient strength and toughness for a variety of applications, and that can be triggered to decompose with a variety of stimuli. Specifically, disclosed herein are cyclic copolymers of phthalaldehyde (PHA) and one or more different aldehyde monomers. The second (and further) monomer(s) can be used to improve the evaporation rate of the depolymerized polymer or used to carry out cross-linking of the polymer, thus changing its mechanical properties. The second (and further) monomer(s) can also be used to depress the freezing point of the decomposed materials, or to delay the depolymerization rate. In specific aspects, the disclosed copolymers comprises monomers of phthalaldehyde and one or more different aldehyde monomers, with substantially no other types of monomer residues besides aldehydes, e.g., there is less than 5 mol %, less than 4 mol %, less than 3 mol %, less than 2 mol %, less than 1 mol %, less than 0.5 mol %, or 0 mol % of monomer residues in the copolymer other than phthalaldehyde and the other aldehyde monomer(s). Of course, compositions can be prepared with the disclosed copolymers and the compositions can comprise additional materials and agents to modify the composition as disclosed herein.

In certain aspects, the disclosed copolymers can have a repeating unit as shown in Formula I:

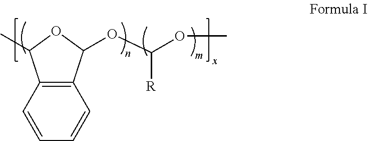

wherein R can be substituted or unsubstituted C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R can be substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, amino, sulfonic acid, sulfinic acid, fluoroacid, phosphonic acid, ether, halide, hydroxy, ketone, nitro, cyano, azido, silyl, sulfonyl, sulfinyl, or thiol; m is 1 to 100,000; n is 1 to 100,000; and x is 1 to 100,000. In some embodiments, m, n, and/or x independently can be about 1, 10, 50, 100, 250, 500, 1000, 1500, 2500, 5000, 10,000, 25,000, 50,000, 100,000, 200,000, 300,000, 400,000, 500,000, or any range therein.

In some examples, the disclosed copolymers are linear or branched copolymers. In other examples, the copolymers disclosed herein can have a cyclic structure. That is, the copolymers contain substantially no reactive end groups on the polymer backbone. The lack of aldehyde end groups can be confirmed by analysis of low-molecular weight polyaldehydes that reveal only the chemical shifts associated with the aldehyde backbone. Thus, when cyclic, the disclosed copolymers can comprise a polymeric backbone, which is not limited by length or arrangement of aldehyde monomers. In some examples, the polymeric backbone can comprise any one or any combination of the following repeating units:

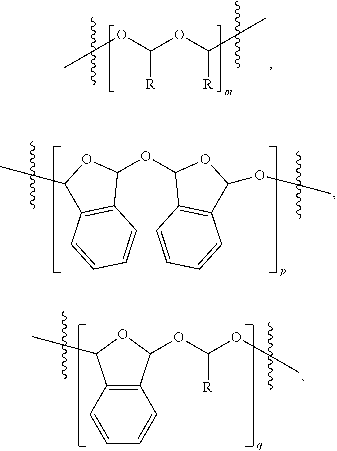

where m can be an integer from 1 to 100,000; p can be an integer from 1 to 100,000; and q can be an integer from 1 to 100,000. In these examples, the disclosed copolymers can be a copolymer of phthalaldehyde and one other aldehyde.

In other examples, the disclosed copolymers can be a copolymer of phthalaldehyde and two different aldehydes (i.e., a terpolymer). In still other examples, the disclosed copolymers can be a copolymer of phthalaldehyde and three or more different aldehydes. In some examples where the disclosed copolymers comprise repeating units derived from three different aldehyde monomers, PHA and two other aldehydes. These copolymers can also be linear or branched copolymers. In some examples, these copolymers can be cyclic and can have Formula II:

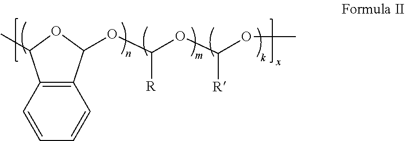

wherein n can be an integer of from 1 to 100,000; R and R′ can be different; R can be chosen from C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R can be substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, amino, sulfonic acid, sulfinic acid, fluoroacid, phosphonic acid, ether, halide, hydroxy, ketone, nitro, cyano, azido, silyl, sulfonyl, sulfinyl, or thiol; and R′ can be chosen from substituted or unsubstituted C₁-C₂₀ alkyl, C₁-C₂₀ alkoxyl, C₂-C₂₀ alkenyl, C₂-C₂₀ alkynyl, C₆-C₁₀ aryl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R′ can be substituted with C₁-C₂₀ alkyl, C₁-C₂₀ alkoxy, C₂-C₂₀ alkenyl; C₂-C₂₀ alkynyl, C₆-C₁₀ aryl, C₆-C₁₀ heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol; k is 1 to 100,000; m is 1 to 100,000; n is 1 to 100,000; and x is 1 to 100,000. In these examples, the backbone of the copolymer can comprise any one or any combination of the following repeating units:

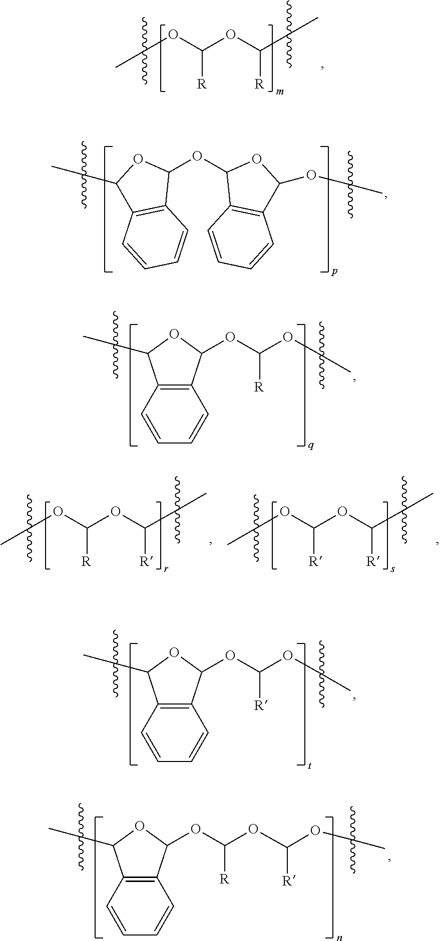

where n can be an integer from 1 to 100,000; m can be an integer from 1 to 100,000; p can be an integer from 1 to 100,000; q can be an integer from 1 to 100,000; r can be an integer from 1 to 100,000; s can be an integer from 1 to 100,000; and t can be an integer from 1 to 100,000.

In specific examples of copolymers disclosed herein, R and/or R′ can be chosen from C₁-C₁₀ alkyl, C₂-C₁₀ alkenyl, or C₂-C₁₀ alkynyl, or cycloalkenyl, or heterocycloalkenyl. In more specific examples, R and/or R′ can be C₁-C₆ alkyl or C₁-C₆ alkenyl. In some embodiments, R and/or R′ can be an unsubstituted C₂-C₂₀ alkenyl, unsubstituted C₂-C₂₀ alkynyl, unsubstituted, cycloalkenyl, unsubstituted heterocycloalkenyl, C₆-C₁₀ heteroaryl; or R is C₁-C₂₀ alkyl, C₃-C₁₀ cycloalkyl, or C₃-C₁₀ heterocycloalkyl substituted with amino, sulfonic acid, sulfinic acid, fluoroacid, phosphonic acid, ester, halide, hydroxyl, ketone, nitro, cyano, azido, thiol, sulfonic acid, or fluoroacid. In other examples, the disclosed copolymer is a copolymer of PHA and one or more of acetaldehyde, propanal, butanal, pentanal, hexanal, heptanal, octanal, nonanal, decanal, undecanal, propenal, butenal, pentenal, hexenal, heptenal, octenal, nonenal, decenal, undecenal, and any combination thereof.

In some embodiments, the copolymer is synthesized from a hydrophobic aldehyde monomer. Copolymer films that contain more hydrophobic monomers can help reduce the solubility and diffusivity of water inside the films, which in turn decreases the permeation rate. Hydrophobic aldehyde monomers are those which have little affinity for water and do not readily absorb large quantities of water. Examples include, without limitation, 4-chlorobutanal and 2,2-dichlorobutanal.

In some embodiments, the copolymer is synthesized from a volatile aldehyde monomer. Volatile aldehyde monomers are those that convert to a gas (e.g., through evaporation or sublimation) at a suitable low temperature. Volatile aldehydes have a melting point at or below 20° C. Examples include, without limitation, propanal, butanal, and pentanal whose melting points are −81° C., −97° C. and −60° C., respectively.

The disclosed copolymers can have a ratio of phthalaldehyde units to other aldehyde units of from about 1:50 to about 100:1. By phthalaldehyde unit within the polymer is meant:

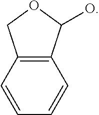

By aldehyde unit within the polymer is meant:

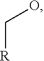

where R is as defined herein. For example, the ratio of phthalaldehyde units to other aldehyde units is about 1:50; 1:45; 1:40; 1:35; 1:30; 1:25; 1:20; 1:15; 1:10; 1:5; 1:1, 5:1; 10:1; 15:1; 20:1; 25:1; 30:1; 35:1; 40:1; 45:1, 50:1; 55:1; 60:1; 65:1; 70:1; 75:1; 80:1; 85:1; 95:1; or 100:1. In more specific examples, the ratio of phthalaldehyde units to other aldehyde units is about 25:1 to about 1:1, from about 15:1 to about 5:1, or from about 10:1 to about 5:1.

In further examples, the disclosed copolymers can comprise 30 mol % or more phthalaldehyde units based on total monomer weight (e.g., 35 mol % or more, 40 mol % or more, 45 mol % or more, 50 mol % or more, 55 mol % or more, 60 mol % or more, 65 mol % or more, 70 mol % or more, 75 mol % or more, 80 mol % or more, 85 mol % or more, 90 mol % or more, 95 mol % or more, 97 mol % or more, or 99 mol % or more). In some examples, the copolymer can comprise from 99 mol % or less phthalaldehyde units based on the total monomer weight (e.g., 97 mol % or less, 95 mol % or less, 90 mol % or less, 85 mol % or less, 80 mol % or less, 75 mol % or less, 70 mol % or less, 65 mol % or less, 60 mol % or less, 55 mol % or less, 50 mol % or less, 45 mol % or less, 40 mol % or less, or 35 mol % or less). The amount of phthalaldehyde units in the copolymer can range from any of the minimum values described above to any of the maximum values described above. For example, the copolymer can comprise from 30 mol % to 99 mol % phthalaldehyde units based on the total monomer content (e.g., from 60 mol % to 99 mol %, from 70 mol % to 97 mol %, from 80 mol % to 95 mol %, from 85 mol % to 99 mol %, from 90 mol % to 99 mol %, or from 80 mol % to 90 mol %).

In certain examples, the other aldehyde(s) in the copolymer can be selected from substituted or unsubstituted C₁-C₂₀ alkyl aldehyde, C₂-C₂₀ alkenyl aldehyde, C₂-C₂₀ alkynyl aldehyde, C₆-C₁₀ aryl aldehyde, C₆-C₁₀ heteroaryl aldehyde, C₃-C₁₀ cycloalkyl aldehyde, C₃-C₁₀ cycloalkenyl aldehyde, C₃-C₁₀ heterocycloalkyl aldehyde, and C₃-C₁₀ heterocycloalkenyl aldehyde. In particular examples, the other aldehyde can be a C₂-C₁₀ alkyl aldehyde, e.g., propylaldehyde, butylaldehyde, pentylaldehyde, or hexylaldehyde. In still other examples, the other aldehyde can be C₃-C₁₀ alkenyl aldehyde or C₃-C₁₀ alkynyl aldehyde. The presence of unsaturation in these monomers can be useful for crosslinking or other modifications as disclosed elsewhere herein. In further examples, the other aldehyde can be C₂-C₁₀ alkyl aldehyde substituted with a reactive group such as an alcohol, thiol, amine, azide, nitrile, carbonyl, imine, or halogen. In further examples, the other aldehyde (e.g., R) can be C₂-C₁₀ alkyl aldehyde substituted with acid, e.g., a sulfonic acid, sulfinic acid, fluoroacid, or phosphonic acid.

Molecular weight of the disclosed copolymers can be 500 g/mol or more (e.g., 1,000 g/mol or more; 2,000 g/mol or more; 4,000 g/mol or more; 6,000 g/mol or more; 8,000 g/mol or more; 10,000 g/mol or more; 12,000 g/mol or more; 14,000 g/mol or more; 16,000 g/mol or more; 18,000 g/mol or more, 20,000 g/mol or more; 25,000 g/mol or more, 30,000 g/mol or more, 50,000 g/mol or more; 100,000 g/mol or more; 150,000 g/mol or more; 200,000 g/mol or more; 250,000 g/mol or more; 500,000 g/mol or more; 1,000,000 g/mol or more; 1,500,000 g/mol or more; or 2,000,000 g/mol or more). It is noted that the term Dalton (Da) can be used in place of g/mol or kilo-Dalton (kDa) in place of kg/mol.

In some examples, the disclosed copolymers can have a molecular weight of 2,000,000 g/mol or less (e.g., 1,500,000 g/mol or less; 1,000,000 g/mol or less; 500,000 g/mol or less; 250,000 g/mol or less; 200,000 g/mol or less; 150,000 g/mol or less; 100,000 g/mol or less; 50,000 g/mol or less; 30,000 g/mol or less, 25,000 g/mol or less, 20,000 g/mol or less; 18,000 g/mol or less; 16,000 g/mol or less; 14,000 g/mol or less; 12,000 g/mol or less; 10,000 g/mol or less; 8,000 g/mol or less; 6,000 g/mol or less; 4,000 g/mol or less; 2,000 g/mol or less; 1,000 g/mol or less; or 500 g/mol or less).

The molecular weight of the disclosed copolymers can range from any of the minimum values described above to any of the maximum values described above. For example, the molecular weight of the copolymer can be from 500 g/mol to 2,000,000 g/mol or any range therein (e.g., from 2,000 g/mol to 1,500,000 g/mol; from 10,000 g/mol to 1,000,000 g/mol; from 20,000 g/mol to 500,000 g/mol; from 50,000 g/mol to 250,000 g/mol; from 100,000 g/mol to 2,000,000 g/mol; from 5,000 g/mol to 18,000 g/mol; from 12,000 g/mol to 50,000 g/mol; from 2,000 g/mol to 50,000 g/mol, from 2,000 g/mol to 25,000 g/mol, from 2,000 g/mol to 20,000 g/mol, from 5,000 g/mol to 20,000 g/mol, from 5,000 g/mol to 15,000 g/mol, or from 10,000 g/mol to 20,000 g/mol).

Density of the disclosed copolymers can be about 0.9 g/cm³ or more (e.g., about 1.0 g/cm³; 1.1 g/cm³; 1.2 g/cm³; 1.3 g/cm³; 1.4 g/cm³; or 1.5 g/cm³). In some examples, the disclosed copolymers can have a density of about 1.5 g/cm³ or less (e.g., about 1.4 g/cm³; 1.3 g/cm³; 1.2 g/cm³; 1.1 g/cm³; 1.0 g/cm³; or 0.9 g/cm³). The density of the disclosed copolymers can range from any of the minimum values described above to any of the maximum values described above. For example, the density of the copolymer can be from about 0.9 g/cm³ to about 1.5 g/cm³ or any range therein (e.g., from about 0.9 g/cm³ to about 1.2 g/cm³; from about 1.1 g/cm³ to about 1.4 g/cm³; from about 1.3 g/cm³ to about 1.5 g/cm³).

The disclosed copolymers have can have a ceiling temperature below ambient temperature, e.g., 0° C. or below, −10° C. or below, −20° C. or below, −30° C. or below, −40° C. or below, or −50° C. or below. In specific examples, the disclosed copolymers can have a ceiling temperature of from ambient temperature to −50° C., from ambient temperature to −40° C., from ambient temperature to −30° C., from ambient temperature to −20° C., from ambient temperature to −10° C., from ambient temperature to 0° C., from 0° C. to −50° C., from 0° C. to −40° C., from 0° C. to −30° C., from 0° C. to −20° C., from 0° C. to −10° C., from −10° C. to −50° C., from −10° C. to −40° C., from −10° C. to −30° C., from −10° C. to −20° C., from −20° C. to −50° C., from −20° C. to −40° C., from −20° C. to −30° C., from −30° C. to −50° C., from −30° C. to −40° C., or from −40° C. to −50° C. Ceiling temperatures can be measured from in-situ NMR polymerization by measuring equilibrium monomer concentrations at various temperatures where polymer can form. They are also measured by polymer yield experiments from polymerizations run to equilibrium at various temperatures.

The disclosed copolymers, in some examples, can also have low polydispersity or be substantially monodisperse. The terms “low polydispersity” and “substantially monodisperse” are used interchangeably to refer to a polydispersity index (PDI), defined as the ratio of the weight average molecular weight to the number average molecular weight, of from 1 to 3.0. In certain examples, the disclosed copolymers can have a PDI, of 1 or more (e.g., 1.1 or more, 1.2 or more, 1.3 or more, 1.4 or more, 1.5 or more, 1.6 or more, 1.7 or more, 1.8 or more, 1.9 or more, 2.0 or more, 2,2 or more, or 2.5 or more). In some examples, the copolymers can have a PDI of 3.0 or less (e.g., 3.0 or less, 2.5 or less, 2.2 or less, 2.0 or less. 1.9 or less, 1.8 or less, 1.7 or less, 1.6 or less, 1.5 or less, 1.4 or less, 1.3 or less, 1.2 or less, 1.1 or less, or 1.05 or less). The PDI of the disclosed copolymers can range from any of the minimum values described above to any of the maximum values described above. For example, the composite prepolymer can have a PDI from 1 to 3.0 (e.g., from 1.05 to 2.0, from 1.2 to 1.9, from 1 to 1.9, from 1.1 to 1.8 from 1.2 to 1.7, from 1.3 to 1.6, from 1.4 to 1.5, from 1.5 to 2.0, from 1.7 to 2.0, from 1 to 1.3, or from 1.5 to 1.8). In other examples, the disclosed copolymers can have high polydispersity (e.g., PDI greater than 3.0), especially when the copolymers are intercollated.

In some examples, the disclosed copolymers can have a strength of 1 gigapascals (GPa) or more (e.g., 1.5 GPa or more, 2 GPa or more, 2.5 GPa or more, 3 GPa or more, 3.5 GPa or more, 4 GPa or more, 4.5 GPa or more, 5 GPa or more, 5.5 GPa or more, 6 GPa or more, 6.5 GPa or more, 7 GPa or more, 7.5 GPa or more, 8 GPa or more, 8.5 GPa or more, 9 GPa or more, or 9.5 GPa or more). In some examples, the disclosed copolymers can have a strength of 10 GPa or less (e.g., 9.5 GPa or less, 9 GPa or less, 8.5 GPa or less, 8 GPa or less, 7.5 GPa or less, 7 GPa or less, 6.5 GPa or less, 6 GPa or less, 5.5 GPa or less, 5 GPa or less, 4.5 GPa or less, 4 GPa or less, 3.5 GPa or less, 3 GPa or less, 2.5 GPa or less, 2 GPa or less, or 1.5 GPa or less). The strength of the disclosed copolymers can range from any of the minimum values described above to any of the maximum values described above, for example from 1 GPa to 10 GPa (e.g., from 1 GPa to 5 GPa, from 5 GPa to 10 GPa, from 1 GPa to 2.5 GPa, from 2.5 GPa to 5 GPa, from 5 GPa to 7.5 GPa, from 7.5 GPa to 10 GPa, from 2 GPa to 9 GPa, or from 2 GPa to 3 GPa).

In some examples, the disclosed copolymers can have an elongation to break of 0.3% or more, e.g., 0.4% or more, 0.5% or more, 0.6% or more, 0.7% or more, 0.8% or more, 0.9% or more, 1.0% or more, 1.1% or more, 1.2% or more, 1.3% or more, or 1.4% or more. In further examples, the disclosed copolymer can have an elongation to break of 1.5% or less, e.g., 1.4% or less, 1.3% or less, 1.2% or less, 1.1% or less, 1.0% or less, 0.9% or less, 0.8% or less, 0.7% or less, 0.6% or less, 0.5% or less, or 0.4% or less. The elongation to break of the disclosed copolymers can range from any of the minimum values described above to any of the maximum values described above, for example from 0.3% to 1.5%, for example, from 0.3% to 1.2%, or from 0.3% to 1.0%.

In some examples, the disclosed copolymers can have an elastic modulus of 0.5 GPa or more, e.g., 0.6 GPa or more, 0.7 GPa or more, 0.8 GPa or more, 0.9 GPa or more, 1.0 GPa or more, 1.1 GPa or more, 1.2 GPa or more, 1.3 GPa or more, 1.4 GPa or more, 1.5 GPa or more, 1.6 GPa or more, 1.7 GPa or more, 1.8 GPa or more, 1.9 GPa or more, 2.0 GPa or more, 2.1 GPa or more, 2.2 GPa or more, 2.3 GPa or more, 2.4 GPa or more, 2.5 GPa or more, 2.6 GPa or more, 2.7 GPa or more, 2.9 GPa or more, or 2.9 GPa or more. In other examples, the disclosed copolymer can have an elastic modulus of 3.0 GPa or less, e.g., 2.9 GPa or less, 2.8 GPa or less, 2.7 GPa or less, 2.6 GPa or less, 2.5 GPa or less, 2.4 GPa or less, 2.3 GPa or less, 2.2 GPa or less, 2.1 GPa or less, 2.0 GPa or less, 1.9 GPa or less, 1.8 GPa or less, 1.7 GPa or less, 1.6 GPa or less, 1.5 GPa or less, 1.4 GPa or less, 1.3 GPa or less, 1.2 GPa or less, 1.1 GPa or less, 1.0 GPa or less, 0.9 GPa or less, 0.8 GPa or less, 0.7 GPa or less, or 0.6 GPa or less. The elastic modulus of the disclosed copolymers can range from any of the minimum values described above to any of the maximum values described above, for example from 0.5 GPa to 3.0 GPa, from 1.0 GPa to 2.5 GPa, from 1.3 GPa to 2.2 GPa.

The benefit of incorporating low molecular weight aldehyde monomer in the copolymer can be seen in the evaporation time of the depolymerized copolymer. The melting point of phthalaldehyde, pentanal, butanal, propanal and ethanal are 55° C., −60° C., −97° C., −81° C., and −123°, respectively. After exposure to an acid, the homopolymer of poly(phthalaldehyde) takes 2.5 days for 90% weight loss whereas the poly(phthalaldehyde-butanal) copolymer took only 5.25 h for 90% weight loss.

The toughness of the poly(aldehyde) copolymer was tougher than that of the poly(phthalaldehyde) polymer, as measured by elongation to break in a stress-strain measurement. Poly(phthalaldehyde) had an elongation to break below 1% whereas the 50 g/mole poly(phthalaldehyde-butanal) copolymer had an elongation to break of >1.2%.

### Crosslinked Polyaldehyde Copolymers

Crosslinking is the act of chemically bonding one polymer chain to another or alternatively, one part of a chemical chain to another part of the same chain. Crosslinking polymers can modify the mechanical and chemical properties by creating new bonds that alter how the polymer behaves under mechanical or chemical stresses. Variables such as the crosslink density and the chemical nature of the crosslinks can further alter the polymer's final properties including density, permeability to gases or liquids, mechanical properties, and solubility.

The disclosed copolymers can be crosslinked in various ways. For example, by incorporating a reactive group in one or more of the different aldehyde monomers, the reactive groups can be used to form crosslinks with the same or different polymer. Such reactions are sometimes initiated by heat or a catalyst. Alternatively, a crosslinking agent can be used where the crosslinking agent would have a two or more functional groups which each react with a chemical site on the polymer chain. The end result is to create a chemical crosslink incorporating the crosslinking agent. In some specific examples, R in any of the formula disclosed herein can comprise a reactive group that can i) react with another R or R′ group on a different aldehyde monomer; ii) convert into a different reactive group, which is then reacted with another R or R′ group on a different aldehyde monomer; and/or iii) react with a crosslinking agent.

Examples of crosslinking reactions that can be used to crosslink the disclosed copolymers include, but are not limited to, photocuring, free radical polymerization, cationic polymerization, anionic polymerization, coordination polymerization, ring-opening polymerization, chain-growth polymerization, chain transfer polymerization, emulsion polymerization, ionic polymerization, solution polymerization, step-growth polymerization, suspension polymerization, radical polymerization, condensation reactions, cycloaddition reactions, electrophilic additions, and nucleophilic additions (e.g., Michael additions).

As a specific example, Scheme 1 shows the copolymerization of phthalaldehyde and 4-pentenal (4PE). The terminal, unsaturated, carbon-carbon double bond on the 4PE can be used to cross-link the PHA-4PE containing copolymer through a number of different mechanisms including but not limited to: radical based reactions that can be thermally or photolytically induced from initiators, thiol-alkene reactions, and vulcanization.

Additionally, the unsaturated bond can be reacted into a different functional group that is capable of crosslinking, such as transforming the alkene into an epoxide, aldehyde, ester, alcohol, thiol, amine, or halide group. This permits additional chemistries to be used crosslinking.

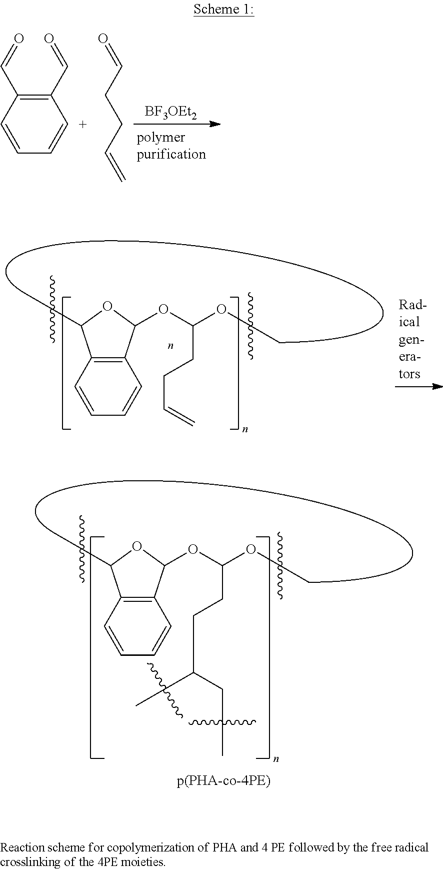

Another example is incorporating an aldehyde with a furan group into the copolymer. The furan group can participate in Diels-Alder reactions with a dienophile, such as maleimides. If multi-functional dienophiles are loaded into the copolymer containing furan reactive groups then the Diels-Alders reactions can create covalent crosslinks between polymer chains. This example is illustrated in Scheme 2. These reactions can occur at modest temperatures, about 60° C. At higher temperatures, >110° C., the retro Diels-Alder reaction can occur and undo the covalent crosslinks. This is highly favorable for disappearing devices as it minimizes the high molecular weight residue that often accompanies crosslinked polymers.

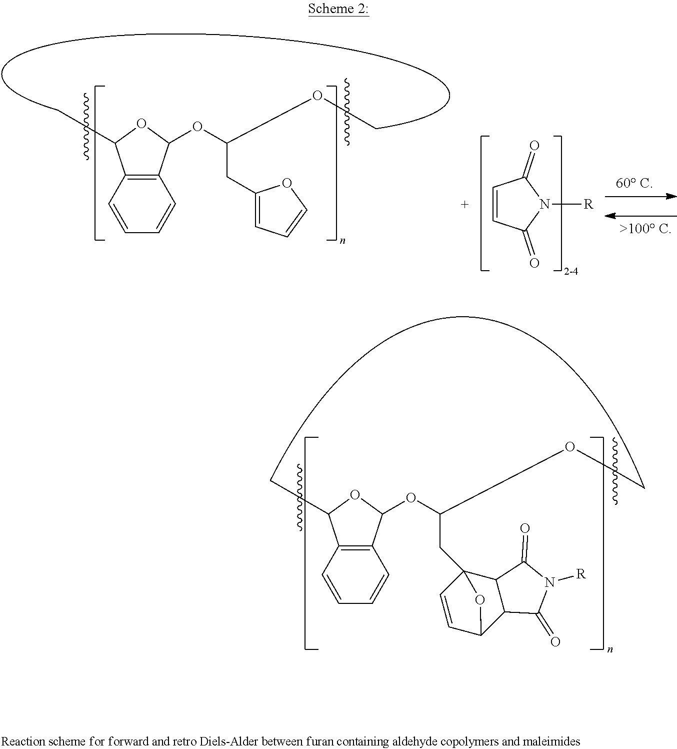

Aldehyde monomers containing other functional groups can be incorporated into the copolymer leading to other crosslinking mechanisms. In additional examples, the disclosed copolymers can have reactive groups that are pendant on the polymer backbone (e.g., R and/or R′) that are available for bond formation. The disclosed copolymers can be reacted with a crosslinking agent that reacts with reactive groups on separate copolymers or on the same copolymer to form a crosslink. Alternatively, the disclosed copolymers can have reactive groups that are pendant on the polymer backbone that are converted into different reactive groups, which are then reacted with other reactive groups on the same copolymer, or a different copolymer or with a crosslinking agent.

Examples of suitable reactive groups for crosslinking that can be incorporated into the copolymer include nucleophilic groups, electrophilic groups, or radical generating groups. Thus, disclosed herein are copolymers of phthalaldehyde and one or more different aldehydes wherein the one or more different aldehydes comprise a nucleophilic group, electrophilic group, or radical generating group. Referring to Formula I and II, specific examples of these copolymers can have R and/or R′ as an unsubstituted C₂-C₂₀ alkenyl, unsubstituted C₂-C₂₀ alkynyl, unsubstituted, cycloalkenyl, unsubstituted heterocycloalkenyl, C₆-C₁₀ aryl, C₆-C₁₀ heteroaryl; or R and/or R′ can be C₁-C₂₀ alkyl, C₃-C₁₀ cycloalkyl, or C₃-C₁₀ heterocycloalkyl substituted with amino, carboxylic acid, sulfonic acid, sulfinic acid, fluoroacid, phosphonic acid, ester, halide, hydroxyl, ketone, nitro, cyano, azido, or thiol. In some specific examples, the disclosed copolymers can comprise thiol groups. In some examples, the disclosed copolymer can comprise hydroxyl groups. In some examples, the disclosed copolymer can comprise ene or yne groups. In some examples, the disclosed copolymer can comprise epoxide groups.

In certain examples, a crosslinking agent can be used to crosslink the copolymers. The crosslinking agent can have reactive groups that are available for bond formation; that is, the crosslinking agent can be reacted with the reactive groups (e.g., R and/or R′ or other aldehyde monomer) of the copolymer. Examples of reactive groups on a suitable crosslinking agent include nucleophilic groups, electrophilic groups, or radical generating groups. The reactive groups of the crosslinking agent can be complementary to the reactive groups of the copolymer. For example, the reactive groups of the copolymer can comprise nucleophilic reactive groups and the crosslinking agent can comprise electrophilic reactive groups. Alternatively, the reactive groups of the copolymer can comprise electrophilic reactive groups and the crosslinking agent can comprise nucleophilic reactive groups.

In some examples, the crosslinking agent can comprise two or more reactive groups (e.g., 3 or more, 4 or more, or 5 or more). In some examples the crosslinking agent can comprise 6 or less reactive groups (e.g., 5 or less, 4 or less, or 3 or less). The number of reactive groups of the crosslinking agent can range from any of the minimum values described above to any of the maximum values described above, for example from 2 to 6 (e.g., from 2 to 4, from 4 to 6, from 3 to 5, from 2 to 3, from 3 to 4, from 4 to 5, or from 5 to 6).

In some examples, the crosslinking agent can comprise a Michael acceptor. In some examples, the crosslinking agent can comprise a multifunctional (meth)acrylate or a multifunctional allylate. In some examples, the crosslinking agent can comprise a polyisocyanate. In other examples, the crosslinking agent can comprise a dienophile.

The amount of crosslinking, and thus the amount of reactive groups in the copolymer involved in reactions, can be controlled by selecting the desired amount of crosslinking agent. That is, the stoichiometry of the reagents can be used to dictate the extent of crosslinking. The amount of crosslinking can be monitored by various analytical techniques, such as TLC, IR spectroscopy, and NMR.

By incorporating minor amounts of aldehyde monomers with reactive groups into the disclosed copolymers, the degree of crosslinking can be minimized. For example, using less than 1 mol % of aldehyde monomers with reactive groups, e.g., less than 0.5 mol %, or less than 0.1 mol %, the degree of crosslinking can be minor. In contrast, using significant amounts of aldehyde monomer with reactive groups can lead to highly crosslinked copolymers. For example, using 5 mol % of aldehyde monomers with reactive groups, e.g., 10 mol % or more, or 15 mol % or more, the degree of crosslinking can be significant.

In some examples, crosslinking the copolymer can comprise a Michael addition. In some examples, the copolymer can comprise thiol groups on the aldehyde units and crosslinking the copolymer can comprise base-catalyzed Michael addition of the thiol groups of the copolymer with electrophilic reactive groups (e.g., a Michael acceptor such as an ene or yne group) of the crosslinking agent. Alternatively, the copolymer can comprise a Michael acceptor group on the aldehyde units and the crosslinking agent can comprise thiol groups. Further, the copolymer can contain aldehyde units with Michael acceptors and Michael donors and the copolymer can be crosslinked with itself.

In some examples, crosslinking the copolymer can comprise a substitution reaction. The copolymer can comprise aldehyde units having an alcohol, amine, or thiol and the crosslinking agent can comprise a polyisocyanate, such that the crosslinked copolymer can include urethane, urea, or thiourea linkages. Alternatively, the crosslinking agent can comprise an alcohol, amine, or thiol and the copolymer can comprise aldehyde units having a polyisocyanate. Further, the copolymer can contain aldehyde monomers with a polyisocyanate and either one or more of alcohol, amine, or thiol groups and the copolymer can be crosslinked with itself.

Further examples include a crosslinking reaction between an epoxide, carbonyl, ester, or halogen with an alcohol, amine, or thiol. That is, the aldehyde units in the copolymer can contain (or be converted to contain) an epoxide, carbonyl, ester, or halogen and the crosslinking agent can comprise an alcohol, amine, or thiol. Alternatively, the crosslinking agent can contain an epoxide, carbonyl, ester, or halogen and the aldehyde units in the copolymer can comprise an alcohol, amine, or thiol. Further, the aldehyde units in the copolymer can contain (or be converted to contain) an epoxide, carbonyl, ester, or halogen, an alcohol, amine, or thiol and the copolymer can be crosslinked with itself.

In still further examples, crosslinking the copolymer can comprise a cycloaddition. In some examples, the copolymer can comprise aldehyde units having unsaturated (diene, diyne, or azide)) groups and crosslinking the copolymer can comprise reacting these groups with a dienophile of the crosslinking agent. Alternatively, the copolymer can comprise aldehyde units having a dienophile and the crosslinking agent can comprise an unsaturated groups (diene, diyne, or azide). Further, the copolymer can comprise aldehyde units having a dienophile and dienes and the copolymer can be crosslinked with itself.

In yet further examples, crosslinking the copolymer can comprise a radical polymerization. Here, the aldehyde units can comprise a radical generator, e.g., an unsaturated group, and the radical can be generated by application of a radical initiator. This can be done in the presence or absence of a crosslinking agent.

The amount of crosslinking agent used in the crosslinking reactions can be 0.05% or more based on the total amount of the monomers to be polymerized (e.g., 0.1% or more, 0.2% or more, 0.3% or more, 0.4% or more, 0.5% or more, 0.6% or more, 0.7% or more, 0.8% or more, 0.9% or more, 1% or more, 1.1% or more, 1.2% or more, 1.3% or more, 1.4% or more, 1.5% or more, 1.6% or more, 1.7% or more, or 1.8% or more). In some examples, the amount of crosslinking agent used can be 2% or less based on the total amount of the monomers to be polymerized (e.g., 1.9% or less, 1.8% or less, 1.7% or less, 1.6% or less, 1.5% or less, 1.4% or less, 1.3% or less, 1.2% or less, 1.1% or less, 1% or less, 0.9% or less, 0.8% or less, 0.7% or less, 0.6% or less, 0.5% or less, 0.4% or less, 0.3% or less, or 0.2% or less). The amount of crosslinking agent used can range from any of the minimum values described above to any of the maximum values described above. For example, the amount of crosslinking agent used can be from 0.05% to 2% based on the total amount of monomers to be polymerized (e.g., from 0.05% to 1%, from 1% to 2%, from 0.05% to 0.5%, from 0.5% to 1%, from 1% to 1.5%, from 1.5% to 2%, or from 0.1% to 1.9%).

### Photocatalysts and Thermocatalysts

The disclosed copolymers can be triggered to undergo depolymerization by a variety of stimuli, e.g., light, heat, chemical, or sound. In some examples, a reliable environmental trigger in the form of sunlight or heat can be used to induce the ‘disappearance’ of the disclosed copolymers. The term light is used here to include all forms of electromagnetic radiation, not simply visible light. Ultraviolet radiation is especially effective activating the the photocatalysts used here. The ability to decompose these polymers in ambient temperature with environmental conditions such as sunlight or controlled, specific LED wavelengths can lead to many applications, e.g., in the emerging field of transient electronics, or stealth devices that are not to be recovered. Alternatively, an instantaneous pulse of heat can also be used to create the depolymerization trigger. The disclosed copolymers can be highly sensitive to acid or bases and can be promptly depolymerized into volatile monomer units by end-cap removal or direct chain attack at temperatures above about −4° C., after triggering the photocatalyst or thermocatalyst.

Onium salts are commonly used in the microlithographic industry for chemically amplified photoresists and photoinitators for polymerizations (Crivello, J. V.; et al., “Design and Synhesis of Photoacid Generating Systems,” J. Photopolym Sci. Technol., 2008, 21:493-497; Crivello, J. V.; et al., “Anthracene electron-transfer photosensitizers for onium salt induced cationic photopolymerizations,” J. Photochem. PhotobioL A Chem., 2003, 159:173-188; J. V. Crivello and U. Bulut, “Curcumin: A naturally occurring long-wavelength photosensitizer for diaryliodonium salts,” J. Polym. Sci. Part A Polym. Chem., 2005, 43:5217-5231). The most efficient photo-acid generators are the diaryliodonium and triarylsulfonium salts. The presence of the aryl groups of the onium cation make the photo-acid generators absorb strongly in the short wavelength region of the ultraviolet spectrum. Photo-base generators based on tetraphenylborate salts have also seen some interest in past literature for anionic polymerizations (Sun, X.; et al., “Bicyclic guanidinium tetraphenylborate: A photobase generator and a photocatalyst for living anionic ring-opening polymerization and cross-linking of polymeric materials containing ester and hydroxy groups,” J. Am. Chem. Soc. 2008, 130:8130-8131; Sun, X.; et al., “Development of Tetraphenylborate-based Photobase Generators and Sacrificial Polycarbonates for Radiation Curing and Photoresist Applications,” Carleton University, 2008). The tetraphenylborate salts undergo a rearrangement that abstracts a proton from its cation neighbor, releasing a strong guanidine base. The tetraphenylborate anion is responsible for the absorbance in the short wavelength region of the ultraviolet spectrum of these photo-base generators. As a result, most of the energy emitted from broadband light sources is wasted with these photo-acid/base generators. Sensitizing the onium and tetraphenylborate salts to longer wavelengths of light can capture a higher fraction of energy from these light sources leading to a more efficient photolysis. Sunlight is one example of a broadband light source that is a reliable environmental trigger for transient devices that can initiate the decomposition of the polymer. Sensitization to longer wavelengths of light is desired as there is not enough deep ultraviolet light in natural sunlight to activate the photo-acid/base generators. Alternatively, the photoactive compound can be active by heat. A pulse of heat to a high enough temperature can accomplish the same chemical reaction as light. In particular, onion salts are thermally activated at about 180° C.

An attractive quality of these onium salts is the ability to extend their spectral sensitivity to longer wavelengths of light via electron-transfer photosensitization (Crivello, J. V.; et al., J. Photochem. Photobiol. A Chem. 2003, 159:173-188). A simplified scheme is shown below. In the Scheme 3, MtXn- represents the nucleophilic counterion such as BF₄⁻, PF₆⁻, SbF₆⁻, (C₆F₅)₄B⁻. The photo-induced electron transfer begins from the absorption of light by the photo sensitizer, transitioning the PS to the excited state species [PS]*. The excited species PS undergoes an encounter complex by colliding with an onium salt generating an excited complex state (exciplex). The onium is reduced by a formal one electron-transfer reaction. The electron-transfer reaction is rendered irreversible due to the rapid decay of the onium radical as shown in eq4. The photosensitizer cation radical can decay in a number of ways to produce a strong Bronsted acid.

Disclosed herein are copolymers of phthalaldehyde and one or more other aldehydes and a photocatalyst, which can trigger the depolymerization of the copolymer by the application of light. In specific examples, the photocatalyst is a photo-acid generator (PAG), especially photo-active generators that are active at a wavelength in the visible spectrum. Other photo-acid generators that are active at a wavelength in the UV, IR, or X-rays can be used when depolymerization is desired to be triggered by these stimuli. In other examples, the photocatalyst is a photo-base generator (PBG), especially photo-base generators that are active at a wavelength in the visible spectrum. Other photo-base generators that are active at a wavelength in the UV, IR, or X-rays can be used when depolymerization is desired to be triggered by these stimuli.

Examples on suitable photo-acid generators are onium salts, such as iodonium salts and sulfonium salts having perfluorinated anions, bissulfonyldiazomethane compounds, N-sulfonyloxydicarboximide compounds, and O-arylsulfonyloxime compounds. Further examples of photo-acid generators are tetrakis-(pentafluorophenyl)borate-4-methylphenyl[4-(1-methylethyl)phenyl]iodonium (Rhodorsil-FABA), tris(4-tert-butylphenyl)sulfonium tetrakis-(pentafluorophenyl) borate (TTBPS-FABA), triphenylsulfonium tetrakis-(pentafluorophenyl) borate (TPS-FABA), bis(4-tert-butylphenyl)iodonium triflate (BTBPI-TF), tert-(butoxycarbonylmethoxynaphthyl)-diphenylsulfonium triflate (TBOMDS-TF), N-hydroxynaphthalimide triflate (NHN-TF), diphenyliodonium perfluoro-1-butanesulfonate (DPI-NF), tris(4-tert-butylphenyl)sulfonium perfluoro-1-butanesulfonate (TTBPS-NF), N-hydroxynaphthalimide perfluoro-1-butanesulfonate (NHN-NF), N-hydroxy-5-norbornene-2,3-dicarboximide perfluoro-1-butanesulfonate (NHNDC-NF), bis(4-tert-butylphenyl)iodonium tris(perfluoromethanesulfonyl) methide, (BTBPI-TMM), bis(4-tert-butylphenyl)iodonium bis(perfluorobutanesulfonyl) imide (BTBPI-BBI), diphenyliodonium 9,10-dimethoxyanthracene-2-sulfonate (DPI-DMOS), bis(4-tert-butylphenyl) iodonium p-toluenesulfonate (BTBPI-PTS), a non-ionic PAG such as Ciba IRGACURE™ PAG 263 (III) and bis(4-tert-butylphenyl)iodonium perfluoro-1-octanesulfonate (BTBPI-HDF). Other examples of photo-acid generators are disclosed in U.S. Pat. Nos. 6,004,724, 6,849,384, 7,393,627, 7,833,690, 8,192,590, 8,685,616, 8,268,531, 9,067,909, and 9,383644, which are incorporated by reference herein froth their teachings of photo-acid generators.

Examples of suitable photo-base generators include photoactive carbamates such as benzyl carbamates and benzoin carbamates, 0-carbamoylhydroxylamines, 0-carbamoyloximes, aromatic sulfonamides, alpha-lactams, and amides such N-(2-arylethyenyl)amides. Other examples of photo-base generators are disclosed in U.S. Pat. Nos. 5,627,010, 7,300,747, 8,329,771, 8,957,212, and 9,217,050, which are incorporated by reference herein froth their teachings of photo-base generators.

Thermal acid generators can be any of the photo-acid generators described herein, that when heated to a certain temperature will decompose to release an acid. Other examples of such compounds include ammonium salts, sulfonyl esters, and acid amplifiers. Further examples are disclosed in U.S. Publication Nos. 2017/0123313 and 2014/0193752, which are incorporated by reference herein in their entireties their teachings of acid generators.

Thermal base generators can be any photo-base generators described herein, that when heated to a certain temperature will decompose to release a base. These compounds can be, but not limited to, carboxylic salts of an amidine, imidazole, guandine, or a phosphazene derivative. Additional thermal base generators are disclosed in WO 2016109532, which is incorporated by reference herein in its entirety for its teachings of base generators.

The photo and thermocatalysts can be added to the disclosed copolymers prior to or after polymerization. The amount of photo or thermocatalyst present can vary depending on the intended purpose of the copolymer. In some examples, the amount of photo or thermocatalyst can be from 0.01 mol % to 10 mol % based on the total monomer mol %, e.g., from 0.01 to 5, from 0.1 to 1, from 1 to 5, or from 5 to 10 mol %.

### Photosensitizers

The disclosed copolymers can also comprise a photosensitizer to facilitate photo-catalytic triggering of decomposition. The role of the photosensitizer is to extend the wavelength range of the photocatalyst to wavelengths which the photocatalyst does not absorb or absorbs only weakly. Molecular compounds such as modified polyaromatic hydrocarbons or fused aromatic rings can be suitable photosensitizers for the onium and tetraphenylborate salts, as well as other photo-acid and photo-base generators disclosed herein. However, photo-induced electron transfer between photosensitizer and photo-acid/base generator is not always certain. This electron transfer is typically described between a donor and its acceptor. The donor (sensitizer) is at a ground-state with two electrons in the highest occupied molecular orbital (HOMO). The oxidation potential of the donor (sensitizer) is increased over its ground state from the absorption of a photon thereby transitioning an electron to the lowest unoccupied molecular orbital (LUMO). The reduction potential of the accepter (PBG or PAG) must be lower than the oxidation potential of the donor. The photosensitizer and photo-catalyst can create an excited complex as shown in Scheme 3 eq 3, where an electron is transferred to the LUMO of the photo-catalyst. As a result of the excitation of the photo-catalyst, a strong acid or base is released.

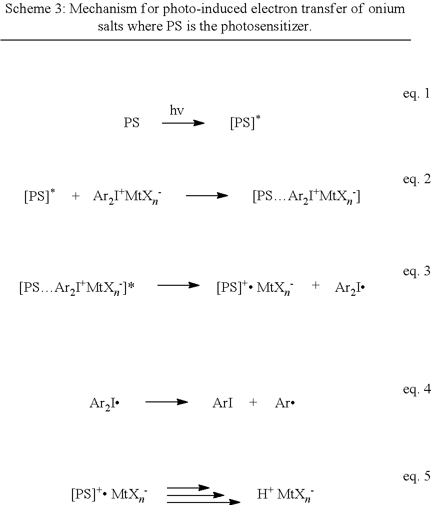

Photosensitizers can range from aromatic hydrocarbons, isobenzofurans, carbocyanines, metal pthalocyanines, carbazoles, olefins, phenothiazines, acridines, stilbenes. Additional photosensitizers are disclosed in U.S. Pat. No. 4,250,053, and Crivello, J. V.; et al., J. Photochem. Photobiol. A Chem. 2003, 159:173-188, which are incorporated by reference herein for its teachings of photo sensitizers.

### Freezing Point Depression

In certain circumstances, the disclosed copolymers degrade into small molecules (oligomers) or monomers upon exposure to an external/internal trigger. These small molecules or monomers can have low vapor pressure and evaporation of the monomer is slow. Further, these monomers can have a tendency to be in a solid form in various environments, which can be undesirable if detection of the decomposed polymer is not desired. Freezing point depression can therefore be used to keeping monomer units in liquid form once the polymer has been triggered to decompose. The monomer can remain in liquid-state and absorb into the surrounding environment. This reduces the chance of detection where the monomer can evaporate over time.

In some examples, the disclosed copolymers can comprise a freezing point depressing agent. The freezing point depressing agents can be present in the disclosed copolymers as additives to a composition comprising the copolymer, or as a covalently bound moiety onto the copolymer. In certain embodiments, additives with the monomer units can be used to reduce the monomers freezing point and maintain liquid state at low temperatures. Examples of suitable agents include, but are not limited to, traditional and non-traditional plasticizers, photo-catalysts, and any combination of these additives. Types of traditional plasticizer include, but are not limited to, adipates (bis(2-ethylhexyl)adipate, dimethyl adipate, monomethyl adipate, dioctyl adipate), azelates, citrates, ether-esters, glutarates, isobutyrates, phosphates, sebacates (dibutyl sebacate), maleates, tertiary amines, quaternary ammonium compounds, diethylene glycol dibenzoate, dipropylene glycol dibenzoate, tripropylene glycol dibenzoate, butyl benzyl phthalate, phosphonium compounds, sulfonium compounds, or a combination thereof. Additional plasticizers include bis(2-ethylhexyl)phthalate, bis(2-propylheptyl)phthalate, diisononyl phthalate, dibutylphthalate, diisodecyl phthalate, diisooctyl phthalate, diethyl phthalate, diisobutyl phthalate, dihexylphthalate. Further examples include tirmethyl trimellitate, tri(2-ethylhexyl)trimellitate, tri(octyl,decyl)trimellitate, tri(heptyl,nonyl)trimellitate, octyltrimellitate. Further examples include sulfonamides, organophosphates, glycols and polyethers. Types of non-traditional plasticizers include, but are not limited to, ionic liquids, surfactants, and acid amplifiers. Suitable ionic liquids can include, but are not limited to, salts having as a cation imidazolium, alkyl-imidazole, alkyl-ammonium, alkyl-sulfonium, alkyl-piperidinium, alkyl-pyridinium, alkyl-phosphonium, or alkyl-pyrrolidinium, and having as an anion carboxylate, halide, fulminate, azide, persulfate, sulfate, sulfites, phosphates, phosphites, nitrate, nitrites, hypochlorite, chlorite, bicarbonates, perfluoroborates, and the like.

In other examples, the presence of different aldehyde comonomers can reduce the freezing point. Types of aldehyde comonomers that can be incorporated into poly(phthalaldehyde) (PPHA) homopolymer include, but are not limited to, acetaldehyde, propanal, butanal, pentanal, pentenal, hexanal, heptanal, octanal, nonanal, decanal, and 10-undecenal.

The presence of as little as 1 wt % freezing point depression agents can significantly lower the freezing point of the depolymerized polymer by disrupting the crystallization process. The presence of 10 wt % to 50 wt % freezing point depression compound can lower the freezing point of the depolymerization products more than 30° C. It was found that the presence of compounds containing quaternary ammonium or suflonium moieties can lower the freezing point of decomposed poly(phthalaldehyde) below −20° C. Without the freezing point depression agent, decomposed poly(phthalalsdehyde) freezes between 55° C. and 20° C.

### Delayed Photo-Response of Poly(Phthalaldehyde) Depolymerization

In some situations, transient materials with extended operational time of use in the presence of a photo trigger is desirable. Devices comprising these materials can finish the mission or product life cycle within the expected duration of time under continuous exposure to the photo triggers and vanish after completing its function.

Influence of organic additives on transient time is demonstrated herein to extend the operation time of the materials under the presence of a trigger. These organic additives contain weakly basic moieties that can coordinate and dissociate with a photo generated super acid. This can hinder the diffusion of the acid and potentially reduce the rate of depolymerization. In some examples, the disclosed copolymers can comprise agents that delay depolymeriation or reduce the rate of depolymerization. These agents can be present in the disclosed copolymers as additives to a composition comprising the copolymer, or as a covalently bound moiety onto the copolymer. Organic additives include but are not limited to tertiary amine (e.g., n-methyl-2-pyrrolidone (NMP), dimethylformamide (DMF)), solvents with lone pair electrons (e.g., gamma butyrolactone (GBL)), tertiary phosphine, imidazole, different ionic liquids including but not limited to quaternary ammonium ionic liquid, phosphonium ionic liquid, imidazolium ionic liquid, sulfonium ionic liquid.

Suitable examples of ionic liquids that can be added include salts where a cation is imidazolium, alkyl-imidazole, alkyl-ammonium, alkyl-sulfonium, alkyl-piperidinium, alkyl-pyridinium, alkyl-phosphonium, or alkyl-pyrrolidinium and the anion is a halogen (fluoride, chloride, bromide, or iodide), perchlorate, a thiocyanate, cyanate, C₁-C₆ carboxylate, fulminate, azide, persulfate, sulfate, sulfites, phosphates, phosphites, nitrate, nitrites, hypochlorite, chlorite, bicarbonates, perfluoroborates, and the like. In specific examples, the ionic liquid comprises an imidazolium ion, e.g., a Cₙ alkyl-methylimidazolium [Cₙmim] where n is an integer of from 1 to 10. Allyl methylimidazolium ion and diethylimizazolium ion can also be used. The anion in the salt can be a halogen (fluoride, chloride, bromide, or iodide), perchlorate, a thiocyanate, cyanate, C₁-C₆ carboxylate, fulminate, azide, persulfate, sulfate, sulfites, phosphates, phosphites, nitrate, nitrites, hypochlorite, chlorite, bicarbonates, perfluoroborates, and the like, including mixtures thereof.

### Multi-Layered, Photo/Thermo Activated Polymers

The decomposition and vaporization of polymers is useful in fabricating electronic and other devices where the polymer serves a temporary spatial placeholder. The decomposition and vaporization of polymers is also useful in constructing components that have a fixed lifetime and recovery of the component is undesirable. That is, the component can be made to disappear on command. The trigger mechanism can be an optical trigger from a light source or the sun. The trigger mechanism can also be a thermal trigger from a local heating source such as joule heating from a wire.

When a photosensitive polymer is used, it can be problematic to handle materials because they can be inadvertently exposed to the triggering light. Also, the photosensitive polymer may have a limited temperature range where it is stable. This can make processing the final component difficult if high temperature processes are needed, such as for soldering or curing of compounds.

Thus, it is desirable to fabricate a polymer-containing component without it being photosensitive and add a photosensitive layer later, or at the end of the process. In the disclosed methods, it has been found that a second, photo-sensitive layer containing a decomposing photocatalyst can be added after component fabrication. Activation of the second, photo-sensitive layer can be initiated and result in decomposition of the second layer. Further, the photo-catalyst in the second layer can diffuse into the first, non-photosensitive layer resulting in efficient destruction of it. This is particularly effective when the first step in the photo-decomposition process is the liquefaction of the photo-activated materials because the photo-catalyst has a high diffusion coefficient and can easily penetrate into the non-photo sensitive layer.

Similar structures can be prepared with thermal triggered layers. For example, one can fabricate a polymer-containing component without it being thermally sensitive and add a thermally sensitive layer later, or at the end of the process. Activation of the second, thermally-sensitive layer can be initiated and result in decomposition of the second layer. Further, the thermocatalyst in the second layer can diffuse into the first, non-thermally-sensitive layer resulting in efficient destruction of it.

Thus disclosed herein are various multilayer or multi-regioned compositions. In one example, a polymer composition can comprise a plurality of polymer layers wherein one layer comprises a copolymer as disclosed herein with a photo or thermocatalyst and the other layer comprise a degradable polymer, e.g., a copolymer disclosed herein without the photo or thermocatalyst or with the photo or thermocatalysts and an agent that delays the photo- or thermal-initiated degradation In another example, a polymer composition comprises a copolymer as disclosed herein, and the polymer composition has a plurality of regions, wherein one region has a photo or thermocatalyst and another region does not. In still another example, a polymer composition can comprise a plurality of polymer layers wherein one layer comprises a photo or thermocatalyst and the other layer comprise a degradable polymer, e.g., a copolymer disclosed herein without the photo or thermocatalyst or with the photo or thermocatalysts and an agent that delays the photo- or thermal-initiated degradation.

Also disclosed herein are various multilayered compositions or devices. In one example, a composition/device can comprise a plurality of layers wherein one layer comprises a copolymer as disclosed herein with a photo or thermocatalyst and the other layer comprise a substrate, e.g., metal, metal alloy, metal oxide, or graphitic oxide, or a non-degradable polymer. The copolymer layer can also comprise photosensitizers and/or chemical amplifiers.

The disclosed multilayer structures can have a variety of different arrangements. For example, the degradable copolymer with photocatalyst can be on top of, covering completed or partially, the layer/region without the photocatalyst, or it can be adjacent to the layer/region without the photocatalyst. In another example, the degradable copolymer can also be sandwiched between layers/regions without the photocatalyst. Conversely, two layers of degradable copolymer can sandwich a layer/region without photocatalyst.

In still other examples, disclosed are mulilayered or multi-regioned structures where a degradable polymer having a thermocatalyst is in one layer and a thermal acid generator is in another.

It is also disclosed that the layers in the multilayered composition or device do not have to be discrete layers. Rather, they can be graded layers where the concentration of the constituents within each layer changes gradually from one layer blending into the other layer(s). A gradient in concentration from one layer to another can occur experimentally when fabricating a multilayer structure because the constituents in one layer may partially dissolve the constituents in another layer. Or, the gradient may be intentionally added so that there is not a discrete seam between the two layers. The gradient in concentration may occur with structures with more than two layers, as described above.

Chemical Amplification of the Response into Non-Photosensitive Regions

Constructing devices with the copolymers disclosed herein where a small area can be made photosensitive at the end of fabrication can be highly desirable. The photosensitive region can be limited to a single area at the trigger source (i.e., a photo-catalyst). At this point in the device, the acid or base catalyst can diffuse to other regions which are not photosensitive. However, the diffusion of acid to the non-photosensitive regions of the device is problematic because some of the catalyst can be inadvertently consumed by impurities or other means, and only a limited amount of catalyst can be loaded into a small region. Thus, it is desirable to multiply the number of catalyst species, or chemically amplify the catalyst. Then, the number of catalyst species increases as the catalyst diffuses through the body of the device.

Therefore, in some circumstances it can be desirable to incorporate small molecules within the polymer body of the device that, upon contact with catalyst, will create additional catalyst molecules. This process can be called amplification of the acid catalyst in the non-photosensitive regions. Acid amplifiers are such compounds that can be used to increase the number of acid species created by the trigger source. The loading of the acid amplifier into the non-photosensitive region can thus increase the rate of polymer decomposition, and substantially reduce residue. Furthermore, the amount of catalyst from the trigger source can be reduced.

Thus disclosed herein are various multilayer or multiregioned compositions. In one example, a polymer composition can comprise a plurality of polymer layers wherein one layer comprises a copolymer as disclosed herein with a photocatalyst and the other layer comprise a degradable polymer, e.g., a copolymer disclosed herein with a chemical amplifier (e.g., acid or base amplifier). In another example, a polymer composition comprises a copolymer as disclosed herein, and the polymer composition has a plurality of regions, wherein one region has a photocatalyst and another region has a chemical amplifier. In still other examples, a composition/device can comprise a plurality of layers wherein one layer comprises a photocatalyst and the other layer comprise a degradable polymer, e.g., a copolymer disclosed herein with a chemical amplifier (e.g., acid or base amplifier).

An example of an acid amplifier but not limited to is shown in Formula IV,

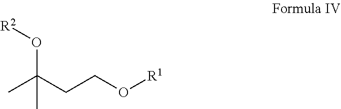

where R¹ can comprise a number of acid precursors such as sulfonic esters, flouroesters, and carbonic esters; and R² can comprise a trigger that can contain hydroxyl, methoxy, acetate, carbonic esters, sulfonic esters, and fluoro esters.

The acid amplification into other regions for subsequent decomposition and vaporization of the polymer are not limited to light-sensitive applications. It can be desirable to initiate this reaction from a region where the polymer is loaded with acid amplifier so that upon exposure to elevated temperature or a chemical source, acid catalyst will be created from the acid amplifier.

### Films

One aspect of the invention relates to a film comprising the copolymer of the present invention. In some embodiments, the film may be a freestanding film, e.g., one that is ready for application to a surface. In some embodiments, the film may be present on a surface, e.g., as a coating, e.g., a film that has been formed on the surface.

The film may be any thickness that is effective to provide the desired purpose, e.g., protection of the surface. The polyaldehyde thickness can be controlled by concentrations of the deposited solutions and the coating conditions. With spin-coating, thickness ranging from 30 nm to 1 μm can be obtained. The thickness of the polyaldehyde does not alter the effectiveness of its protection against oxidation, as long as a full coverage of polyaldehyde is achieved across the substrate. Its presence on the surface, regardless of thickness, is sufficient to observe the desired effect.

In some embodiments, the film has a thickness of at least about 10 nm, e.g., at least about 50 nm, at least about 100 nm, at least about 250 nm, at least about 500 nm, at least about 750 nm, at least about 1 mm, at least about 2 mm, at least about 3 mm, at least about 4 mm, or at least about 5 mm. In some embodiments, the film has a thickness of less than about 5 mm, e.g., less than about 4 mm, less than about 3 mm, less than about 2 mm, less than about 1 mm, less than about 750 nm, less than about 500 nm, less than about 250 nm, less than about 100 nm, less than about 50 nm, or less than about 10 nm. The thickness can range from any of the minimum values described above to any of the maximum values described above. For example, the thickness can be from about 10 nm to about 5 mm (e.g., from about 10 nm to about 1 mm, from about 10 nm to about 100 nm, from about 100 nm to about 1 mm, from about 100 nm to about 5 mm, from about 1 mm to about 5 mm).

In some embodiments, the film may further comprise one or more additional polymers, e.g., 1, 2, 3, 4, or more additional polymers. The additional polymers may enhance the mechanical properties of the film. For example, the additional polymer may increase the strength of the film. Examples of additional polymers include, without limitation, polyvinyl chloride, polydimethylsiloxane, and polycaprolactone at 1 wt. % to 100 wt. %. While inclusion of additional polymers may, for example, increase the strength of the film, it may also result in a reduction in flexibility. Additionally, the polymer additives may not compose like the copolymer of the invention, remaining in the byproduct mixture after the copolymer has decomposed, hindering absorption into the environment.

One method for increasing the flexibility (e.g., storage modulus) of the film is to add one or more plasticizers, such as described above. In some embodiments, the at least one additional plasticizer is an ether-ester plasticizer, e.g., bis(2-ethylhexyl) phthalate (BEHP).

In some embodiments, addition of a plasticizer alone may be insufficient to provide the desired flexibility. Additionally, higher amounts of plasticizer (e.g., greater than 15% BEHP) may result in phase segregation and the presence of plasticizer may not sustain the liquid byproduct after decomposition of the copolymer, leaving behind solid residuals.

Addition of high concentrations of ionic liquid into the copolymer together with plasticizer may provide films that achieve a wider range of mechanical properties (e.g., flexibility) and may be completely foldable at sub-ambient temperatures. It is indeed remarkable that having such a high concentration of liquid (i.e., ionic liquid) in a polymer even results in a solid material with superior properties rather than a liquid or liquid-like film. Moreover, addition of plasticizer with high concentrations of ionic liquid may mitigate phase segregation and result in more transparent films. In addition, the resulting byproducts after decomposition of the copolymer may maintain in a liquid state below ambient temperatures.

Thus, in some embodiments, the film of the invention may further comprise at least one ionic liquid. The ionic liquid may have a weight percent of at least about 40% with respect to the weight of the copolymer, e.g., at last about 50%, 60%, 70%, 75%, 80%, 85%, or 90%. In some embodiments, the ionic liquid has a cation selected from imidazolium, alkyl-imidazole, alkyl-ammonium, alkyl-sulfonium, alkyl-piperidinium, alkyl-pyridinium, alkyl-phosphonium, and alkyl-pyrrolidinium, and an anion selected from carboxylate, halide, fulminate, azide, persulfate, sulfate, sulfites, phosphates, phosphites, nitrate, nitrites, hypochlorite, chlorite, bicarbonates, sulfonimides, imides, and borates. In some embodiments, the ionic liquid is 1-butyl-1-methylpyrrolidinium bis(trifluoromethylsulfonyl)imide) (BMP), 1-hexyl-1-methylpyrrolidinium bis(trifluoromethylsulfonyl)imide (HMP), or 1-methyl-1-octylpyrrolidinium bis(trifluoromethylsulfonyl)imide (OMP).

In some embodiments, films comprising plasticizer and ionic liquid may have an elastic modulus of at least about 2 MPa, e.g., at least about 4 MPa, 6 MPa, 8 MPa, 10 MPa, 15 MPa, or 20 MPa. In some embodiments, films comprising plasticizer and ionic liquid may have an elastic modulus of less than about 30 MPa, e.g., less than about 25 MPa, 20 MPa, 18 MPa, 16 MPa, 14 MPa, or 12 MPa. The elastic modulus can range from any of the minimum values described above to any of the maximum values described above, for example from 2 to 30 MPa (e.g., from 2 to 15 MPa, from 2 to10 MPa, from 5 to 20 MPa, or from 10 to 30 MPa).

In situations where the elastic modulus of the film is less than desirable (e.g., due to addition of plasticizer and/or ionic liquid) and undergo plastic deformation too easily, addition of fibers or particles to the film may reinforce the film and raise the elastic modulus. The fibers or particles may be inorganic (e.g., glass, carbon) or organic (e.g., polymeric such as acrylic). Of particular interest are fibers and particles with lengths of 100 nm to 1 mm, and diameters of about the same size as the length to diameters which are only 1/100^{th} of the length.

In some embodiments, the film is a composite film as described above. The composite film may comprise two or more layers, such as 2, 3, 4, 5, or more layers. In some embodiments, the composite film is comprised of at least two layers each with different mechanical properties. In some embodiments, one layer has a mechanical property that compensates for a mechanical property of a second layer, e.g., due to the presence of one or more additives in one layer that is not present or present in a different concentration in at least one other layer. For example, a copolymer layer that is soft due to a high concentration of plasticizers or brittle due to a low concentration of plasticizers can be laminated with a more ductile or tougher copolymer layer to compensate for the inferior mechanical property of the first layer. In some embodiments, an additive, such as a photocatalyzer, is present in one layer such that the composite film can still achieve phototransience.

In some embodiments, the film of he invention may be prepared from a suitable composition comprising the copolymer and one or more additives. In some embodiments, the composition comprises:

a) a copolymer, wherein the copolymer comprises a repeating unit as shown in Formula I:

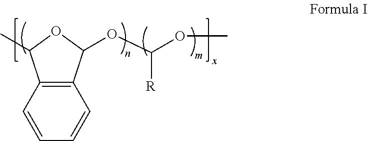

wherein R is substituted or unsubstituted C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R is substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
m is 1 to 100,000;
n is 1 to 100,000; and
x is 1 to 100,000;
b) a plasticizer; and
c) an ionic liquid, wherein the ionic liquid has a weight percent of at least about 40% with respect to the weight of the copolymer.

In some embodiments, the plasticizer is an ether-ester plasticizer, e.g., bis(2-ethylhexyl) phthalate. In some embodiment, the ionic liquid has a cation selected from imidazolium, alkyl-imidazole, alkyl-ammonium, alkyl-sulfonium, alkyl-piperidinium, alkyl-pyridinium, alkyl-phosphonium, and alkyl-pyrrolidinium, and an anion selected from carboxylate, halide, fulminate, azide, persulfate, sulfate, sulfites, phosphates, phosphites, nitrate, nitrites, hypochlorite, chlorite, bicarbonates, imides, sulfonimides, and borates. In some embodiments, the ionic liquid is 1-butyl-1-methylpyrrolidinium bis(trifluoromethylsulfonyl)imide) (BMP), 1-hexyl-1-methylpyrrolidinium bis(trifluoromethylsulfonyl)imide (HMP), or 1-methyl-1-octylpyrrolidinium bis(trifluoromethylsulfonyl)imide (OMP).

### Devices and Methods of Use

One aspect of the invention relates to devices and apparatuses comprising the copolymer and film of the invention. In some embodiments, the device or apparatus comprises a surface, wherein the surface is at least partially coated with the film of the invention, wherein the film may be later removed. The surface may be any surface where it is desired to transiently coat and/or protect the surface. The surface may be, for example, a semiconductor, metal, or dielectric material. The semiconductor material may comprise, for example, silicon, germanium, or a combination thereof.

One of the advantages of the copolymer and film of the invention is that the glassy nature of the polyaldehydes temporarily lowers the rate of permeation of reactive (e.g., oxidizing) species (oxygen or water) to the surface of the substrate, thus protecting it from the harmful ambient environment.

The molecular weight of the copolymer will change the density of the protective layer and how it orients on the surface. Blending different molecular weights also changes how the polymer interacts with the surface. Blending different polymers will change the protective effect.

Surfaces which are more easily wet by the copolymer have greater polymer/surface interaction. The protective copolymer has a greater tendency to preserve the intrinsic value of surfaces in which they have greater interaction with. Silicon, germanium, SiGe, and metal surfaces are easily wet by polyaldehydes and are thus protected. In one example, the film can be applied to a semiconductor surface, e.g., after the surface has been cleaned to remove the native oxide layer to prevent further oxidation.

In addition to chemical protection, the film of the invention can provide physical protection to a surface, e.g., one having delicate three-dimensional structures.

Thus one aspect of the invention relates to a method of transiently protecting a surface from chemical and or physical modification, comprising coating at least part of the surface with the film of the invention. The method may further comprise removing the film by exposing the film to a decomposition trigger at the desired time such that the copolymer depolymerizes into monomers. The trigger may be any signal that causes decomposition, e.g., heat or radiation or acoustic energy.

In some embodiments, the chemical modification is oxidation, e.g., of a semiconductor, metal, or dielectric material, e.g., one comprising silicon, germanium, or a combination thereof.

In some embodiments, the physical modification is degradation (e.g., collapse or distortion) of three dimensional structures on the surface, e.g., microstructures or nanostructures, e.g., pillars.

In some embodiments, the decomposition trigger is a thermal trigger, e.g., a temperature that is sufficient to volatilize the monomer (e.g., about 100° C. to 200° C., e.g., about 150° C.). In certain embodiments, the film may further comprise a catalyst that is thermally activated.

In some embodiments, the decomposition trigger is electromagnetic radiation. In certain embodiments, the film may further comprise a catalyst that is activated by the electromagnetic radiation. In certain embodiments, a photo-catalyst is activated by radiation having a wavelength from deep-UV to near-infrared.

In some embodiments, photo-triggering of the catalyst produces a strong acid, e.g., such as triflic acid, nonaflic acid, or toluenesulfonic acid, which can lead to rapid depolymerization of polyaldehydes.

In some embodiments, the catalyst is a diaryliodonium salt, a triarylsulfonium salt, tetraphenylborate salt, an onium salt or sulfonium salt having perfluorinated anions, a bissulfonyldiazomethane compound, an N-sulfonyloxydicarboximide compound, an O-arylsulfonyloxime compound, tetrakis-(pentafluorophenyl)borate-4-methylphenyl[4-(1-methylethyl)phenyl-]iodonium (Rhodorsil-FABA), tris(4-tert-butylphenyl)sulfonium tetrakis-(pentafluorophenyl) borate (TTBPS-FABA), triphenylsulfonium tetrakis-(pentafluorophenyl) borate (TPS-FABA), bis(4-tert-butylphenyl)iodonium triflate (BTBPI-TF), tert-(butoxycarbonylmethoxynaphthyl)-diphenylsulfonium triflate (TBOMDS-TF), N-hydroxynaphthalimide triflate (NHN-TF), diphenyliodonium perfluoro-1-butanesulfonate (DPI-NF), tris(4-tert-butylphenyl)sulfonium perfluoro-1-butanesulfonate (TTBPS-NF), N-hydroxynaphthalimide perfluoro-1-butanesulfonate (NHN-NF), N-hydroxy-5-norbomene-2,3-dicarboximide perfluoro-1-butanesulfonate (NHNDC-NF), bis(4-tert-butylphenyl)iodonium tris(perfluoromethanesulfonyl) methide, (BTBPI-TMM), bis(4-tert-butylphenyl)iodonium bis(perfluorobutanesulfonyl) imide (BTBPI-BBI), diphenyliodonium 9,10-dimethoxyanthracene-2-sulfonate (DPI-DMOS), bis(4-tert-butylphenyl) iodonium p-toluenesulfonate (BTBPI-PTS), (1Z,1′Z)-1,1′-((ethane-1,2-diylbis(oxy))bis(4,1-phenylene))bis(2,2,2-trifluoroethan-1-one) 0,0-dipropylsulfonyl dioxime, bis(4-tert-butylphenyl)iodonium perfluoro-1-octanesulfonate (BTBPI-HDF), or any combination thereof.

In some embodiments, the film may further comprise a photosensitizer. The photosensitizer may be, for example, a modified or unmodified polyaromatic hydrocarbon, e.g., anthracene, 1,8-dimethoxy-9,10-bis(phenylethynyl)anthracene (DMBA), 6,13-bis(3,4,5-trimethoxyphenylethynyl)pentacene (BTMP), 5,12-bis(phenylethynyl)tetracene (BPET), 1-Chloro-4-propoxythioxanthone (CPTX), 4-methylphenyl[4-(1-methylethyl) phenyl] tetrakis(pentafluorophenyl) borate (FABA-PAG), 1,5,7 triaza-bicyclo [4.4.0] dec-5-ene tetraphenylborate (TBD-PBG), or any combination thereof.

In some embodiments, the film is removed from the device or apparatus by exposing the film to a solvent such that the copolymer is washed away. The solvent may be, for example, a polar aprotic solvent, e.g., dichloromethane, tetrahydrofuran, acetone, n-methyl-pyrrolidone, dimethylformamide, dimethyl sulfoxide, propylene carbonate, diglyme, or propylene glycol methyl ether acetate.

Some polyaldehydes decompose at a slower rate compared to others. The longer time required for depolymerization may result in undesirable longer period of harsh environment for other components and lead to unfavorable effects. In some embodiments, the depolymerization rate can be increased by hydrating the depolymerized aldehyde monomer to form acidic byproducts. Examples of acidic byproducts include, without limitation, phthalic acid, ethanoic acid, propanoic acid, butanoic acid, pentanoic acid, and others. Furthermore, a copolymer comprising a more volatile, higher vapor pressure comonomer such as acetaldehyde (bp=21° C.) can result in faster vaporization and less residuals left behind after depolymerization than a copolymer containing a less volatile comonomer such as 10-undecenal.

Further, mixtures of polymers with different molecular weights or different comonomers have different densities and molecular packaging. These properties affect the permeation of reactants to surfaces. Thus, the protective effect can be enhanced by using mixtures of polymers.

In all of the methods of the invention, the depolymerized aldehyde monomer may be 2-chlorobutanal or 3-bromopropanal.

### Methods of Preparing Polyaldehyde Copolymers

Also disclosed are method of preparing a cyclic copolymer, comprising: contacting phthalaldehyde and one or more different aldehydes in the presence of a solvent and Lew acid catalyst. Specific examples of suitable Lewis acid catalyst include BF₃-etherate, GaCl₃, TiCl₄, TiF₄, and FeCl₃. In specific examples, the Lewis acid catalyst is BF₃ or GaCl₃. The amount of other aldehydes(s) can vary depending on the intended purpose of the copolymer. For example, the other phthalaldehyde can be present at 30 mol % or more based on total monomer weight (e.g., 35 mol % or more, 40 mol % or more, 45 mol % or more, 50 mol % or more, 55 mol % or more, 60 mol % or more, 65 mol % or more, 70 mol % or more, 75 mol % or more, 80 mol % or more, 85 mol % or more, 90 mol % or more, 95 mol % or more, 97 mol % or more, or 99 mol % or more). In some examples, from 99 mol % or less phthalaldehyde can be used based on the total monomer weight (e.g., 97 mol % or less, 95 mol % or less, 90 mol % or less, 85 mol % or less, 80 mol % or less, 75 mol % or less, 70 mol % or less, 65 mol % or less, 60 mol % or less, 55 mol % or less, 50 mol % or less, 45 mol % or less, 40 mol % or less, or 35 mol % or less). The amount of phthalaldehyde used can range from any of the minimum values described above to any of the maximum values described above. For example, from 30 mol % to 99 mol % phthalaldehyde can be used based on the total monomer content (e.g., from 60 mol % to 99 mol %, from 70 mol % to 97 mol %, from 80 mol % to 95 mol %, from 85 mol % to 99 mol %, from 90 mol % to 99 mol %, or from 80 mol % to 90 mol %).

The ratio of total aldehyde monomers to catalyst used can range from about 1500:1 to about 1:1. For example, ratio of aldehyde monomers to catalyst can be about 1200:1, about 1100:1, about 1000:1, about 750:1, about 500:1, about 100:1, about 50:1, about 10:1, or about 1:1. It has been generally found that the less catalyst used, the higher the molecular weight of the resulting copolymer.

The solvent can be dichloromethane, toluene, or chloroform. The reaction mixture can be left at ambient temperatures or cooled until polymerization is completed. It has been found that the reaction time and temperature have little effect on the copolymer's properties. However, cooling the reaction before catalyst addition can increase the proportion of the other aldehyde in the copolymer.

The resulting copolymer can be precipitated into methanol or hexane. Redissolving the copolymer into THF with a small amount of amine (e.g., triethyl amine) followed by precipitation can be used to purify the copolymer.

The various photocatalysts, thermocatalysts, photosensitizers, chemical amplifiers, freezing point depressing agents, and agents that delay photodegredation can be added to the reaction mixture prior to polymerization or added after polymerization.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Cationic Copolymerization of o-Phthalaldehyde and Functional Aliphatic Aldehydes

Degradable polymers are of interest because they can be used in transient-device applications, stimuli-responsive materials, advanced lithography, and closed loop polymer recycling (Fu, K. K. et al., Chem. Mater., 28(11), pp. 3527-3539; Cang, J.-K. et al., Proc. Natl. Acad. Sci., 114(28), pp. E5522-E5529; Herbert, K. M., et al., Macromolecules, 50(22), pp. 8845-8870; Peterson, G., Macromolecules; Ober, M. S., et al.,Macromolecules, p. acs.macromol.8b01038; Marneffe, J. F. et al., ACS Nano; Uzunlar, E., et al., J. Electron. Packag., 138(2), p. 020802; Zhu, J. B., et al., Science (80-.), 360(6387), pp. 398-403). Low ceiling temperature (T_{C}) polymers can be metastable at higher temperatures above T_{C} and can be depolymerized with a small activation energy. A single chemical event capable of breaking a bond in the polymer backbone can initiate the polymer unzipping depolymerization reaction because depolymerization is the thermodynamically favored state at temperatures above T_{C}. Polyacetals prepared by the addition polymerization of aldehydes can have T_{C} values from −60° C. to 50° C. (Kubisa, P., et al., Polymer (Guildf), 21(12), pp. 1433-1447). The low T_{C} is due to the relatively small enthalpy gain from the polymerization of a carbon-oxygen double bond compared to the high enthalpy gain which occurs in the polymerization of a carbon-carbon double bond (Odian, G., 2004, Principles of Polymerization). A lower polymerization temperature is required to overcome the entropy decrease in the system (i.e., TΔS) and shift equilibrium towards polymerization. Dainton and Ivin derived Equation 1 to describe T_{C} in terms of polymerization thermodynamics and initial monomer concentration, [M]₀ (Dainton, F. S., et al., Nature, 162(4122), pp. 705-707).

$${T}_{C} = \frac{Δ {H}^{∘}}{Δ {S}^{∘} + R {ln [ M ]}_{0}} \qquad ( 1 )$$

In Eq. 1, ΔH° and ΔS° are the standard enthalpy and entropy of polymerization, respectively, and R is the ideal gas constant. Recent polyaldehyde publications have focused on poly(phthalaldehyde) (PPHA) and poly(glyoxylates) (Wang, F., et al., Macromol. Rapid Commun., 39(2), pp. 1-21; Fan, B., et al., J. Am. Chem. Soc., 136(28), pp. 10116-10123; Sirianni, Q. E. A., et al., Macromolecules, 52, p. acs.macromol.8b02616). PPHA and its derivatives and copolymers were originally investigated as dry-develop photoresist films for lithography (Ito, H., et al., Polym. Eng. Sci., 23(18), pp. 1012-1018; Ito, H., et al., J. Electrochem. Soc., 136(1), pp. 241-245; Ito, H., et al., J. Electrochem. Soc., 136(1), pp. 245-249). More recently, PPHA-based materials have been used as stimuli-responsive materials for a variety of applications because the materials rapidly degrade back to monomer at ambient conditions (Kaitz, J. A., et al., Macromolecules, 46(3), pp. 608-612; Kaitz, J. A., et al., Macromolecules, 47(16), pp. 5509-5513; DiLauro, A. M., et al., Macromolecules, 46(8), pp. 2963-2968; Dilauro, A. M., et al., Angew. Chemie—Int. Ed., 54(21), pp. 6200-6205; Park, C. W., et al., Adv. Mater., p. n/a-n/a; Lee, K. M., et al., ACS Appl. Mater. Interfaces, 10(33), pp. 28062-28068; Gourdin, G., et al., Proc.—Electron. Components Technol. Conf., pp. 190-196; Phillips, O., et al., J. Appl. Polym. Sci.; Coulembier, O., et al., Macromolecules, 43(1), pp. 572-574). PPHA has been used as a structural material for applications where device recovery is not desired and the material needs to disappear into the surroundings (Hwang, S., et al., Science (80-.), 337(6102), pp. 1640-1644). There is interest in phthalaldehyde (PHA) based copolymers with improved transient and mechanical properties compared to PPHA. For example, the incorporation of monomers with higher vapor pressure than PHA (e.g., aliphatic aldehydes) into a copolymer could improve the overall rate of monomer evaporation, and post-polymerization reactions such as cross-linking may improve the toughness of the transient polymer.

Cationic polymerization of cyclic PPHA is preferred over the anionic polymerization due to (i) the ease of synthesis, (ii) the formation of higher molecular weight polymers (i.e., improved mechanical properties), (iii) improved thermal stability above T_{C}, and (iv) elimination of end-capping reaction during synthesis (Aso, C., et al., 1969, J. Polym. Sci. Part A Polym. Chem., 7, pp. 497-511; Aso, C., et al., 1969, Macromolecules, 2(4), pp. 414-419; Schwartz, J. M., et al., 2017, J. Polym. Sci. Part A Polym. Chem., 55(7), pp. 1166-1172. Kaitz, J. A., et al., 2013, J. Am. Chem. Soc., 135(34), pp. 12755-12761). Anionically polymerized aliphatic aldehydes are also highly isotactic and precipitate from the reaction solution (Vogl, O., et al., 1964, J. Polym. Sci. Part A Gen. Pap., 2(10), pp. 4633-4645). The anionic copolymerization of PHA with benzaldehydes was discussed by Kaitz and Moore (Kaitz, J. A., and Moore, J. S., 2013, Macromolecules, 46(3), pp. 608-612), who also explored the cationic copolymerization PHA and ethylglyoxylate (Kaitz, J. A., and Moore, J. S., 2014, Macromolecules, 47(16), pp. 5509-5513). Schwartz et al. studied PHA-butanal copolymers, including their degradation properties (Schwartz, J. M., et al., 2018, J. Appl. Polym. Sci.). The aim of this study was to extensively examine the synthesis and characteristics of the cationic copolymerization of PHA with a variety of aliphatic aldehydes. The functionalization of PHA-based copolymers is also presented as a means of introducing cross-linkable moieties and other functional groups incompatible with the cationic polymerization chemistry.

### 1.1 Materials and Methods

Nuclear magnetic resonance (NMR) spectra were collected using CDCl₃ as the solvent using the residual solvent peak (δ=7.26 ppm for ¹H and δ=77.16 ppm for ¹³C) as the reference for chemical shifts. Dynamic thermal gravimetric analysis (TGA) was used at a heating rate of 5° C./min. Isothermal TGA runs were at 5° C./min until 10° C. before the desired temperature and followed by a 1° C./min ramp rate. Dynamic mechanical analysis (DMA) was used in the frequency scan mode oscillating at 0.01% strain to test the mechanical properties of crosslinked polymer films at 30° C.

Polymer films for crosslinking were prepared by dissolving 250 mg of copolymer, thiols, and photoradical generator in tetrahydrofuran (THF) and placed on a rolling mixer until homogeneous. The formulation was cast into PTFE coated foil that was molded into a rectangle of dimensions 32 mm×12 mm×0.5 mm. Films were exposed to an Oriel Instruments flood exposure source with a 1000W Hg(Xe) lamp filtered to 248 nm radiation for a specified length of time. After crosslinking, the films were allowed to slowly dry in a semi-rich THF environment to help minimize bubble defects in the films After DMA analysis, swelling ratio experiments were performed by allowing the films to sit in excess of THF. Swollen films were periodically weighed until a constant mass was achieved, and then the swelling ratio was taken as the final mass divided by the initial mass. High crosslink densities can prevent the polymer from swelling and produces swelling ratio values near one. Low crosslink density films have high swelling ratio and/or completely dissolve in the solvent.

### 1.2 Results and Discussion

### 1.2.1 Polymerization Catalyst and Solvent

A number of catalysts for the polymerization of PHA and aliphatic aldehydes homopolymers have been reported (Aso, C., et al., 1969, Macromolecules, 2(4), pp. 414-419; Vogl, O., 1967, J. Macromol. Sci. Part A—Chem., 1(2), pp. 243-266). Lewis acid catalysts were found to yield polyaldehydes with long room-temperature shelf-life. It is thought that the macrocyclic polymer conformations of PPHA could be maintained with the addition of comonomers, such as with ethyl glyoxylate. Propanal (PA) was chosen as the model comonomer for its structural simplicity, ease of purification, and favorable solubility. Copolymerization synthesis is carried out at low temperature to help push equilibrium in favor of polymeric products (Scheme 4). Solvent(s) are selected by on solubility of high molecular weight polyaldehydes at the polymerization temperature, e.g., −78° C. The solvent must also dissolve the trimer form of the aliphatic aldehyde comonomer even through the trimer itself does not homopolymerize. Precipitation of the trimer form of the comonomer would decrease the concentration of free monomer from the reaction solution.

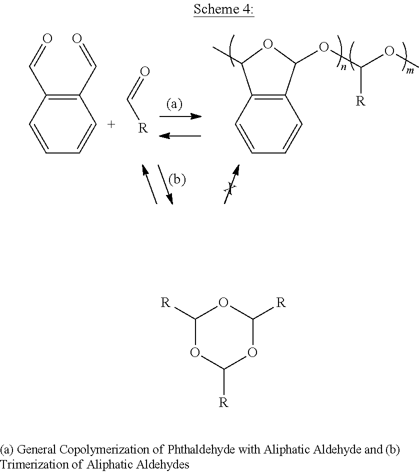

Copolymerization reactions were run at −78° C. to screen possible polymerization solvents, as shown in Table 1. The monomer concentration was 0.75 M, the monomer-to-catalyst ratio was 500:1, and the PHA-to-PA monomer feed ratio was 1.5:1. The starting solution was a vibrant yellow which quickly converted to colorless at the reaction temperature showing the conversion of the yellow PHA monomer to polymer. Some solutions became very viscous upon reaction making magnetic stirring difficult. The polymerization reaction was quenched after one hour followed by product precipitation and purification. No attempt was made to endcap the polymer chains. The Lewis acid catalysts and solvents are shown in Table 1 along with product yield, molecular weight and percent uptake of PHA and PA into the polymer.

TABLE 1
Synthetic Results for Copolymerizations of o-Phthalaldehyde with Propanal
using various Lewis Acid Catalysts and Solvents

| | | p(PHA- | Molec- | PHA | PA |
|---|---|---|---|---|---|
| | | PA) | ular | Conver- | Conver- |
| Lewis | | Yield | Weight^{a} | sion | sion |
| Acid | Solvent | (%) | (kDa) | (%) | (%) |
| BF₃OEt₂ | DCM/CHCl₃/ | 77/54/57 | 60/43/26 | 90/69/72 | 20/4/8 |
| | Tol | | | | |
| BCl₃ | DCM/CHCl₃/ | 0/0/0 | — | — | — |
| | Tol | | | | |
| BBr₃ | DCM/CHCl₃/ | 0/0/0 | — | — | — |
| | Tol | | | | |
| TiF₄^{b} | DCM/CHCl₃ | 0/0 | — | — | — |
| TiCl₄^{b} | DCM | <1 | — | — | — |
| GaCl₃ | DCM/CHCl₃/ | 55/48/60 | 16/13/10 | 69/59/74 | 10/12/13 |
| | Tol | | | | |
| AlEt₃ | DCM/CHCl₃ | 0/0 | — | — | — |

Tol = toluene;
DCM = dichloromethane;
^{a}Measured by GPC;
^{b}Not fully soluble.

Boron trifluoride diethyl etherate (BF₃OEt₂) gave the highest yield polymerizations among the Lewis acids tested. This catalyst has been reported as highly active to aldehyde polymerizations (Vogl, O., 1974, Die Makromol. Chemie, 175, pp. 1281-1308). Copolymer yields from chloroform and toluene were significantly lower than those from DCM. Other boron trihalides and triethyl aluminum catalysts did not catalyze the copolymerization reaction. Titanium (IV) halides were not fully soluble, and did not yield copolymer. Gallium trichloride catalyst gave modest polymer yield with all three solvents: DCM, chloroform, and toluene. It is important to note that polymerizations in toluene always resulted in polymer precipitating from the reaction mixture during polymerization even to the extent of solidifying the entire polymerization medium. Chloroform showed similar but less consistent results in terms of polymer solubility and solidification compared to the other solvents. The effectiveness of toluene as the polymerization solvent was demonstrated by performing a polymerization reaction at half the monomer concentration (0.38 M) that yielded polymer product precipitating from the reaction mixture after only 25 min. Further dilution of the reactant concentration was detrimental because it would decrease the ceiling temperature of the monomer mixture, as shown by Eq. 1. Evidence from past reports suggests that the Lewis acids may require a co-catalyst to initiate the polymerization, which could come from acid impurities, adventitious water, or aldehyde hydrates. The BF₃OEt₂/DCM system was selected as the solvent in the remaining studies here because it produced copolymers with the highest yield, molecular weight, and monomer conversion.

1.2.2 Copolymerization of o-Phthalaldehyde and Propanal Model System

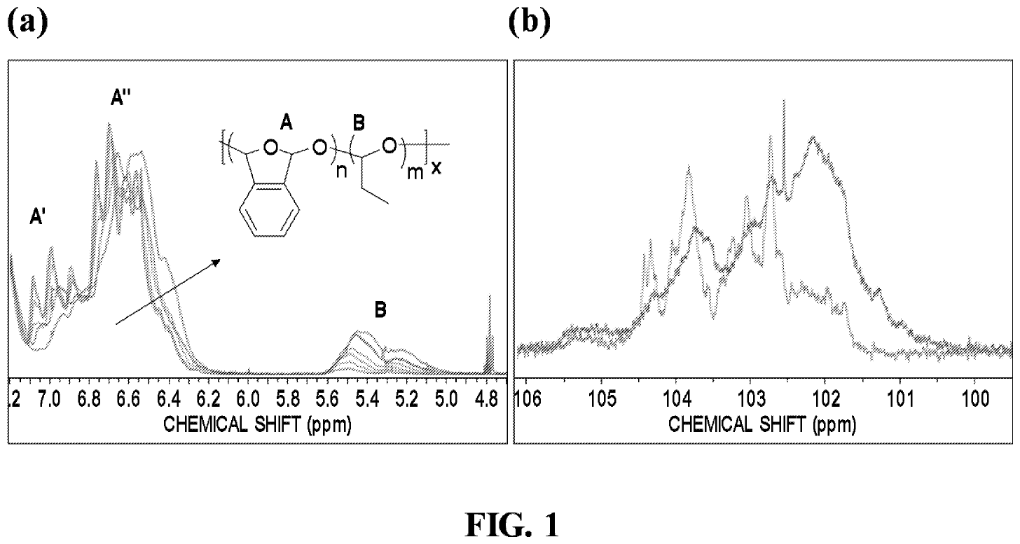

A series of PHA-PA copolymers were synthesized with monomer composition feeds ranging from 0-60 mol % to investigate PA reactivity. Feed loadings of >70 mol % PA resulted in sparse or zero copolymer yield. The composition of the copolymers was measured by comparing integrations of the backbone protons in the ¹H-NMR spectra. FIG. 1, panel a shows overlaid spectra of p(PHA-PA) copolymers, focused between chemical shifts of 6=4.7 to 7.2 ppm. Each curve represents a copolymerization with a higher PA percentage in the monomer feed. The resulting copolymers had 3 to 23 mol % PA as seen by the growth of PA (peak B) with respect to the PHA (peak A). A deterioration of the well-defined PHA peaks can also be seen as the PA incorporation increased. This deterioration originates from loss of the cisltrans configuration of the PHA acetal protons (A″/A′, respectively). The copolymerization appears to promote the cis configuration for the PHA monomer, because the acetal peak of the copolymer product shifts to favor the cis configuration as the peaks associated with the trans structure shrink. The loss in well-defined PHA tacticity is also observed in the acetal carbon peaks in the ¹³C-NMR spectrum, which is overlaid with PPHA homopolymer in FIG. 1, panel b.

The bimodal nature of the NMR PA acetal peaks may also be due to a cis/trans configuration with neighboring monomers within the copolymer. Alternatively, it could be the result of varying monomer sequences within the polymer chains. A slight chemical shift would occur for PA acetal peaks flanked by PHA monomers (-PHA-PA-PHA- sequence) compared to two sequential PA monomers (-PHA-PA-PA-PHA- sequence). These copolymers likely have a random monomer sequence distribution because there is little evidence to support the existence of consecutive PA monomer sequences. If the copolymer was blocky in nature with -PA-PA- or -PHA-PHA- sequences, it is expected to better maintain the cis/trans configuration ratio. NMR results reported by Weideman et al. show that homopolymerization of aliphatic aldehydes (i.e., butanal in their case) produces broad acetal peaks centered around δ˜4.8 ppm (Weideman, I., et al., 2017, Eur. Polym. J., 93(May), pp. 97-102), which is not observed in these copolymers. This peak shift also corresponds to that of the aliphatic trimer, an impurity of which is the likely cause of the appearance of the triplet peak in FIG. 1, panel a at δ=4.80 ppm (J=5.3 Hz) and the sharp peak in FIG. 1, panel b at 6=102.6 ppm, based on the crispness of the peak and the lack of trend compared to peak B (Schwartz, J. M., et al., 2018, J. Polym. Sci. Part A Polym. Chem., 56(2), pp. 221-228).

There are no apparent signs of endcaps existing within the copolymers synthesized here. Lack of alkene signals in NMR suggests that a-elimination is not a favored pathway. 2D-NMR experiments did not show strong correlations to other potential endcaps, but this is expected with polymers of such high molecular weight that cause the concentration of endcaps to be very low, if there were ends. Unfortunately, repeated MALDI mass spectrometry analyses did not show well-resolved peaks to determine the mass of the copolymer chains. It is likely that the copolymers synthesized here are predominantly cyclic, formed by a transacetalization reaction from the polymer chain. This result would be similar to PPHA and p(PHA-ethylglyoxylate) polymerizations using BF₃OEt₂ in DCM. However, water or aldehyde hydrate impurities might cap the polymers with hydroxyl groups, Scheme 5.

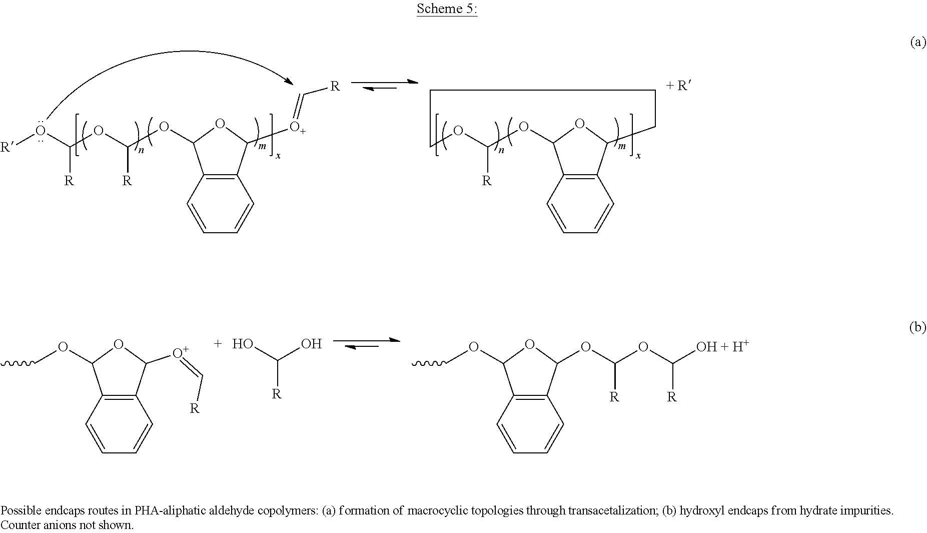

1.2.3 Reactivity of Aliphatic Aldehydes toward Copolymerization with o-Phthalaldehyde

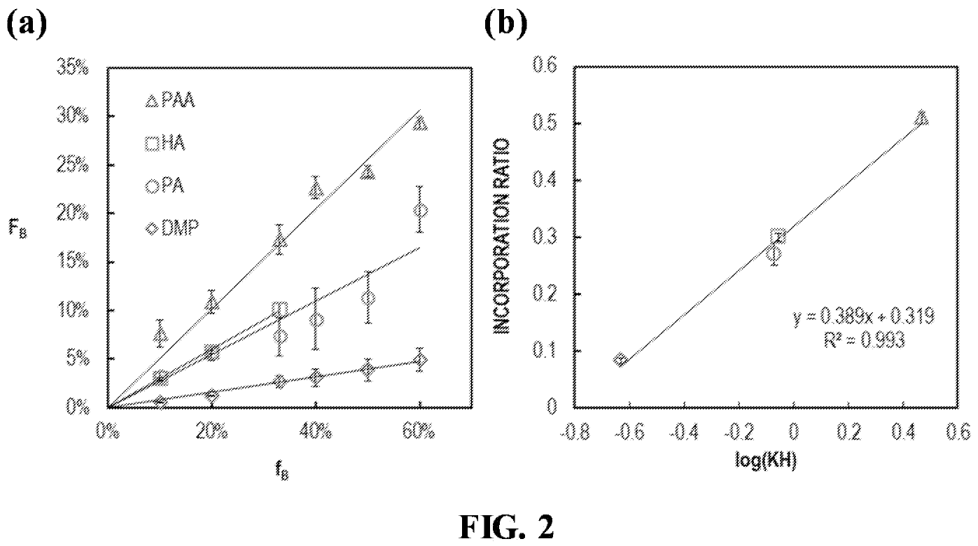

A number of aliphatic aldehydes (monomer A) were copolymerized with PHA (monomer B) to investigate the relative reactivity of different monomers. Composition profiles for copolymerizations of PHA with PA, 2,2-dimethylpropanal (DMP), heptanal (HA), and phenylacetaldehyde (PAA), are shown in FIG. 2, panel a and Tables 2-7.

TABLE 2
Phenylacetaldehyde (PAA): Synthetic data for poly(phthalaldehyde-
phenylacetaldehyde) copolymer series

| Feed Ratio | Triplicate Copolymerizations | | | Avg GPC Data |
|---|---|---|---|---|
| oPHA/PAA | Composition (Yield) | Composition (Yield) | Composition (Yield) | Mₙ (kDa), Ð |
| 90/10 | 91/9 (83%) | 93/7 (81%) | 93/7 (83%) | 111 ± 20, 1.62 |
| 80/20 | 90/10 (78%) | 89/11 (78%) | 88/12 (77%) | 60 ± 4, 1.72 |
| 67/33 | 83/17 (67%) | 84/16 (67%) | 81/19 (66%) | 35 ± 2, 1.75 |
| 60/40 | 76/24 (59%) | 78/22 (62%) | 78/22 (61%) | 29 ± 9, 1.86 |
| 50/50 | 76/24 (52%) | 76/24 (55%) | 75/25 (52%) | 15 ± 1, 1.99 |
| 40/60 | 70/30 (42%) | 71/29 (41%) | 71/29 (43%) | 13 ± 2, 1.81 |

TABLE 3
Propanal (PA): Synthetic data for poly(phthalaldehyde-propanal) copolymer
series

| Feed Ratio | Triplicate Copolymerizations | | | Avg GPC Data |
|---|---|---|---|---|
| oPHA/PA | Composition (Yield) | Composition (Yield) | Composition (Yield) | Mₙ (kDa), Ð |
| 90/10 | 96/4 (72%) | 97/3 (87%) | 97/3 (76%) | 165 ± 35, 1.53 |
| 80/20 | 94/6 (70%) | 94/6 (80%) | 95/5 (52%) | 155 ± 15, 1.56 |
| 67/33 | 92/8 (45%) | 91/9 (69%) | 95/5 (45%) | 73 ± 40, 1.89 |
| 60/40 | 91/9 (48%) | 88/12 (71%) | 94/6 (77%) | 50 ± 9, 1.77 |
| 50/50 | 88/12 (35%) | 86/14 (61%) | 92/8 (36%) | 33 ± 18, 2.43 |
| 40/60 | 81/19 (32%) | 77/23 (50%) | 81/19 (26%) | 16 ± 9, 2.08 |

TABLE 4
Heptanal (HA): Synthetic data for poly(phthalaldehyde-heptanal) copolymer
series

| Feed Ratio | Triplicate Copolymerizations | | | Avg GPC Data |
|---|---|---|---|---|
| oPHA/HA | Composition (Yield) | Composition (Yield) | Composition (Yield) | Mₙ (kDa), Ð |
| 90/10 | 97/3 (84%) | 97/3 (83%) | 97/3 (81%) | 128 ± 17, 1.71 |
| 80/20 | 94/6 (80%) | 94/6 (78%) | 94/6 (74%) | 105 ± 13, 1.79 |
| 67/33 | 89/11 (46%) | 91/9 (66%) | 90/10 (48%) | 66 ± 9, 1.92 |
| 60/40 | 90/10 (55%) | 90/10 (50%) | 91/11 (61%) | 50 ± 19, 2.17 |
| 50/50 | 91/9 (45%) | 90/10 (n/a) | 89/11 (n/a) | 50 ± 9, 1.97 |
| 40/60 | 90/10 (n/a) | 86/14 (51%) | 90/10 (13%) | 46 ± 5, 1.95 |

TABLE 5
2,2-Dimethylpropanal (DMP): Synthetic data for poly(phthalaldehyde-2,2-
dimethylpropanal) copolymer series

| Feed Ratio | Triplicate Copolymerizations | | | Avg GPC Data |
|---|---|---|---|---|
| oPHA/DMP | Composition (Yield) | Composition (Yield) | Composition (Yield) | Mₙ (kDa), Ð |
| 90/10 | 99.5/0.5 (78%) | 99.4/0.6 (81%) | 99.5/0.5 (83%) | 83 ± 3, 1.67 |
| 80/20 | 99/1 (78%) | 99/1 (77%) | 99/1 (77%) | 56 ± 4, 1.68 |
| 67/33 | 98/5 (44%) | 96/4 (24%) | 97/3 (58%) | 19 ± 10, 1.94 |
| 60/40 | 98/2 (34%) | 96/4 (44%) | 97/3 (50%) | 16 ± 5, 1.91 |
| 50/50 | 97/3 (32%) | 96/4 (37%) | 95/5 (30%) | 13 ± 4, 1.94 |
| 40/60 | 94/6 (5%) | 95/5 (28%) | 96/4 (16%) | 9 ± 4, 1.64 |

TABLE 6
Statistics of best-fit lines used to calculate the
incorporation ratios of DMP, PA, HA, and PAA.
Values calculated using linest function in Microsoft Excel.

| Statistic | DMP | PA | HA | PAA |
|---|---|---|---|---|
| Slope (incorporation ratio) | 0.0828 | 0.2729 | 0.3006 | 0.5110 |
| Standard error in slope | 0.0051 | 0.0168 | 0.0066 | 0.0102 |
| r² | 0.9345 | 0.9390 | 0.9961 | 0.9928 |

TABLE 7
Reactivity ratios for PHA with DMP, PA, HA, and PAA.
Calculated by using the Kelen-Tüdös
method (Kelen, T.; Tüdös, F.. Polym. Bull. 1980, 2, 71-76).

| Monomer #2 | r_{PHA} | r₂ |
|---|---|---|
| DMP | 54 | −0.49 |
| PA | 6.6 | −0.25 |
| HA | 3.5 | −0.27 |
| PAA | 2.0 | −0.17 |

In FIG. 2, panel a, the mole percentage of the aliphatic monomer in the feed (f_{B}) and resulting mole percentage incorporation of aliphatic monomer in the copolymer (F_{B}) are shown. The copolymer uptake into the PHA-based copolymer is less than the stoichiometric amount in the feed for every comonomer. Kaitz and Moore introduced the incorporation ratio, a simple experimentally derived parameter obtained by the slope of the best-fit line from plotting F_{B} against f_{B}, that can be used to compare the relative reactivity between monomers (Kaitz, J. A., and Moore, J. S., 2013, Macromolecules, 46(3), pp. 608-612). Common approaches to reactivity analysis do not apply because the low T_{C} affects the ability for monomers to depropagate during polymerization. The Mayo-Lewis approach fails because their assumption that the addition of a new monomer to a growing polymer chain is irreversible does not hold. In the present case, PHA units are likely free to reversibly shuttle in and out of the growing polymer chain as evidenced by the polymer scrambling studies on PHA derivatives (Kaitz, J. et al., 2013, Macromolecules, 46(20), pp. 8121-8128). The extended Kelen-Tüdös model produces negative reactivity ratios for aliphatic aldehydes and unusually large values for PHA (Tüdös, F., et al., J. Macromol. Sci. Part A—Chem., 10(8), pp. 1513-1540). When the polymer is formed at temperatures near T_{C}, the depropagation of monomers is not negligible and one must consider the reverse rate. Although such models exist, they can be very nonlinear, difficult to accurately calculate, and can utilize parameters that would be unknown in this system.

The copolymer compositions show near linear profiles, FIG. 2, panel a. The experimental incorporation ratios were determined by applying a best-fit line to the data that also runs through the origin. A positive correlation was found with the hydration equilibrium constants (K_{H}) for the comonomer, which is readily available for aldehydes (Guthrie, J. P., 2000, J. Am. Chem. Soc., 122(23), pp. 5529-5538; Hilal, S. H., et al., 2005, QSAR Comb. Sci., 24(5), pp. 631-638; Hanke, V.-R., et al., 1987, J. Chem. Soc. Faraday Trans. 1, 83(9), pp. 2847-2856). K_{H} is the equilibrium constant for the addition reaction of water to an aldehyde to form a gem-diol product, and a larger K_{H} value signifies that the aldehyde more readily undergoes the addition reaction. The significance of this is apparent when considering aldehydes with higher K_{H} values are more electron-deficient, which is advantageous for the cationic polymerization mechanism, Scheme 4. The growing chain end in cationic aldehyde polymerizations can be thought of as an oxonium ion, where propagation occurs with the nucleophilic attack of an aldehyde monomer to the electrophile at the polymer chain end. Creating a larger positive charge on the aldehyde carbon through the use of nearby electron-withdrawing groups improves its ability to act as an electrophile, facilitates the transition from sp² to sp³ configuration, and ultimately shifts the equilibrium towards polymerization. These results are consistent with the previous observation that benzaldehyde reactivity to anionic copolymerization with PHA improved with larger Hammett values (Kaitz, J. A., and Moore, J. S., 2013, Macromolecules, 46(3), pp. 608-612).

The uptake of HA into the PHA-HA copolymer was linearly related to the feed concentration for values ≤33 mol %. Copolymerization at higher HA feeds sometimes resulted in a heterogeneous solution with needle-like crystals that would dissolve upon warming the solution from −78° C. The crystals were separated from the cold reaction solution and appeared to be almost entirely HA trimer, as determined by ¹H-NMR analysis. There was a sharp triplet at δ=4.80 ppm (J=5.3 Hz) and no PHA protons. It is noted that −78° C. is reportedly above the T_{C} of the DMP monomer, suggesting that there is some energetic benefit to copolymerization (Mita, I., et al., 1970, Die Makromol. Chemie, 137, pp. 155-168).

Copolymerization of a variety of aldehyde monomers with PHA was attempted to investigate the functional group tolerance of this polymerization chemistry. The copolymerization results are reported in Table 8, with the successful copolymers shown in Scheme 6. Electron-rich aldehydes are less reactive comonomers in PHA polymerization. It was found that electron-rich t-cinnamaldehyde, methyl formate, and formylferrocene were not incorporated in the PHA copolymer. Presence of any of these monomers in the reaction did not inhibit the polymerization of PPHA homopolymer, they simply did not participate. Copolymerization of PHA with electron-deficient benzaldehydes also showed no incorporation yielding only PPHA homopolymer. It is noted that 2,4-dinitrobenzaldehyde was previously shown to have an incorporation ratio of 0.71, however, it was by anionic copolymerization with PHA which is a different mechanism. The addition of BF₃OEt₂ to the PHA copolymerization mixture containing 3-methylthiopropanal resulted in the immediate formation of a precipitate, presumably due to Lewis acid-base reaction between the thioether and boron trifluoride, and no polymer was formed. Aldehyde polymerizations have been cited as being intolerant of protic functional groups and impurities. The incompatibility of strong Lewis bases with the boron trifluoride Lewis acid catalyst in the cationic polymerization potentially prevents many heteroatom-based functional groups from being used and limits the choice of monomers in this system.

TABLE 8
Synthetic data for PHA based copolymers with various aldehydes

| | | | | | | | | Batch |
|---|---|---|---|---|---|---|---|---|
| | | [M]: | Time | Mₙ | | | Yield | size |
| Comonomer B | f_{B} (%) | [I] | (min) | (kDa) | Ð | F_{B} (%) | (%) | (mmol) |
| 2,3,5- | 40% | 500 | 60 | 14 | 2.26 | 0% | 38% | 6.2 |
| Trichlorobenzaldehyde | | | | | | | | |
| 2,4- | 40% | 100 | 60 | 124 | 1.69 | 0% | 41% | 15.0 |
| Dinitrobenzaldehyde | | | | | | | | |
| 3-Bromo-5- | 40% | 500 | 60 | 39 | 1.57 | 0% | 30% | 18.7 |
| nitrobenzaldehyde | | | | | | | | |
| Formyl Ferrocene | 50% | 100 | 60 | — | — | — | 0% | 15.0 |
| Methyl formate | 50% | 500 | 60 | 9.5 | 2.06 | 0% | 37% | 22.4 |
| Butanal | 50% | 750 | 60 | 33 | 2.10 | 10% | 53% | 22.4 |
| 2-Ethylbutanal | 40% | 380 | 60 | 64 | 1.93 | 9% | 42% | 24.6 |
| 2-Ethylbutanal | 40% | 380 | 60 | 44 | 2.15 | 9% | 40% | 24.6 |
| 2-Ethylbutanal | 40% | 750 | 60 | 51 | 1.97 | 9% | 38% | 24.6 |
| t-Cinnamaldehyde | 20%- | 500 | 60 | 5.3- | 1.62- | 0% | 18%- | 22.4 |
| | 50% | | | 17 | 2.28 | | 28% | |
| 4-Pentenal | 20% | 500 | 60 | 21 | 2.38 | 9% | 61% | 18.7 |
| 4-Pentenal | 40% | 500 | 60 | 13 | 1.75 | 14% | 48% | 6.2 |
| 4-Pentenal | 40% | 750 | 60 | 15 | 1.837 | 12% | 45% | 12.4 |
| 4-Pentenal | 40% | 500 | 60 | 11 | 1.92 | 13% | 51% | 18.7 |
| 4-Pentynal | 20% | 100 | 60 | 34 | 1.79 | 2% | 73% | 15.0 |
| 4-Pentynal | 40% | 100 | 60 | 15 | 1.54 | 4% | 56% | 15.0 |
| 4-Pentynal | 50% | 100 | 60 | 9 | 1.49 | 5% | 32% | 15.0 |
| Norbornene-2- | 10% | 100 | 60 | 40 | 1.63 | 4% | 76% | 15.0 |
| carboxaldehyde | | | | | | | | |
| Norbornene-2- | 33% | 100 | 60 | 22 | 1.7 | 14% | 39% | 15.0 |
| carboxaldehyde | | | | | | | | |
| Norbornene-2- | 50% | 100 | 60 | 17 | 2.11 | 23% | 29% | 15.0 |
| carboxaldehyde | | | | | | | | |
| 10-Undecenal | 25% | 767 | 1360 | 27 | 3.38 | 8% | 63% | 29.8 |
| 10-Undecenal | 40% | 500 | 60 | 23 | 3.23 | 7% | 51% | 24.6 |
| 10-Undecenal | 40% | 500 | 1380 | 17 | 3.11 | 9% | 44% | 62.0 |
| 10-Undecenal | 40% | 1000 | 2900 | 18 | 2.36 | 10% | 50% | 187.0 |
| 2-Chlorobutanal | 10- | 100 | 60 | 6-35 | 1.5- | <1% | 30-80% | 15.0 |
| | 50% | | | | 2.2 | | | |
| 2-Chlorobutanal | 10% | 100 | 1440 | 19 | 1.65 | 2% | 78% | 15.0 |
| 2-Chlorobutanal | 20% | 100 | 1440 | 5 | 2.05 | 8% | 67% | 15.0 |
| 2-Chlorobutanal | 33% | 100 | 1440 | 5 | 1.46 | 22% | 41% | 15.0 |
| 2-Chlorobutanal | 40% | 100 | 1440 | 2.4 | 1.65 | 17% | 30% | 15.0 |
| 2-Chlorobutanal | 50% | 100 | 1440 | 2.6 | 1.39 | 21% | 29% | 15.0 |
| 4-Chlorobutanal | 20% | 100 | 60 | 82 | 1.61 | 6% | 73% | 15.0 |
| 4-Chlorobutanal | 40% | 100 | 60 | 48 | 1.74 | 10% | 52% | 15.0 |
| 4-Chlorobutanal | 50% | 100 | 60 | 27 | 1.73 | 8% | 58% | 15.0 |
| 3-Methylthiopropanal | 20%- | 500 | 60 | — | — | — | 0% | 22.4 |
| | 60% | | | | | | | |
| 4-Tosyloxybutanal | 20% | 100 | 60 | 75 | 1.66 | 4% | 64% | 15.0 |

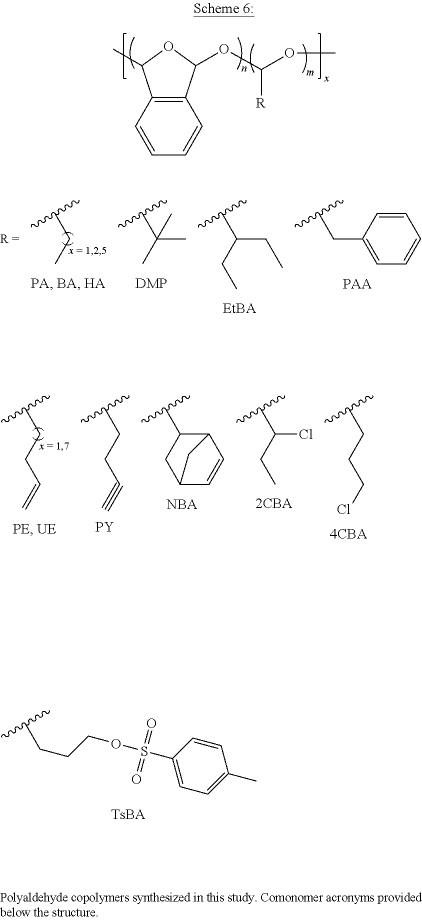

Branching doesn't seem to inhibit the polymerization until creating a quaternary carbon at the α-position that is too electron-donating, given by the F_{B} results of 2-ethylbutanal and DMP. Monomer chain length affects the solubility of the trimer byproduct, which has shown to limit incorporation of the aliphatic aldehyde in the cases of HA and 10-undecenal at larger values of f_{B}. Aldehyde monomers with unsaturated functional groups can be polymerized as long as the unsaturation is not conjugated with the aldehyde group because they would become electron donating. For example, 4-pentenal, 10-undecenal, norbornene-2-carboxaldehyde and 4-pentynal were successfully copolymerized with PHA, as shown in Table 8. Alkyl halides are compatible with PHA cationic copolymerization as evidenced by the copolymerization of 2- and 4-chlorobutanal with PHA. The 2,2-dichlorobutanal impurity present within the monochloro aldehyde product also showed incorporation into the PHA copolymer indicating that the steric hindrance is not a significant factor in this case. Sulfonate esters are compatible with the polymerization chemistry as shown by 4-tosyloxybutanal, which can be useful for post-polymerization modifications.

Copolymerization of 2-chlorobutanal (2CBA) with PHA showed different polymerization kinetics. Whereas the other aliphatic aldehydes examples reacted to equilibrium within one hour, the 2CBA/PHA yielded copolymer with less than 1 mol % incorporation in a one hour reaction. Extending the polymerization time to 24 h significantly increased the 2CBA incorporation up to 22 mol % at the same feed loadings. Purifying the 2CBA monomer proved to be difficult as the compound was prone to decomposing during distillation, which greatly affected the reactivity during copolymerization. It is believed that monomer purity is the reason that 2CBA did not show the even higher incorporation.

All of the copolymer NMR results indicate that the comonomer is not incorporated in long consecutive units in the polymer. One explanation for the lack of consecutive aliphatic monomer segments is the possibility for the chain to back-bite and form trioxane derivatives, visualized in Scheme 7. This reaction may be a kinetic product of the polymerization reaction if the rate of intramolecular backbiting occurs faster than the propagation of a new monomer to the chain end. Once formed, the trioxane compound is kinetically trapped and is not active in the polymerization.

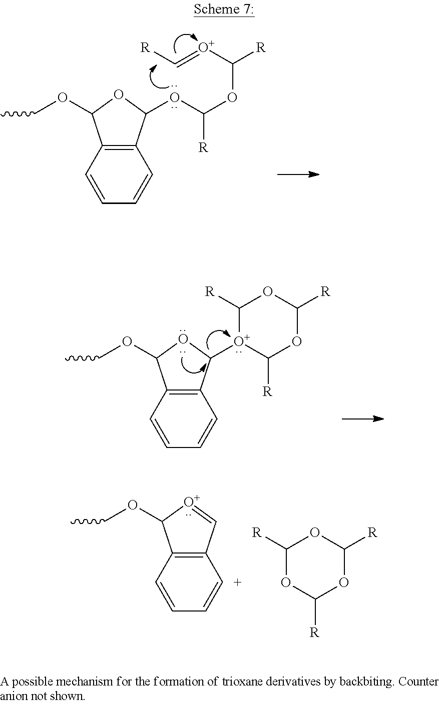

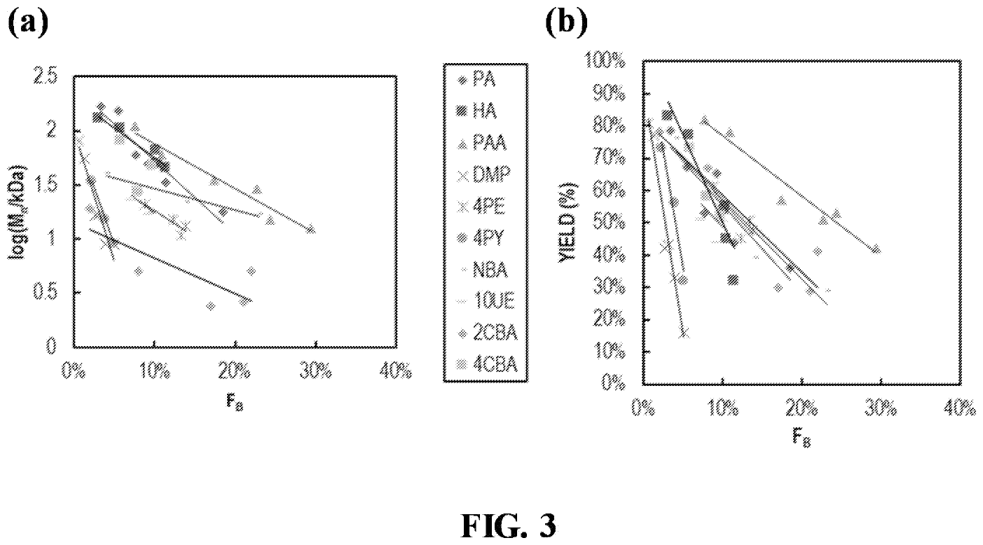

The copolymerization results across the aldehydes share a common trend where both the molecular weight and yield decrease with comonomer incorporation into the PHA copolymer (F_{B}), seen in FIG. 3, panel a and b. A similar trend between molecular weight and polymer yield has been observed for PPHA homopolymer (Schwartz, J. M., et al., 2017, J. Polym. Sci. Part A Polym. Chem., 55(7), pp. 1166-1172). Given that the conversion has been shown to track with polymerization temperature (Schwartz, J. M., et al., 2018, J. Polym. Sci. Part A Polym. Chem., 56(2), pp. 221-228), and the reduced copolymerization yield at increasing feed values of f_{B}, it is likely that these copolymers are being thermodynamically limited. In fact, the results indicate that the aliphatic aldehydes are behaving as if it is still above its T_{C}, even though reports place the T_{C} values of PA in pentane to around −48° C. (Lebedev, B. V., et al., 1992, J. Therm. Anal., 38(5), pp. 1299-1309). This is supported by the evidence that PA-based copolymerizations where f_{B}>70% does not yield polymer, and the lack of consecutive PA monomer signals from spectroscopic analysis. The inability to polymerize aliphatic aldehydes can be explained by the affect that solvent medium has on Eq. 1 (Ivin, K. J., 2000, J. Polym. Sci. Part A Polym. Chem., 38(12), pp. 2137-2146). Realistically, the initial monomer concentration term, [M]₀, should be replaced with the activity of the monomer, a_{B}, and the activity coefficients, γ_{B}, of the monomers are affected by the polarity of the medium. Changing the solvent from pentane to DCM can change γ_{B} enough to bring the T_{C} of the monomer below −78° C., the reaction temperature used in this study. This is supported by the thermodynamic reaction parameters for the trimerization of butanal, where values obtained in a nonpolar solvent, pentane, were more exothermic and exoentropic than a polar solvent, DCM. This improved polymerizability in nonpolar solvents is in agreement with results from the anionic polymerization of aliphatic aldehydes (Vogl, O., 1967, J. Macromol. Sci. Part A—Chem., 1(2), pp. 243-266). Based on this observation, the toluene-based polymerizations might be expected to give higher conversions of PA, but the solubility issues previously discussed may have diminished any beneficial effects.

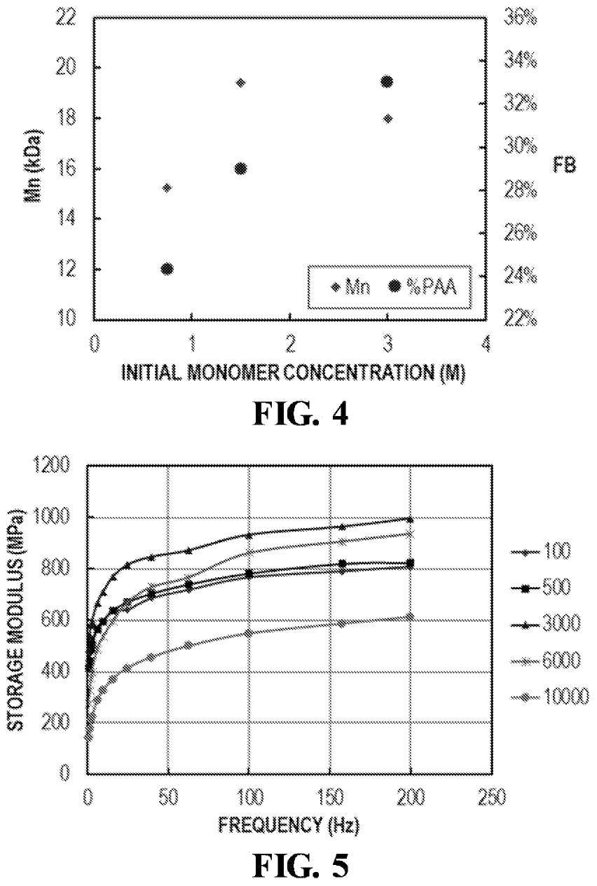

Another way to test the hypothesis that the thermodynamics are limiting the copolymerization is to increase the monomer concentration in the reaction. According to Eq. 1, doing this should increase the activity of the monomer and help overcome the entropy within the system to help raise the T_{C} of the monomer mixture (Ivin, K. J., 2000, J. Polym. Sci. Part A Polym. Chem., 38(12), pp. 2137-2146). FIG. 4 shows the molecular weight and composition of a series of p(PHA-PAA) copolymers where the only difference was the concentration of the reaction solution. As [M]₀ is quadrupled from 0.75 M to 3 M, the composition of the resulting copolymer increases from 24 to 33 mol % PAA. Although the changes in molecular weights are comparatively minimal it is a slight disruption from the trend in FIG. 3, panel a and b, that the molecular weight decreases with increasing F_{B}. If the homopolymerization of the aliphatic aldehydes is not achievable in this system then there is must be some energetic benefit to copolymerizing aliphatic aldehydes with PHA, or its incorporation would not occur. This is supported by the results from Schwartz et al. who calculated the enthalpy of copolymerizing butanal with PHA to be slightly more exothermic than the trimer formation in DCM (Schwartz, J. M., et al., 2018, J. Polym. Sci. Part A Polym. Chem., 56(2), pp. 221-228).

1.2.4 Reactions with Polyaldehyde Copolymers

Post-polymerization reactions can be used to introduce functional groups into the copolymer that are incompatible with the polymerization chemistry itself. The choice of chemistry for post-polymerization reactions is somewhat limited to mild acid/base or temperature conditions so as not to initiate polymer degradation. Scheme 8 shows examples of polymer modifications carried out in this study. Epoxide functional groups were created by oxidation of p(PHA-UE) copolymers with m-chloroperoxybenzoic acid in the presence of NaHCO₃ to quench the acidic byproducts. ¹H-NMR showed complete conversion of the terminal alkenes into epoxide groups, and an average isolated polymer yield of 50%. The epoxide ring could be ring-opened by subsequent reactions with amines, alcohols, carboxylic acids or anhydrides.

Azide functional groups were introduced into the copolymer via nucleophilic substitution of p(PHA-4CBA) and p(PHA-TsBA) using NaN₃ in dimethylformamide. Substitution of the terminal chloride was limited to conversions of −15% at 25° C., and 50% at 40° C. after reaction for 24 h. Tosylate is an excellent leaving group. It was completely converted to the azide overnight at room temperature with a polymer yield of 35%.

Thiol-ene click reactions can be used for polyaldehyde functionalization. The radical-based reaction was used to crosslink the polyaldehyde films in an effort to improve the mechanical properties of the low molecular weight copolymer films. Crosslinking parameters were optimized for the concentration of polymer, thiol-to-alkene ratio, photoradical initiator content, and 248 nm exposure dose using a system of p(PHA-UE) with pentaerythritol tetrakis(3-mercaptopropionate) in THF with azobis(isobutyronitrile) as the radical generator. Results were compared by evaluating the swelling ratio of the crosslinked films in THF. Films that would fully dissolve in the THF were considered un-crosslinked.

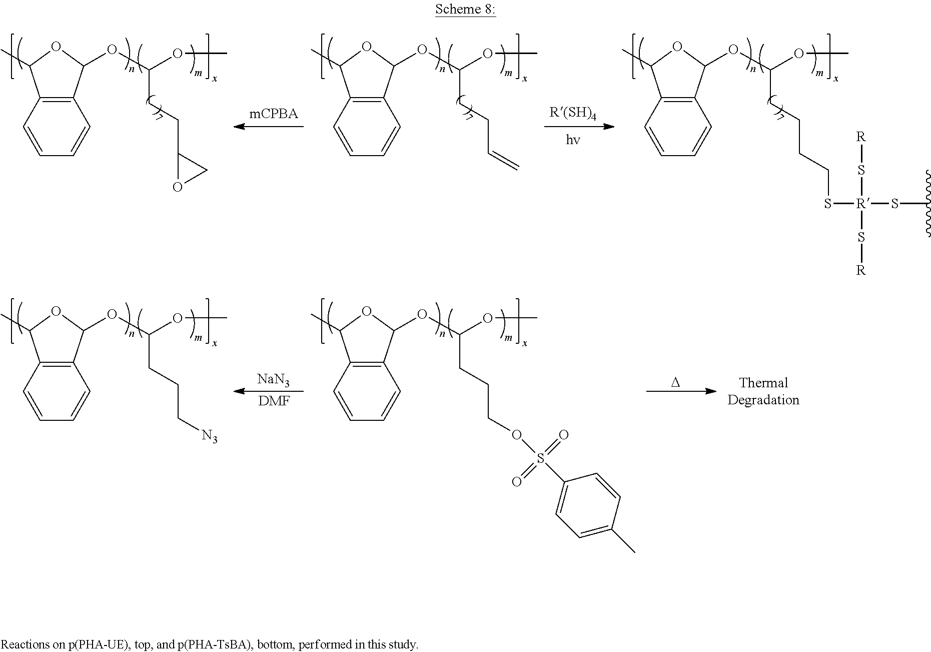

Dried copolymer films did not exhibit evidence of crosslinking, given by total dissolution in the swelling experiment. One hypothesis for this result is that the glassy nature of the polyaldehydes does not permit sufficient chain mobility for thiol crosslinking agents to find the multiple alkene sites necessary to reach a crosslink density which results in insoluble films. Dissolving the components in THF to improve chain mobility led to crosslinked, insoluble films at concentrations of 30-50 wt % p(PHA-UE) in THF. The film quality deteriorated with formulations greater than 40 wt % polymer resulting in bubble defects throughout the film. Increasing the radical generator loading at a constant UV exposure dose led to a higher degrees of polymer degradation as could be observed by the yellowing of the films and PHA monomer odor. It was found that omission of the free radical generator still resulted in polyaldehyde crosslinking, presumably through the formation of thiyl radicals by 248 nm radiation (Cramer, N. B., et al., 2002, Macromolecules, 35(14), pp. 5361-5365). Omitting the thiols and relying on free radical alkene reactions did not crosslink the polymers at ambient temperatures. The thiol-to-alkene ratio of 1 showed the highest crosslink density, as given by the lowest degree of swelling. FIG. 5 shows the storage modulus for a series of films with varying degrees of 248 nm UV exposure. The maximum modulus occurred at an exposure dose of 3000 mJ/cm². Below this dose there is very little crosslinking, and above this dose the polymer displayed signs of degradation, especially the sample at 10000 J/cm². This increase in mechanical strength is indicative of a chemical crosslinking increase in molecular weight.

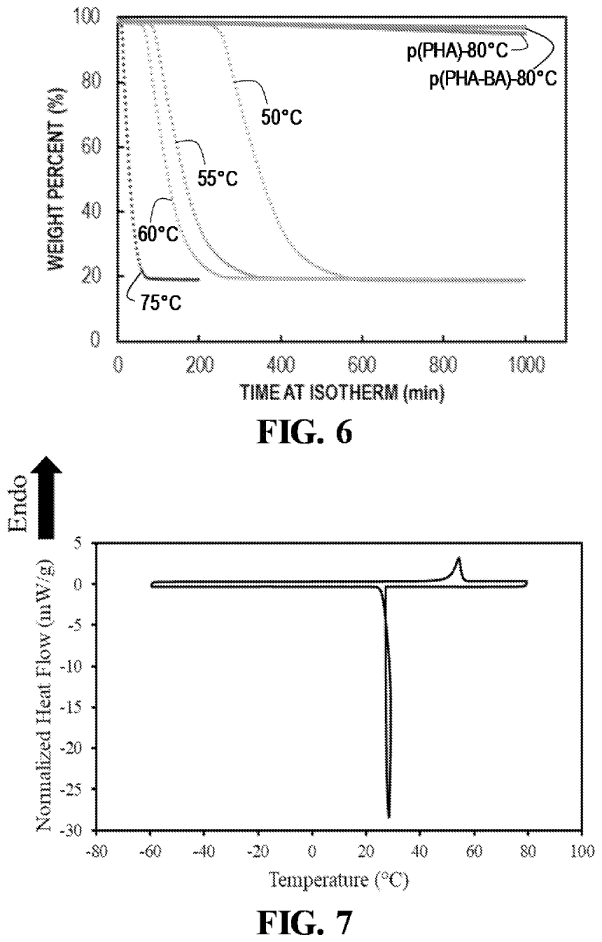

The tosylate group on the p(PHA-TsBA) copolymer can act as a thermal trigger for the decomposition of the polymer at a T_{d,onset}=95° C., compared to the rest of the copolymers that begin to thermally degrade at 150±20° C. It is hypothesized that p-toluenesulfonic acid is formed after the thermally induced dissociation and elimination of the tosylate group, which is then able to attack and degrade the polymer. FIG. 6 shows isothermal TGA runs for a 4 mol % TsBA containing copolymer at 50 to 75° C. Isotherms for p(PHA) and p(PHA-BA), 10 mol % BA, at 80° C. are shown for comparison to highlight the difference in thermal stability when adding the tosylate group. The 20 wt % residue remaining after long times in FIG. 6 is likely caused by TsOH side reactions with the degraded products. The 20 wt % remaining is not solely due to the TsBA monomer because it represents only about 5 wt % of the copolymer.

### 2 Conclusions

Cationic copolymerizations between o-phthalaldehyde and aliphatic aldehydes showed that the Lewis acid catalyst and solvent choice have strong effects on the copolymer composition, conversion and final molecular weight. Aliphatic aldehyde reactivity for copolymerization with PHA increases with the electron-deficiency of the aldehydes. It has also been shown that the comonomer reactivity correlates with the hydration equilibrium constant of the aldehyde monomer, which can provide a method to screen future aldehyde monomer candidates. Under the conditions in this study, it is likely that the aliphatic aldehydes are operating below their respective ceiling temperatures, but are still able to copolymerize with PHA. A photo-induced thiol-ene crosslinking study examined the ability to improve the mechanical properties of low molecular weight copolymers. These functionalizable, metastable copolymers lend themselves well to engineering applications in transient technologies and stimuli-responsive devices.

### Example 2: Synthesis of Various Aldehydes and their Polymerization with o-Phthalaldehyde

### 2.1 Materials

Unless otherwise stated, all starting materials were obtained from commercial suppliers and used without further purification. Anhydrous dichloromethane (DCM) was obtained from EMD Millipore. ACS grade tetrahydrofuran (THF), chloroform and methanol (MeOH) were purchased from BDH Chemicals. o-Phthalaldehyde (oPHA), >99.7%, was purchased from TCI and used as-received. Boron trifluoride diethyl etherate (BF₃—OEt₂), ca. 48% BF₃, was purchased from Acros Organics. Ethanal (EA), heptanal (HA), 4-pentenal (PE), 2,2-dimethylpropanal (DMP), 3-methylthiopropanal, 2,4-dinitrobenzaldehyde (98%), p-toluenesulfonyl chloride, 1,4-butandiol, pyridine, and anhydrous toluene were purchased from Alfa Aesar. Oxalyl chloride, 2-ethylbutanal (EB), propanal (PA), phenylacetaldehyde (PAA), and 10-undecenal (UE) were purchased from Acros Organics. 3-cyclohexene-1-carboxaldehyde (CHE) and butanal (BA) were purchased from Aldrich. 4-pentynol, dimethylsulfoxide, and 4-chlorobutanol (technical, 85%) were purchased from Beantown Chemical. Triethylamine and sulfuryl chloride were purchased from VWR.

### 2.2 Instrumentation

Nuclear magnetic resonance spectra were measured on a Bruker Avance III 400 MHz or Bruker Avance III HD 700 MHz spectrometers in the Georgia Tech NMR Center. Chemical shifts are reported in 8 (ppm) relative to residual chloroform peak (8=7.26 ppm). A T₁ decay experiment was performed to ensure that when analyzing samples the slowest peak still had >99% recovery after a magnetic pulse (Traficante, D. D. et al., Concepts Magn. Reson. 1992, 4, 153-160). Gel permeation chromatography (GPC) analyses were measured on a system composed of Shimadzu GPC units (DGU-20A, LC-20AD, CTO-20A, and RID-20A) utilizing a refractive index detector, a Shodex column (KF-804L), with HPLC grade THF (1 mL/min flow rate at 30° C.) eluent. The GPC was calibrated using a series of linear, monodisperse polystyrene standards from Shodex. Thermal gravimetric analysis (TGA) was measured on a TA Instruments TGA Q50. TGA heating rates were maintained at 5° C./min for all samples unless otherwise stated. Dynamic mechanical analysis (DMA) was performed on a TA Instruments DMA Q800, using a frequency sweep at oscillations of 0.01% strain and temperature of 30° C.

### 2.2. Synthetic Procedures

### 2.2.1 General Swern Oxidation Procedure to Synthesize Aldehydes

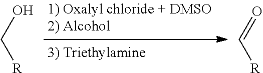

A flame dried three-neck round bottom flask was charged with 1.2 equivalents of oxalyl chloride and DCM (2.7 mL/mmol oxalyl chloride), then subsequently cooled to −78° C. under an argon atmosphere. 2.4 equivalents of dimethyl sulfoxide (DMSO) and DCM (0.4 mL/mmol DMSO) were charged into an addition funnel and added dropwise into the chilled oxalyl chloride solution. The solution stirred for 10 min, and then 1 equivalent of alcohol starting material and DCM (1.8 mL/mmol alcohol) was charged into the additional funnel and added dropwise to the reaction. The reaction stirred for 45-60 min after complete addition of the alcohol. Triethylamine was then added dropwise through the addition funnel. The reaction stirred for another 20 min before being warmed to room temperature. Water was added to the solution, separated from the organic phase, and washed with DCM three times. Combined organic layers were washed with 1.5 M HCl, saturated NaHCO₃, and brine; dried over MgSO₄, filtered and concentrated. Depending on the purity of the resulting aldehyde product, further purification was carried out through flash chromatography on silica gel or by vacuum distillation.

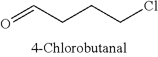

This compound was synthesized by the general Swern oxidation procedure. 4-Chlorobutanol (85%, technical grade) was used as received for the reaction. Obtained as clear oil after distillation, 64% yield. NMR signals match previous literature reports. ¹H-NMR (400 MHz, CDCl₃) δ 9.72 (s, 1H), 2.59 (d, 2H), 2.01 (m, 2H), 1.86 (m, 2H). ¹³C-NMR (400 MHz, CDCl₃) δ 200.9 ppm, 44.1 ppm, 40.8 ppm 24.8 ppm.

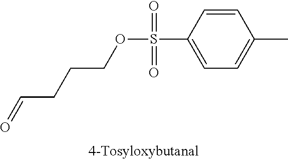 [SMILES: Cc1ccc(S(=O)(=O)OCCCC=O)cc1]

The 4-tosyloxybutanol starting material was synthesized by reacting an excess of 1,4-butanediol with p-toluenesulfonyl chloride in the presence of pyridine. The compound was isolated by column chromatography; eluent was a gradient from 1:1 to 9:1 of ethyl acetate-to-hexanes. 4-Tosyloxybutanal was synthesized by the general Swern oxidation procedure. Purified by column chromatography with DCM as eluent, R_{f}=0.43, obtained as clear oil, 55% yield. NMR signals match previous literature reports. ¹H-NMR (400 MHz, CDCl₃) δ 9.73 (s, 1H), 7.77 (d, 2H), 7.36 (d, 2H), 4.07 (t, 2H), 2.56 (t, 2H), 2.45 (s, 3H), 1.97 (quin, 2H).

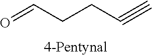

Synthesized by the general Swern oxidation procedure. Obtained as clear oil after distillation, 62% yield. NMR signals match previous literature reports. ¹H-NMR (400 MHz, CDCl₃) δ 9.79 (s, 1H), 2.69 (t, 2H), 2.51 (m, 2H), 1.98 (t, 1H).

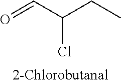

This compound was synthesized in a similar procedure to Stevens and Gillis. A flame dried 500 mL round bottom flask equipped with reflux condenser and addition funnel was held under inert atmosphere and charged with 0.56 moles of butanal. The apparatus was cooled to −5° C. using an ice bath. 0.56 moles of sulfuryl chloride was added dropwise via addition funnel, taking care to not let the solution rise above 40° C. After addition, the reaction was heated in an oil bath at 42-45° C. for two hours, and then stirred at room temperature for 18 hours. Volatiles were removed under reduced pressure. Distillation of the faintly yellow oil was carried out over calcium sulfate at 45-50° C. and 10-30 torr to afford 2-chlorobutanal as a clear oil, 40% yield. A small amount of 2,2-dichlorobutanal (<8%) and butanal (<2%) impurities were present. ¹H-NMR (400 MHz, CDCl₃) δ 9.46 (s, 1H), 4.10 (m, 1H), 2.01 (m, 1H), 1.87 (m, 1H), 1.04 (t, 3H). ¹³C-NMR (400 MHz, CDCl₃) δ 195.5 ppm, 65.5 ppm, 25.6 ppm, 10.2 ppm.

### 2.2.2 Monomer Purification

Aldehyde monomers readily form diol products on contact with water, so drying, purification, and storage are necessary for reproducible copolymer synthesis. oPHA was stored in a nitrogen rich glovebox. Aliphatic aldehyde monomers were purified by distillation over desiccant to remove acidic and water impurities. Propanal was distilled under inert, atmospheric pressure over calcium hydride. Larger aliphatic aldehydes were distilled at reduced pressure over calcium sulfate. All distilled monomer containers were filled with argon gas, sealed, and stored in a nitrogen rich glovebox.

2.2.2 General Copolymerization of o-Phthalaldehyde and Aliphatic Aldehydes

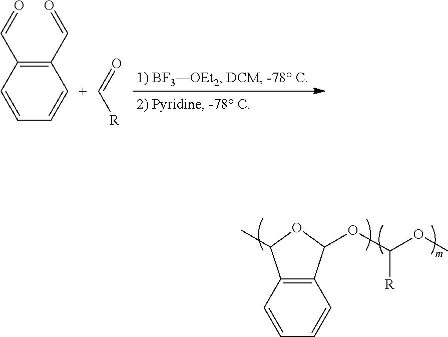

Glassware was cleaned several times with DCM and dried in an oven prior to use, and reaction prep was performed in a nitrogen rich glovebox. To a 100 mL round bottom flask was added a desired amount of oPHA. Anhydrous DCM was added to bring the total monomer concentration to 0.75 M. Next the desired amount of comonomer was added to the solution and the flask sealed. This order of addition helps prevent vaporization of volatile comonomers like ethanal and propanal. A diluted catalyst solution was prepared in a separate vial with stock BF₃—OEt₂ and anhydrous DCM. A volume less than 0.5 mL of this solution was added to the reaction flask via syringe. Reactions took place at reduced temperatures, typically −78° C., and allowed to react for a desired length of time, typically one hour. Pyridine (67 mole excess to BF₃—OEt₂) was injected to quench the polymerization. The reaction was allowed to mix with pyridine for 30-90 min before being precipitated dropwise into vigorously stirred MeOH. The precipitation bath was stirred for >2 hours before filtering and allowing the white solid polymer to air dry overnight. If a second precipitation was required, it was performed by dissolving the polymer in THF and precipitating into hexane or MeOH. Precipitations that resulted in fine white powders tended to exhibit better shelf-life than dense precipitates.

### 2.3. Copolymerization Data

Copolymer composition was measured by comparing integrations from the ¹H-NMR spectrum. Gravimetric yield is reported. Unless otherwise stated, polymerizations were run on a basis of 22.4 mmol of monomer and a monomer-to-catalyst ratio of 500:1.

### Example 3: Synthesis of Stabilized Copolymer Compositions

Devices made from polymeric materials are often fabricated with long-life objectives. However, there are devices that have limited mission life or those where recovery of the component is inconvenient or not desired. Such devices can be made from transient polymers where liquification and/or vaporization is preferred over recovery and solid-waste disposal. Transient polymers are those who decompose or depolymerize upon external triggering (such as from an optical, electrical, acoustic, or thermal stimulus), or which simply react with time. The goal is to have these devices become invisible on command. Previous studies have shown that polyaldehydes, including poly(phthalaldehyde) and its copolymers with other aldehydes, have a ceiling temperature below room temperature and can be used as transient polymers in fabricating devices. The devices include electronic components (such as printed circuit boards or packages) and larger systems such as drones and parachutes. It has also been shown that there are multiple means of triggering the depolymerization event.

There are multiple objectives in the depolymerization event including: (1) rapid response, (ii) depolymerization into liquid or vapor products at ambient temperature which may be cold (i.e., below the freezing point of water), (iii) remaining stable prior to triggering (i.e., having a long shelf-life prior to triggering), and (iv) achieving adequate mechanical properties (e.g., elastic modulus and toughness) for the device which may be different from those of the pure polymer. Optical triggering with sunlight or artificial light is particularly valuable because of the ease of irradiating a transient polymer with electromagnetic radiation.

There are difficulties in simultaneously achieving all the objectives for the transient polymer. For example, at low ambient temperature (e.g., −4° C.) phthalaldehyde (depolymerized product of poly(phthalaldehyde)) is a solid, and chemical reactivity may be slow due to the low temperature. A second example is the mechanical properties of a rigid device are different from those of a foldable or flexible device. As a result, additives, such as plasticizers can be added to improve one property or another. Table 9 shows results of mixing additives into a 50 wt % phthalaldehyde, 50 wt % phthalaldehyde-butanal copolymer. In tests 1 to 18, different amounts of poly(ethylene glycol)-bis(2-ethylhexanoate) (PEO) and bis(2-ethylhexyl)-phthalate (BEHP) plasticizers where added to the mixture. PEO lowers the temperature where the depolymerized mixture freezes but it also increases the sunlight exposure time to depolymerize the polymer (i.e., higher radiant dose is required). BEHP helps make the polymer film more ductile but does not lower the freezing point of the depolymerized mixture. In addition, BEHP phase segregates from the PHA polymer at even modest concentrations, such as 20 wt %. An ionic liquid can act as a plasticizer, such as BMP (1-Butyl-1-methylpyrrolidinium bis(trifluoromethylsulfonyl)imide). However, it was found that the ionic liquid was not an effective enough plasticizer when used at significant concentrations (e.g., 10 wt % to 40 wt %) to overcome the deficiencies of BEHP regarding the freezing point and mechanical properties. When BEHP phase segregates, it causes the film to become cloudy (interferes with optical exposure) and indicates that a good mixture is not taking place. Thus, the needed higher levels of BEHP cannot be achieved. Additional tests corresponding tests 17 and 18 in Table 9 were made where the weight percent of BMP was increased to 60 wt % and 80 wt % confirmed that higher amounts of were not an option. Thus from tests 1 to 18 in Table 9, there is no combination of additives which yields a film that is both flexible (i.e., ductile), reactive to a modest sunlight dose (i.e., less than one hour at dawn), and liquid (or vapor) at below 35° F. Substituting PEO for BEHP improves the liquid properties at low temperature but harms the photo-speed. Substituting BEHP for PEO improves the photo-speed but harms the low temperature liquification. BMP helps liquification and ductility but is limited to concentrations less than 40 wt %.

In this discovery and invention, it was surprisingly found that high concentrations of the ionic liquid (e.g., BMP) overcome phase segregation problems of BEHP and result in a film with superior toughness, photo-speed, and low freezing point. With this invention of very high MMP amounts, adequate amounts of BEHP can be used to achieve liquification at low temperature, ductility at all temperatures tested, and fast photo-speed (i.e., low-dose optical exposures). It was discovered that very high concentrations of ionic liquid overcome the phase segregation problem of BEHP. Test 19 shows that 20 wt % BEHP with 100 wt % BMP has a fast photo-speed (19 minutes of sunlight exposure at 8:46 AM which corresponds to 55 minutes at dawn) and a liquid/vapor depolymerization product even at 25° F. or below. The elastic modulus can be increased by adding inert fibers (glass or acrylic), test 21. While not being bound by theory, it appears that the ionic liquid (e.g., BMP) can act as a solvent for the BEHP while held within the polyaldehyde and within the depolymerized polyaldehyde.

The use of films with high ionic liquid and BEHP can be as a single film or as one part of a composite film. The composite film can be made combining more than one film into a single composite. For example, one layer of the composite may be of a composition which is more ductile or tougher while another layer may have a higher photo-sensitivity. Alternatively, one layer may have glass or acrylic fibers and another layer would not. Such a scenario may minimize the amount of solid fiber or allow greater light penetration. Composite structures can have a synergistic effect where the net properties are greater than the sum of the properties from the individual layers.

TABLE 9
Stabilized Copolymer Compositions

| | | | Ionic | | | | | | Elastic |
|---|---|---|---|---|---|---|---|---|---|
| | Plasticizer | | Liquid | Fiber | | | Test | | Modulus |
| Test | PEO | BEHP | BMP | Glass | Acrylic | Time | Temp | Freezing Point | (MPa) |
| 1 | | 3% | 30% | 20% | | 2 min @ 10:14am | 42 F. | Crystallize | 1253.52 |
| | | | | | | (26 min at dawn) | | Immediately | |
| 2 | | 3% | 30% | 20% | | 50 sec @ 1:48pm | 62 F. | Liquid outside | |
| | | | | | | (21 min at dawn) | | | |
| 3 | | 5% | 30% | 20% | | 2 min @ 10:14am | 42 F. | Crystallize | 813.333 |
| | | | | | | (26 min at dawn) | | Immediately | |
| 4 | | 5% | 30% | 20% | | 50 sec @ 1:48pm | 62 F. | Stay liquid | |
| | | | | | | (21 min at dawn) | | outside | |
| 5 | | 7% | 30% | 20% | | 2 min @ 10:14am | 42 F. | Crystallize | 683.108 |
| | | | | | | (26 min at dawn) | | Immediately | |
| 6 | | 7% | 30% | 20% | | 50 sec @ 1:48pm | 62 F. | Stay liquid | |
| | | | | | | (21 min at dawn) | | outside | |
| 7 | 5% | | 20% | 20% | | 20 min @ 9:38am | 37 F. | Crystallize | 1595.56 |
| | | | | | | (79 min at dawn) | | Immediately | |
| 8 | 5% | | 20% | 20% | | 2 min @ 1:22pm | 46 F. | Liquid state for | |
| | | | | | | (32 min at dawn) | | 2 mins | |
| 9 | 5% | | 30% | 20% | | 13 min @ 9:38am | 37 F. | Crystallize | 1538.15 |
| | | | | | | (63 min at dawn) | | Immediately | |
| 10 | 5% | | 30% | 20% | | 2 min @ 1:22pm | 46 F. | Crystallize | |
| | | | | | | (32 min at dawn) | | Immediately | |
| 11 | 5% | | 40% | 20% | | 19 min @ 9:38am | 37 F. | Crystallize | 969.253 |
| | | | | | | (76 min at dawn) | | Immediately | |
| 12 | 5% | | 40% | 20% | | 2 min @ 1:22pm | 46 F. | Liquid outside | |
| | | | | | | (26 min at dawn) | 50 F. | for short time | |
| | | | | | | 2.5 min at | | | |
| | | | | | | 12:15pm | | | |
| | | | | | | (33 min at dawn) | | | |
| 13 | 10% | | 20% | 20% | | 20 mins at 9:38am | 37 F. | Crystallize | 1152.77 |
| | | | | | | (79 min at dawn) | | Immediately | |
| 14 | 10% | | 20% | 20% | | 2.5 min @ | 46 F. | Crystallize | |
| | | | | | | 1:22pm | | Immediately | |
| | | | | | | (35 min at dawn) | | | |
| 15 | 10% | | 30% | 20% | | 24 min @ 9:38am | 37 F. | Liquid state for | 1026.57 |
| | | | | | | (87 min at dawn) | | 1 min | |
| 16 | 10% | | 30% | 20% | | 3.5 min @ | 46 F. | Liquid state for | |
| | | | | | | 1:22pm | | 3 mins | |
| | | | | | | (26 min at dawn) | | | |
| 17 | 10% | | 40% | 20% | | 24 min @ 9:38am | 37 F. | Liquid for 1 | 876.961 |
| | | | | | | (87 min at dawn) | | min | |
| 18 | 10% | | 40% | 20% | | 7 min @ 1:22pm | 46 F. | Liquid for 1 | |
| | | | | | | (57 min at dawn) | | min | |
| 19 | | 20% | 100% | 5% | | 19 min @ 8:46am | 35 F. | liquid outside/ | 36.793 |
| | | | | | | (55 min at dawn) | | freezer (25 F.) | |
| 20 | 10% | | 100% | 5% | | 65 min @ 8:46am | 35 F. | Crystalize after | 33.476 |
| | | | | | | (114 min at dawn) | | short time | |
| 21 | | 20% | 100% | | 5% | 19 min @ 8:46am | 35 F. | Liquid at 35 F. | 175.500 |
| | | | | | | (55 min at dawn) | | and freezer | |
| | | | | | | | | (25 F.) | |

2.2.2 General Copolymerization of 50 wt % Phthalaldehyde and 50 wt % Phthalaldehyde-Butanal Copolymer with Stabilizers.

Glassware was cleaned several times with DCM and dried in an oven prior to use, and reaction prep was performed in a nitrogen rich glovebox. To a 100 mL round bottom flask was added a desired amount of PHA. Anhydrous DCM was added to bring the total monomer concentration to 0.75 M. Next PHA-butanal was added to the solution and the flask sealed. A diluted catalyst solution was prepared in a separate vial with stock BF₃—OEt₂ and anhydrous DCM. A volume less than 0.5 mL of this solution was added to the reaction flask via syringe. Any additional stabilizers and/or agents were added as well. Reactions took place at reduced temperatures, typically −78° C., and allowed to react for a desired length of time, typically one hour. Pyridine (67 mole excess to BF₃—OEt₂) was injected to quench the polymerization. The reaction was allowed to mix with pyridine for 30-90 min before being precipitated dropwise into vigorously stirred MeOH. The precipitation bath was stirred for >2 hours before filtering and allowing the white solid polymer to air dry overnight. If a second precipitation was required, it was performed by dissolving the polymer in THF and precipitating into hexane or MeOH. Precipitations that resulted in fine white powders tended to exhibit better shelf-life than dense precipitates.

### Example 4: Tunable Transient and Mechanical Properties of Photodegradable Poly(phthalaldehyde)

Self-immolative polymers, such as poly(phthalaldehyde), are of interest for use in transient devices where device self-destruction avoids the need for component retrieval from the field and prevents reverse-engineering (J. A. Kaitz, et al., MRS Commun. 5 (2018) 191-204; 0. Phillips, et al., Phototriggerable Transient Electronics: Materials and Concepts, Proc.—Electron. Components Technol. Conf. (2017) 772-779; O. P. Lee, et al., ACS Macro Lett. 4 (2015) 665-668). Anionically polymerized, linear poly(phthalaldehyde) (PPHA) is a low ceiling temperature polymer which is thermodynamically unstable above its ceiling temperature, −43° C. The rapid unzipping of the polymer backbone at temperatures above −43° C. can be kinetically suppressed by end-capping the polymer chains or by synthesizing cyclic polymer chains. PPHA with thermal stability up to 160° C. has been achieved (J. A. Kaitz, et al., J. Am. Chem. Soc. 135 (2013) 12755-12761; S. T. Phillips, et al., J. Appl. Polym. Sci. 40992 (2014) 1-12; J. M. Schwartz, et al., J. Polym. Sci. Part A Polym. Chem. 55 (2017) 1166-1172; J. M. Schwartz, et al., J. Polym. Sci. Part A Polym. Chem. 56 (2018) 221-228; J. A. Kaitz, et al., Macromolecules. 47 (2014) 5509-5513; J. A. Kaitz, et al., Macromolecules. 46 (2013) 608-612; A. M. Dilauro, et al., Polym. Chem. 6 (2015) 3252-3258; D. Poly, et al., Macromolecules. 46 (2013) 2963-2968).

The acetal bonds of the backbone in PPHA are sensitive to electrophilic attack from protons which initiate rapid cationic unzipping (M. Tsuda, et al., J. Polym. Sci. Part A-Polymer Chem. 35 (1997) 77-89). Previous studies have demonstrated thermal or photo activated triggers to initiate depolymerization of PPHA. Photo acid generators (PAG) have been used to produce acids that can catalyze the depolymerization at or below room temperature (C. W. Park, et al., Adv. Mater. 27 (2015) 3783-3788; H. L. Hernandez, et al., Adv. Mater. 26 (2014) 7637-7642; H. L. Hernandez, et al., Macromol. Rapid Commun. 39 (2018) 1800046 (1-5)). Photosensitizers have been used to expand the spectral range of PAGs into the visible region (O. Phillips, et al., J. Appl. Polym. Sci. (2018) 47141 (1-12)).

Important metrics for the PPHA transient properties include photoresponse time (i.e., time to create the photo-acid), poly(aldehyde) depolymerization rate, and evaporation time of newly created, volatile products. Copolymerization of ortho-phthalaldehyde (PHA) with higher vapor pressure monomers, such as butanal (BA), has been shown to increase the evaporation rate of the depolymerized products by a factor of 12 for micrometer-thick films (J. M. Schwartz, et al., J. Appl. Polym. Sci. 136 (2019) 1-7). However, the evaporation rate decreases for depolymerized thick films because of the limited surface area of the product (less volatile concentration increases at the surface) and cooling effect from monomer evaporation. An alternative to product evaporation for device transience is liquification of the depolymerized device followed by absorption of the liquid products into the environment. The acid-catalysed depolymerization of PPHA is known to form liquid or solid products followed by the slow evaporation or sublimation of the monomers. Liquification of the depolymerized products is assisted by heat from the exothermic depolymerization reaction and incorporation of low melting point additives into the PPHA mixture (J. M. Schwartz, ADVANCES IN LOW-K AND TRANSIENT POLYMERS, Georgia Institute of Technology, 2017). The depolymerization of PPHA or poly(aldehyde) copolymers can be rapid at room temperature and has been recorded to be as fast as 33 s by quartz crystal microbalance (QCM) (J. M. Schwartz, et al., J. Appl. Polym. Sci. 136 (2019) 1-7).

Pure PPHA or p(PHA-co-aldehyde) copolymers by themselves are brittle because of the fused-aromatic-ring backbone structure. In a recent study by Hernandez, et al., it was shown that residual solvents can be used to improve the ductility and toughness or adjust the elastic modulus of PPHA structures (H. Lopez, S. K. et al., Polymer (Guildf). 162 (2019) 29-34). Once the photo-acid trigger is initiated, PPHA can achieve rapid transience via liquification and absorb into the environment as opposed to evaporation of PHA monomer over a long period of time. The liquid-state can potentially absorb into the surrounding environment where visible detection is impaired. Crystallization of the PHA monomer can occur because its freezing point, ca. 55° C. (shown in FIG. 7), is often above the ambient temperature. In addition to improving the mechanical properties, additives can lower the freezing point of the depolymerized poly(aldehyde) mixture.

In this study, additives were used to tune the mechanical properties and both maintain and improve the transient properties of poly(aldehyde) films. The effect of liquid plasticizers on the mechanical properties of poly(aldehyde) films, the physical state of the depolymerized products and the photo-transience speed was evaluated. PPHA has a high elastic modulus that is desirable for forming rigid structures, however, its brittle nature makes it unfavorable for a broader range of applications which need to fold, unfold or bend during use. Recently, a diamine and diethyl phthalate were used as plasticizers to improve film flexibility and to thermally stabilize the polymer for use at higher temperatures including hot-press molding of PPHA (A. M. Feinberg, et al., ACS Macro Lett. 7 (2018) 47-52). Plasticizers can improve the flexibility of brittle poly(aldehyde) films and suppress the freezing point of the depolymerized polymer because they disrupt the intermolecular packing of PPHA (M. Rahman, et al., Polym. Degrad. Stab. 91 (2006) 3371-3382). The chemical structure, specific functional groups, and ionic charge on the plasticizer contribute to their overall effectiveness. However, many studies have also shown that phase segregation of the plasticizers and PPHA is a primary concern with the addition of high concentrations of plasticizers (M. P. Scott, et al., Eur. Polym. J. 39 (2003) 1947-1953; A. Sankri, A. et al., Carbohydr. Polym. 82 (2010) 256-263; M. P. Scott, et al., Chem. Commun. (2002) 1370-1371). Here, two classes of plasticizers (non-ionic ether-ester, and ionic liquid) were evaluated (G. Wypych, Handbook of Plasticizers, Elsevier Ltd, 2012). Ether-ester plasticizers are expected to have the best miscibility with the PPHA backbone in films as well as with the PHA monomer to significantly improve the range of mechanical capability. Alternative plasticizers, such as ionic liquids, have previously been investigated in poly(methacrylate) and poly(vinyl chlorides) to improve the mechanical properties and lower their glass transition temperature (T_{g}). In this study, both ionic liquid and ether-ester plasticizers were evaluated. Polyethylene oxide and phthalate-based ether-ester plasticizers were chosen to evaluate the traditional plasticizer effect on PPHA. Pyrrolidinium-bis(trifluoromethylsulfonyl)imide-based ionic liquid plasticizers were specifically used in this study because of their low freezing point that favors the transience application of absorbing into environment. The chemical structures of selected plasticizers and their freezing point are shown in Table 10 (S. Berdzinski, et al., ChemPhysChem. 14 (2013) 1899-1908; V. Strehmel, et al., J. Mol. Liq. 192 (2014) 153-170). The combination of these two plasticizers in PPHA films enables a wider range of mechanical properties for a variety of structural applications with enhanced transience properties.

TABLE 10
Name of plasticizers used, their chemical structures and their freezing point.

| | | Freezing |
|---|---|---|
| Plasticizer | Chemical Structure | Point (° C.) |
| Poly(ethylene glycol) bis(2- ethylhexanoate) | 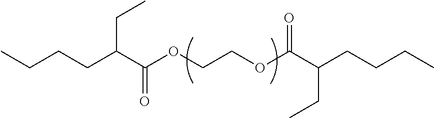 | −48 |
| Bis(2-ethylhexyl) phthalate | 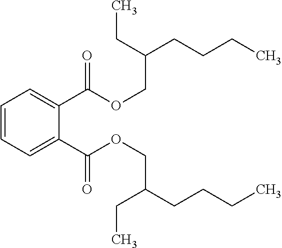 [SMILES: CCCCC(CC)COC(=O)c1ccccc1C(=O)OCC(CC)CCCC] | −50 |
| 1-Butyl-1-Methylpyrrolidinium Bis(trifluoromethylsulfonyl)imide | 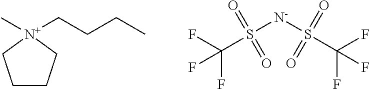 | −17 |
| 1-Hexy1-1-Methylpyrrolidinium Bis(trifluoromethylsulfonyl)imide | 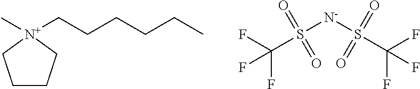 | −24 |
| 1-Methyl-1-Octylpyrrolidinium Bis(trifluoromethylsulfonyl)imide | 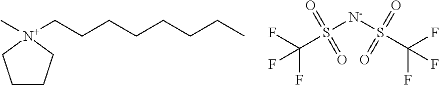 | −12 |

### 4.1 Experimental

### Materials:

Tetrakis(pentafluoropenyl)borate-4-methylphenyl[4-(1-methylethyl)phenyl]iodonium (Rhodorsil Faba) was purchased from TCI Chemicals. Anthracene was purchased from Alfa Aesar. 1-Butyl-1-methylpyrrolidinium bis(trifluoromethylsulfonyl)imide (BMP), 1-Hexyl-1-methylpyrrolidinium bis(trifluoromethylsulfonyl)imide (HMP), and 1-Methyl-1-octylpyrrolidinium bis(trifluoromethylsulfonyl)imide (OMP) were purchased from lolitec. Tetrahydrofuran (THF) was purchased from BDH. Poly(ethylene glycol) bis(2-ethylhexanoate) (PEO) with a number-average molecular weight (Mₑ) of 650 g/mole and bis(2-ethylhexyl) phthalate (BEHP) were purchased and used as received from Sigma Aldrich. All chemicals were used as received. Poly(phthalaldehyde) (PPHA) was cationically polymerized using boron trifluoride etherate (BF₃OEt₂) below its ceiling temperature (−42° C.) following the procedure of Schwartz et al. (J. M. Schwartz, et al., J. Polym. Sci. Part A Polym. Chem. 55 (2017) 1166-1172. doi:10.1002/pola.28473). Mₙ of the synthesized polymer is 340 kDa with a dispersity (D) of 1.27.

All polymer films casted for mechanical property measurement contained 10 pphr Rhodorsil FABA photoacid generator (PAG) as the photocatalyst, 2 pphr anthracene as the photosensitizer. The weight percentage of each additive is with respect to the weight of polymer. Polymer mixtures were formulated by dissolving all components in THF in a clean glass vial in a weight ratio of 10:1 THF:PPHA. Formulations were roll-mixed on a roller until fully dissolved and homogeneous. The formulations were then drop casted into PTFE solvent evaporation dishes and dried under 15 psig nitrogen for 2 days. The nitrogen overpressure slowed the THF evaporation rate and produced good quality films without bubble formation. The dry films were then peeled off and allowed to dry for two additional days in black boxes under ambient conditions.

### Characterization:

QCM experiments were performed with a Stanford Research Systems QCM 200 to quantify the solid-state kinetics of PPHA depolymerization. The Butterworth-van Dyke model was used to describe the mechanical changes of the polymer coating on the quartz crystal. Polymer formulations were made with 9.1 wt % polymer solids in cyclopentanone with 5 parts per hundred resin (pphr) of PAG and 1.05 pphr anthracene. Thin film samples were spin-coated onto a 2.54 cm QCM with 5 MHz unloaded resonant frequency and an active surface area of 0.4 cm². An open-faced holder was used to allow exposure of the polymer films with an Oriel Instruments flood exposure source with a 1000 W Hg(Xe) lamp filtered to 365 nm light. An exposure dose of 730 mJ/cm² was used for all samples to ensure complete photo-activation of Rhodorsil Faba.

Differential scanning calorimetry (DSC) was performed using a Discovery DSC from TA instruments to investigate phase transition of depolymerized PPHA mixtures. The samples (2 to 10 mg) were sealed in aluminum pans and ramped/cooled at 5° C./min. A nitrogen environment was used at 80 mL/min flow rate for the samples containing 40 wt % BMP, 40 wt % HMP, 40 wt % OMP, and 70 wt % OMP. Each of these samples also had 70 wt % BEHP. Note, these weight percentages are with respect to the PPHA weight. A nitrogen flow rate of 50 mL/min was used for all other samples.

Thermal gravimetric analysis (TGA) was performed on a TA TGA Q50 instrument at a ramp rate of 5° C./min. A nitrogen atmosphere, 40 mL/min flow rate, was used. Dynamic mechanical analysis (DMA) of films was performed on a TA Q800 DMA instrument. Tests were performed at 30° C. with 0.1% strain at 1 Hz in a closed chamber. The samples were 8 mm wide, 30 mm long and about 250 μm thick. Tensile tests were performed with an Instron 5843 at a strain rate of 10% per minute at 21° C. Each sample has a tested length of 10 mm, width between 5.5 and 7.5 mm, and thickness between 0.16 and 0.23 mm.

### 4.2 Results and Discussions

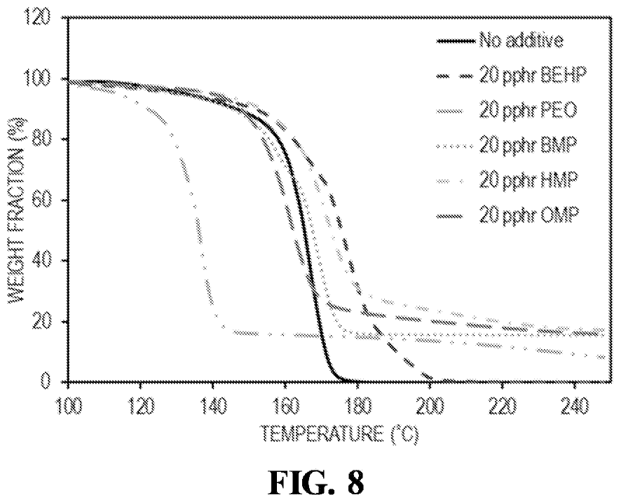

The effect of additives on the thermal stability of PPHA is important because PPHA is sensitive to additives and premature depolymerization is undesirable. The thermal stability of PPHA with addition of 20 pphr plasticizer (both ionic liquid and ether-ester plasticizers) was investigated individually by thermogravimetric analysis (TGA) and shown in FIG. 8. The mass of some of the mixtures did not go to zero at high temperature because of the presence of non-volatile ionic liquids. Table 11 summarizes the onset and endset decomposition temperature of PPHA containing different plasticizers. The rapid degradation of PPHA with no additives occurred at an onset temperature of 158° C., which matches a previous report (A. M. Feinberg, et al., ACS Macro Lett. 7 (2018) 47-52). Most of the ionic liquids had no significant effect on the thermal stability of the PPHA, as shown by the similar decomposition onset temperature and rate of mass change. This shows that PPHA is stable with these ionic liquids. PEO lowered the onset by 32° C., showing that it made PPHA less thermally stable. A qualitative test for pH of PEO using pH test paper showed that it had a pH between 2 and 3 when mixed in water. The acidic nature of PEO contributed to the early depolymerization of PPHA. Nevertheless, all PPHA films containing 20 pphr additive were all stable at room temperature for at least one month.

TABLE 11
TGA results for the onset and endset of depolymerization of PPHA
with 20 pphr loadings of different plasticizers

| | Onset | Endset | Difference |
|---|---|---|---|
| Plasticizer | (° C.) | (° C.) | (° C.) |
| None | 158 | 172 | 14 |
| BEHP | 165 | 187 | 22 |
| PEO | 126 | 140 | 14 |
| BMP | 153 | 174 | 21 |
| HMP | 161 | 179 | 18 |
| OMP | 152 | 168 | 16 |

The onset time for the photo-induced depolymerization of PPHA mixtures was monitored using a quartz crystal microbalance (QCM), as described previously (J. M. Schwartz, et al., J. Appl. Polym. Sci. 136 (2019) 1-7). The increase in resistance in the Butterworth-van Dyke equivalent circuit corresponds to energy loss and softening of the solid polymer film. Table 12 summarizes the photoresponse time for PPHA to degrade after being exposed. PEO had a longer photoresponse time compared to other plasticizers. This is likely due to ether linkages of PEO that compete with the ether linkages in the PPHA backbone for bonding with the photoacid. Other plasticizers show a photoresponse time similar range to that of pure PPHA, indicating that they don't significantly affect the PPHA photoresponse. It was also observed that ionic liquid plasticizers kept the depolymerized PPHA in a liquid state longer than the ether-ester plasticizer after being exposed. This indicates that the ionic liquid has better transient properties compared to the ether-ester plasticizer by forming liquid-state byproducts.

TABLE 12
Photoresponse time for PPHA with various plasticizers at loadings of 20 pphr
after UV exposure from QCM.

| | Photoresponse Time |
|---|---|
| Type of Plasticizer | (seconds) |
| None | 14.0 ± 1.00 |
| BEHP | 19.9 ± 2.90 |
| PEO | 1.44*10³ ± 73.5 |
| BMP | 23.2 ± 0.122 |
| HMP | 25.7 ± 7.60 |
| OMP | 12.6 ± 1.40 |

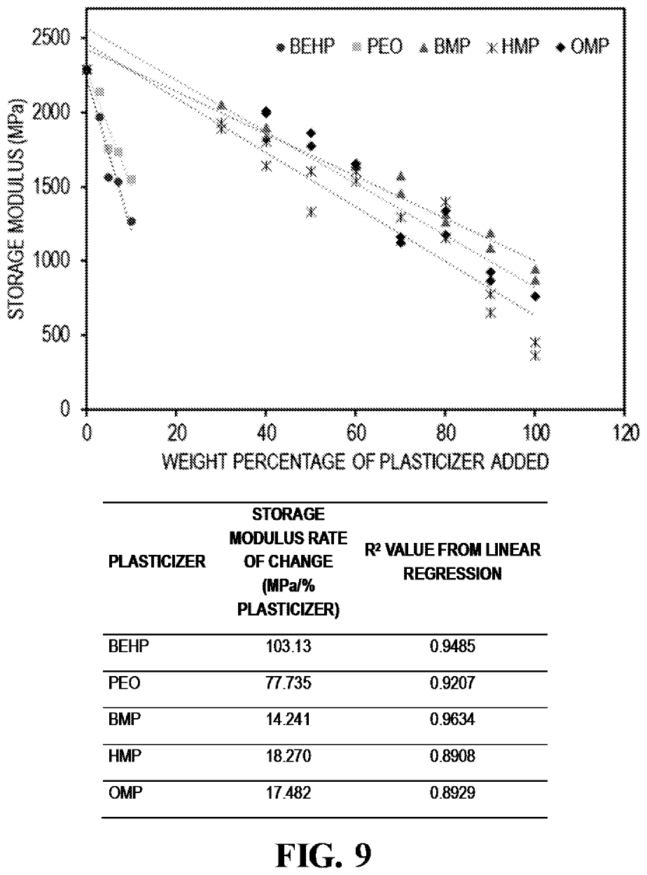

The plasticizing effect of each individual plasticizer on the mechanical properties of PPHA films was investigated. The plasticizers used include BEHP, PEO, BMP, HMP, and OMP. The storage modulus of PPHA films with various amounts of each plasticizer was measured using DMA, as shown in FIG. 9. A linear regression linear fit was made for each plasticizer to estimate the rate of change of the storage modulus with amount of plasticizer. PEO and BEHP plasticizers had a more rapid change in storage modulus with concentration compared to the ionic liquid plasticizers, indicating they are more effective than ionic liquids at loadings below 20 pphr. However, at concentrations greater than 20 pphr, PEO and BEHP plasticizers phase segregated and the films were increasingly cloudy, opaque and brittle. A lesser degree of BEHP phase segregation occurred when high loadings of ionic liquid, particularly OMP, were also mixed with PPHA, as the dried films were transparent. The ionic liquids of interest all show a similar effect on plasticizing the PPHA. HMP has a slightly better plasticizing effect, followed by OMP, and finally BMP. The superior plasticizing effect from HMP is likely due to its lower melting point (−24° C.) than the other ionic liquids. While OMP has a higher melting point than BMP, it has a slightly better plasticizing effect when compared to BMP, likely due to its increased alkyl chain length on the pyrrolidinium cation that enables more conformational changes of OMP's molecular structure.

While ether-ester plasticizers (e.g., PEO and BEHP) have a better plasticizing effect at a concentrations below 20 pphr, the ionic liquid can be added to a higher concentration without causing phase segregation. Moreover, ionic liquids also have superior transient properties for the depolymerized PPHA compared to PEO and BEHP, because they are more miscible with PHA monomer resulting in liquid-state depolymerization byproducts at lower temperatures. Therefore, it is desirable to combine mechanical softening effect of ether-ester plasticizers and the transient advantage of ionic liquid plasticizers to achieve a more versatile PPHA film with better transient properties.

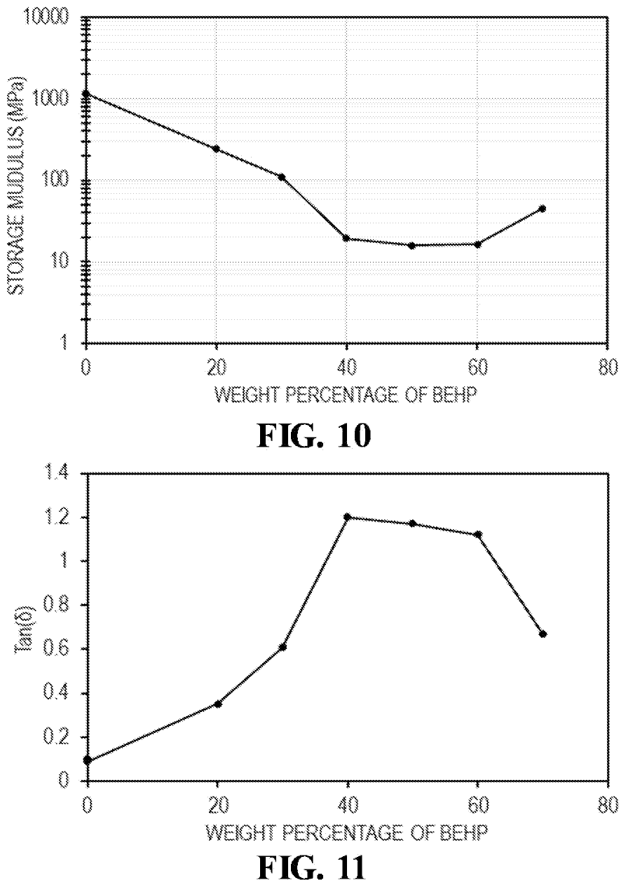

PPHA formulations containing OMP and BEHP plasticizers were made to broaden the mechanical versatility of transient PPHA films. This mixture was chosen because BEHP has the most improved miscibility with PPHA containing OMP. FIG. 10 shows the storage modulus change for a film containing 70 pphr OMP with various loadings of BEHP. The storage modulus dropped initially with increasing BEHP loading until 50 pphr BEHP. The storage modulus then increased at higher BEHP loading. The initial decrease in storage modulus with plasticizer loadings indicates good miscibility between the plasticizers and PPHA. This leads to improved plasticizing effect with addition of more BEHP. Upon addition of 50 pphr BEHP and 70 pphr OMP, the film modulus reached a minimum at about 16 MPa. This film was fully foldable at ambient temperature. BEHP loadings over 50 pphr resulted in a higher modulus due to phase segregation of BEHP from the PPHA matrix. This was evident by the formation of more translucent polymer films at >50 pphr BEHP loading.

Phase segregation can be characterized by analyzing the tan(6) trends of the formulated films with various BEHP loadings, as shown in FIG. 11. Initially, the tan(δ) increased with higher BEHP loadings into the film (which also contained 70 pphr OMP) due to the viscoelastic damping caused by the addition of liquid BEHP plasticizer. Loading over 50 pphr BEHP resulted in the decrease in tan(δ) indicating a lesser degree of viscoelastic damping due to the phase segregation of the plasticizer from the PPHA polymer matrix.

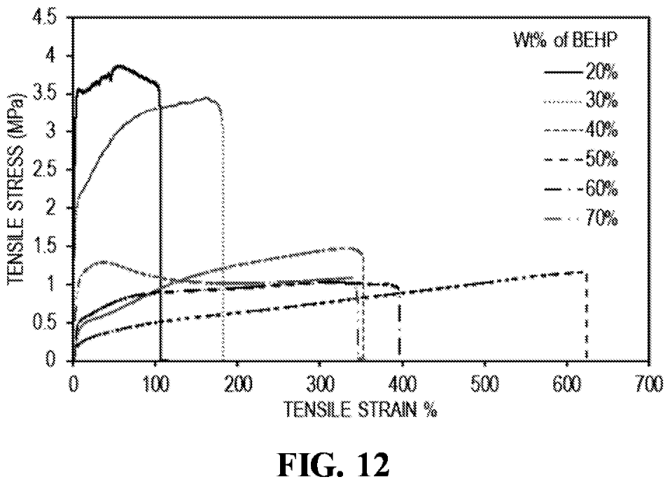

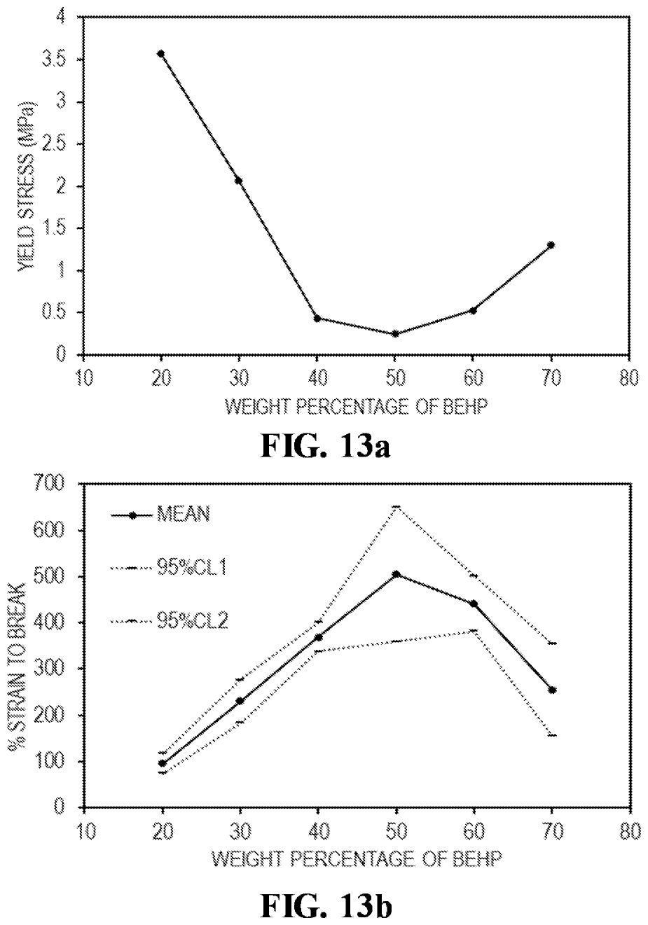

Tensile tests for same sets of films were performed to show the stress-strain behavior of plasticized PPHA films, as shown in FIG. 12. Both yield stress and percentage strain-to-break for films with various amounts of BEHP and 70 pphr OMP were obtained from tensile tests, as shown in FIGS. 13a-13b. The tensile stress decreased initially with added BEHP due to the softening effect of addition of the plasticizer. Similar to the storage modulus measurements from DMA, the tensile stress increased upon addition of >50 pphr BEHP due to the increasing degree of phase segregation of the plasticizers from the PPHA polymer matrix. Similarly, the percent strain-to-break increased initially with BEHP concentration due to the improved physical interaction of polymer chains with the plasticizer until the BEHP loadings reached to 50 pphr. Further addition of BEHP caused phase segregation of the plasticizers from the polymer matrix, resulting in lower strain-to-break values.

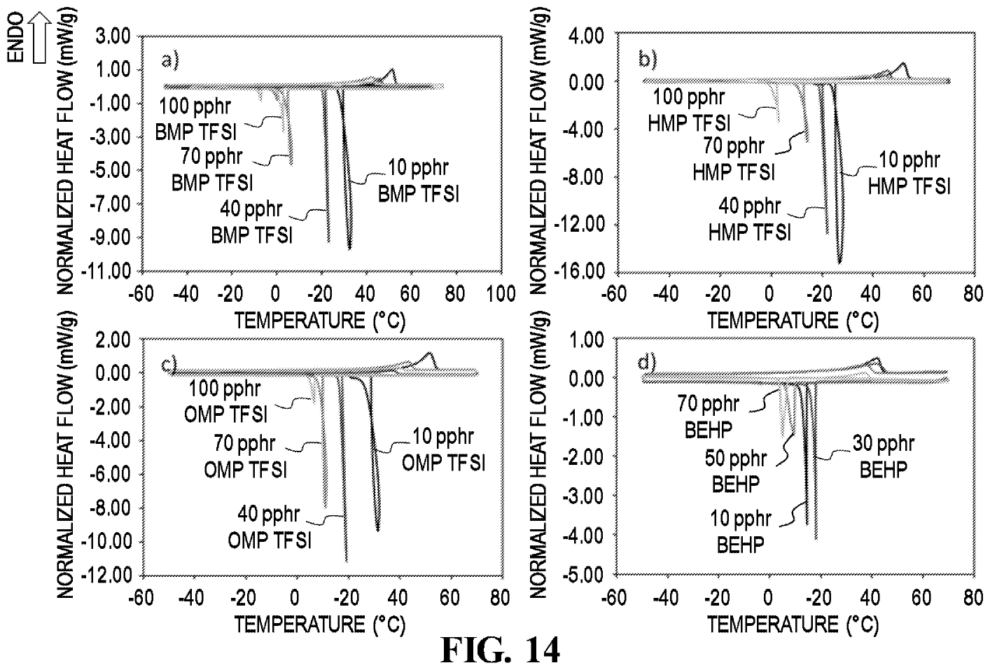

The freezing point and melting point of the depolymerized PPHA mixtures using different alkyl chain length pyrrolidinium TFSI-based ionic liquids were determined using DSC. The phase transition temperatures are helpful in determining the temperature limits for keeping the depolymerization byproducts in the liquid state and achieving acceptable transient properties for absorption into the environment. FIG. 14, panels a-c show DSC measurements for PHA with various loadings of BMP, HMP, and OMP. The freezing point and melting point of the depolymerization byproducts are summarized in Table 13. Increasing the concentration of each ionic liquid decreased both the freezing and melting point of each PHA mixture. The freezing point is always lower than the melting point due to supercooling effects and crystal nucleation effects (C. Schick, et al., J. Phys. Condens. Matter. 29 (2017) 453002 (1-35)). The addition of >70 pphr BMP resulted in a bimodal freezing point peak due to a small degree of solid phase segregation. The addition of >70 pphr HMP and OMP had only a single freezing point peak, indicating they have a better miscibility with the PHA compare to BMP resulting in homogeneous mixtures. FIG. 14, panel d shows the DSC measurement for PHA containing 70 pphr OMP with various BEHP loadings. Increasing the BEHP content at OMP loading increased the freezing point of the products. The freezing point increased from 10.88° C. to 18.10° C. with BEHP content 0 pphr to 30 pphr. This is likely due to the lower concentration of ionic liquid taken per mass of PHA, which is a result of dilution by BEHP. The addition of 50 pphr BEHP resulted in a decreasing freezing point to 9.3° C. The freezing point was further lowered to 5.0° C. with addition to 70 pphr BEHP. Addition of >50 pphr BEHP resulted in a freezing point lower than the 70 pphr OMP only mixture (freezing point=10.9° C.), due to lower freezing point for BEHP.

TABLE 13
Freezing point and melting point for depolymerization mixtures containing
different amount of pyrrolidinium-TFSI based ionic liquids and BEHP.

| Plasticizer | Amount | Freezing Point (° C.) | Melting Point (° C.) |
|---|---|---|---|
| None | None | 28.49 | 54.27 |
| BMP | 10 pphr | 32.40 | 51.44 |
| | 40 pphr | 23.16 | 46.02 |
| | 70 pphr | 6.421 | 42.50 |
| | 100 pphr | 2.952 | 39.05 |
| HMP | 10 pphr | 26.61 | 51.87 |
| | 40 pphr | 22.01 | 45.79 |
| | 70 pphr | 14.15 | 44.00 |
| | 100 pphr | 2.948 | 38.00 |
| OMP | 10 pphr | 31.44 | 51.48 |
| | 40 pphr | 19.15 | 46.80 |
| | 70 pphr | 10.88 | 43.34 |
| | 100 pphr | 6.617 | 39.81 |
| 70 pphr OMP + | 10 pphr BEHP | 14.56 | 42.14 |
| BEHP | 30 pphr BEHP | 18.10 | 41.59 |
| | 50 pphr BEHP | 9.305 | 37.51 |
| | 70 pphr BEHP | 5.001 | 37.52 |

### 4.3. Conclusions

In this study, pyrrolidinium-TFSI ionic liquids were used as a plasticizer to tune and broaden the mechanical properties of PPHA films and simultaneously enhance the phototransience by reducing the melting point of the decomposed, PHA product. The freezing point of the depolymerized product mixture can be maintained below 10° C. while still having a storage modulus >1 GPa. OMP made the most flexible PPHA films due to the longer alkyl chain on the pyrrolidinium cation. It acted to plasticize the cyclic PPHA and improve the solubility of BEHP in the PPHA polymer mixture. The tunable mechanical and transient properties of photodegradable PPHA mixtures allows for its broader application in different transient devices that each require specific mechanical properties at different environmental conditions.

### Example 5: Effect of Surface Substrate on Protection by Copolymer

c-Si wafers were cleaned by dipping in 1:100 hydrofluoric acid solution for 2 min Two sets of substrates were prepared. A set of samples was made by coating a bare Si wafer with PPHA-heptanal (HA) copolymer. The PPHA-HA copolymer was 3 mol % heptanal and 97 mol % phthalaldehyde. The molecular weight was 145 kg/mol. The coating thickness on the silicon was 35 nm. The samples were prepared in air and dried for 24 hours. A companion set of samples was made by coating silicon with copolymer (˜35 nm thickness) in a glove box and allowed to sit for 24 hours. The PPHA was washed away with dichloromethane. All substrates were loaded onto an XPS stage in a nitrogen glovebox to minimize ambient exposure.

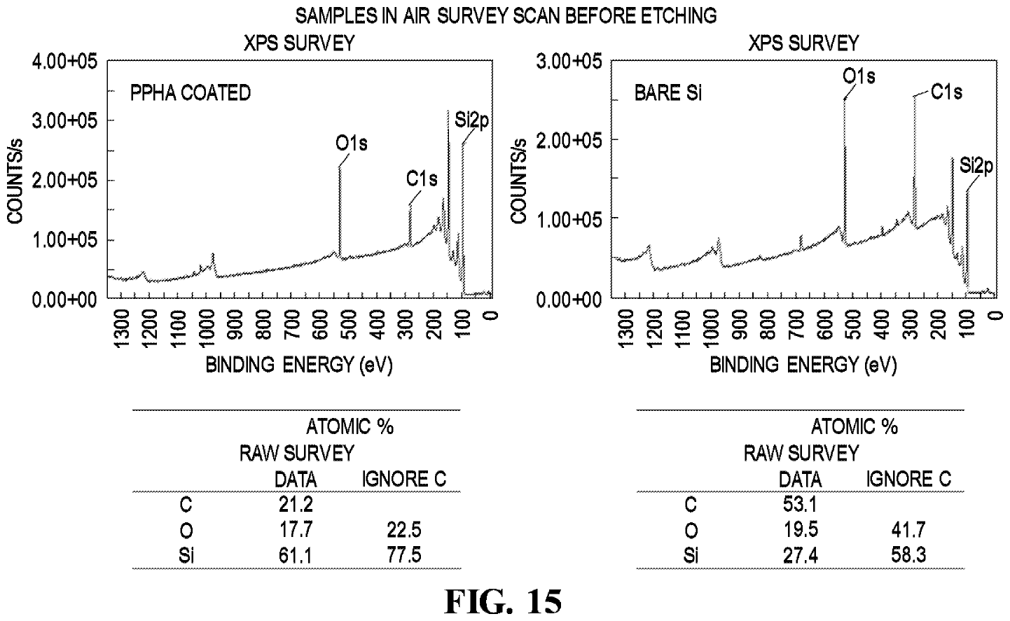

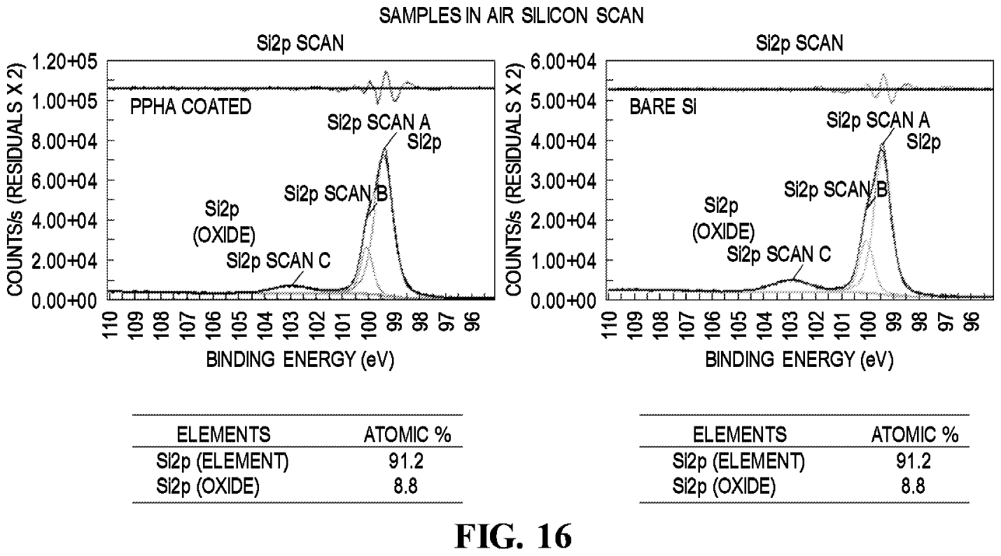

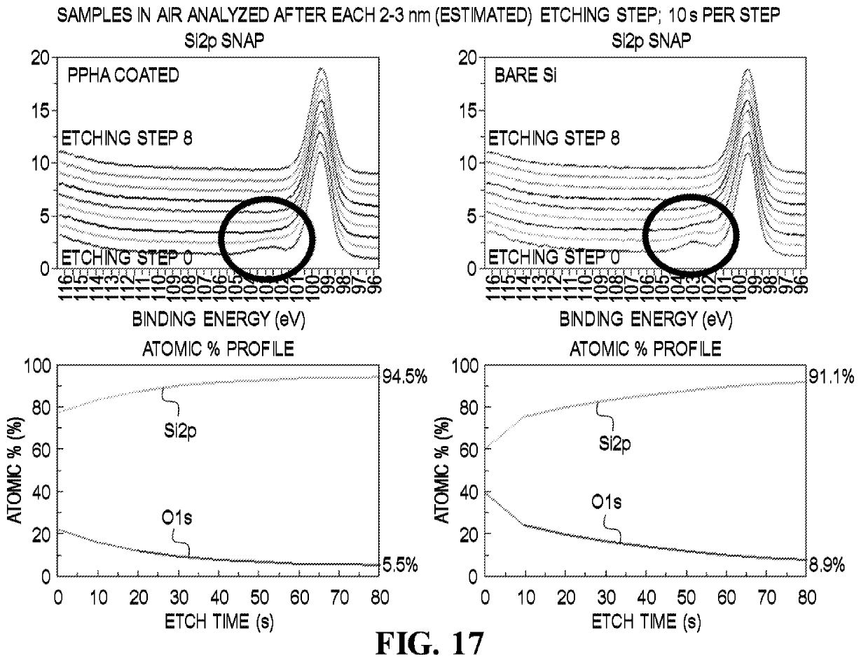

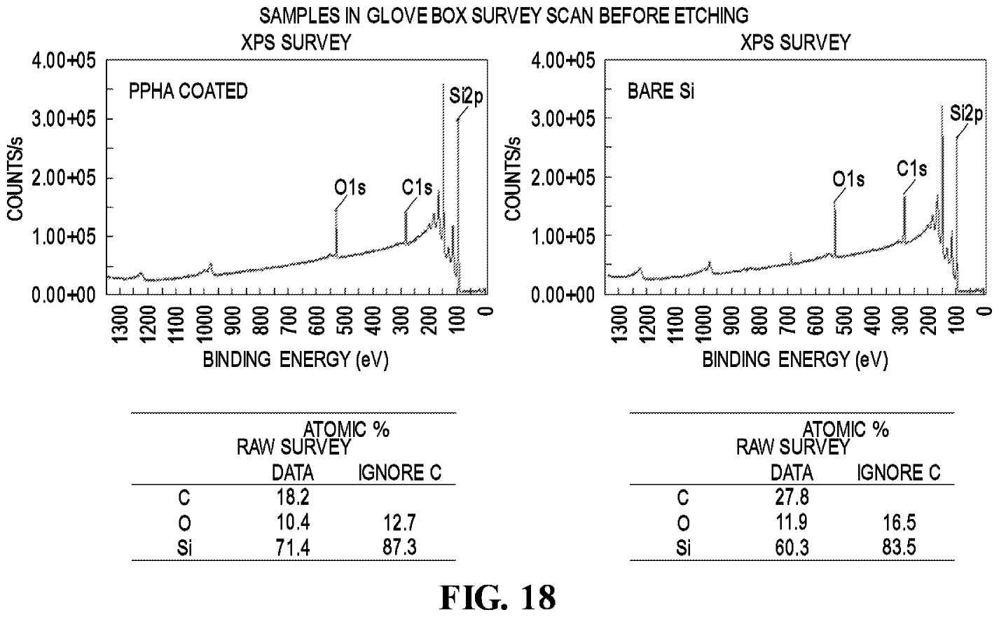

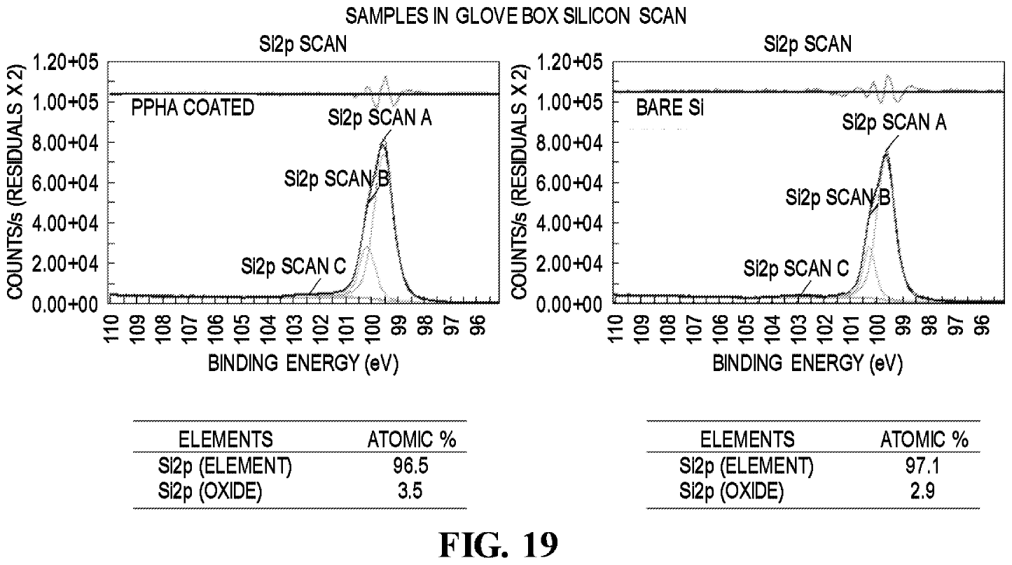

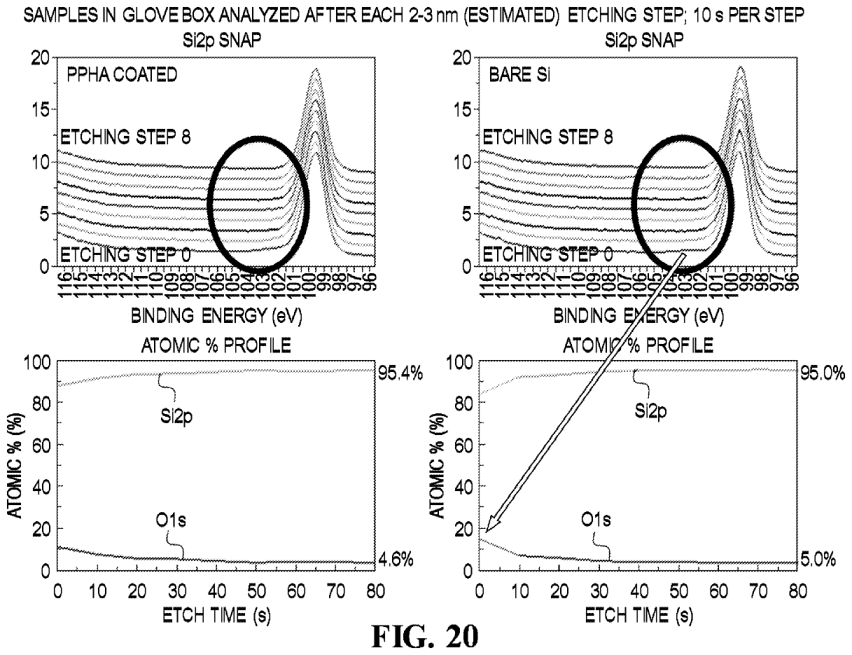

FIGS. 15-16 (air) and FIGS. 18-19 (glove box) show the amount of elemental Si and Si oxide in each wafer. FIG. 17 (air) and FIG. 20 (glove box) show the depth of the oxide layer as determined after repeated etching steps. The results demonstrate that PPHA copolymer can be used to reduce oxidation of a c-Si wafer by inhibiting oxygen and water permeation.

### Example 6: Thickness Dependence of Copolymer on Si—Ge Substrates

Si—Ge (75% Ge) wafers were cleaned by dipping in 1:50 hydrofluoric acid solution for 2 min. The PPHA-HA copolymer had 11 mol % HA and had a molecular weight of 71 kg/mol. It was dissolved in diglyme at 50 mg/ml. Wafers were coated with different thickness films—bare and spin-cast at 1000, 2000, and 3000 rpm, producing films of 0, 210, 270, and 400 nm thickness, respectively. The substrates were stored in the dark with a petri dish of water in a container for 5 days before X-ray photoelectron spectroscopy. The PPHA was washed away with dichloromethane.

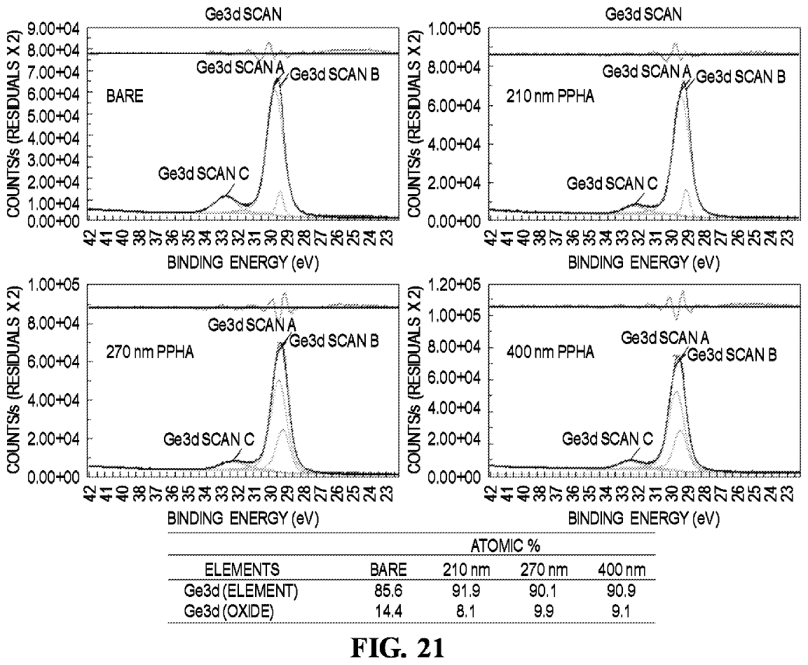

FIG. 21 shows the amount of elemental Ge and Ge oxide in each wafer. The results demonstrate that PPHA copolymer can be used to reduce oxidation of a Si—Ge wafer by inhibiting oxygen and water permeation. The thickness of the film (200-400 nm) did not play a role in the barrier effectiveness.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A composition comprising:
a) a copolymer, wherein the copolymer comprises a repeating unit as shown in Formula I: 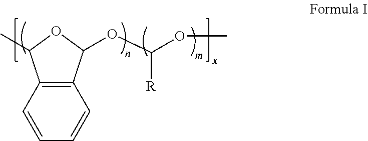
wherein R is substituted or unsubstituted C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R is substituted with C₁-C₂₀ alkyl, C₁-C₂₀ alkoxy, C₂-C₂₀ alkenyl, alkynyl, C₆-C₁₀ aryl, C₆-C₁₀ heteroaryl, aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
m is 1 to 100,000;
n is 1 to 100,000; and
x is 1 to 100,000;
b) a plasticizer; and
c) an ionic liquid, wherein the ionic liquid has a weight percent of at least about 40% with respect to the weight of the copolymer.

2. The composition of claim 1 wherein the plasticizer is an ether-ester plasticizer, e.g., bis(2-ethylhexyl) phthalate.

3. (canceled)

4. The composition of claim 1, wherein the ionic liquid has a cation selected from imidazolium, alkyl-imidazole, alkyl-ammonium, alkyl-sulfonium, alkyl-piperidinium, alkyl-pyridinium, alkyl-phosphonium, and alkyl-pyrrolidinium, and an anion selected from carboxylate, halide, fulminate, azide, persulfate, sulfate, sulfites, phosphates, phosphites, nitrate, nitrites, hypochlorite, chlorite, bicarbonates, imides, sulfonimides, and borates, e.g., wherein the ionic liquid is 1-butyl-1-methylpyrrolidinium bis(trifluoromethylsulfonyl)imide) (BMP), 1-hexyl-1-methylpyrrolidinium bis(trifluoromethylsulfonyl)imide (HMP), or 1-methyl-1-octylpyrrolidinium bis(trifluoromethylsulfonyl)imide (OMP).

5. (canceled)

6. A film comprising a copolymer, wherein the copolymer comprises a repeating unit as shown in Formula I: 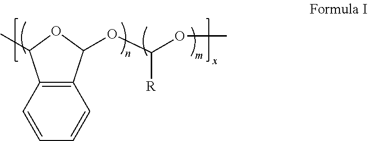
wherein R is substituted or unsubstituted C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R is substituted with C₁-C₂₀ alkyl, C₁-C₂₀ alkoxy, C₂-C₂₀ alkenyl, alkynyl, C₆-C₁₀ aryl, C₆-C₁₀ heteroaryl, aldehyde, amino, sulfonic acid, sulfinic acid, fluoroacid, phosphonic acid, ether, halide, hydroxy, ketone, nitro, cyano, azido, silyl, sulfonyl, sulfinyl, or thiol;
m is 1 to 100,000;
n is 1 to 100,000; and
x is 1 to 100,000.

7-9. (canceled)

10. The film of claim 6, wherein the copolymer is synthesized from a hydrophobic aldehyde monomer, e.g., 4-chlorobutanal or 2,2-dichlorobutanal.

11. (canceled)

12. The film of claim 6, wherein the copolymer is synthesized from a volatile aldehyde monomer.

13. The film of claim 6, wherein the film further comprises at least one additional polymer, e.g., polyvinyl chloride.

14. (canceled)

15. The film of claim 6, wherein the film further comprises at least one plasticizer, e.g., an ether-ester plasticizer, e.g., bis(2-ethylhexyl) phthalate.

16-17. (canceled)

18. The film of claim 15, wherein the film further comprises at least one ionic liquid.

19. (canceled)

20. The film of claim 18, wherein the ionic liquid has a cation selected from imidazolium, alkyl-imidazole, alkyl-ammonium, alkyl-sulfonium, alkyl-piperidinium, alkyl-pyridinium, alkyl-phosphonium, and alkyl-pyrrolidinium, and an anion selected from carboxylate, halide, fulminate, azide, persulfate, sulfate, sulfites, phosphates, phosphites, nitrate, nitrites, hypochlorite, chlorite, bicarbonates, sulfonimides, imides, and borates, e.g., wherein the ionic liquid is 1-butyl-1-methylpyrrolidinium bis(trifluoromethylsulfonyl)imide) (BMP), 1-hexyl- 1-methylpyrrolidinium bis(trifluoromethylsulfonyl)imide (HMP), or 1-methyl-1-octylpyrrolidinium bis(trifluoromethylsulfonyl)imide (OMP).

21. (canceled)

22. The film of claim 18, wherein the film has an elastic modulus of at least about 2 MPa and/or less than about 20 MPa.

23. (canceled)

24. The film of claim 6, wherein the film further comprises fibers to reinforce the film, e.g., wherein the fibers are inorganic (e.g., glass or carbon) fibers and/or polymeric (e.g., acrylic) fibers.

25. (canceled)

26. The film of claim 6, wherein the film further comprises particles to reinforce the film, e.g., inorganic particles or organic particles.

27. (canceled)

28. The film of claim 6, wherein the film is a composite film comprising two or more layers.

29-33. (canceled)

34. The film of claim 6, wherein the copolymer is cyclic and has Formula II: 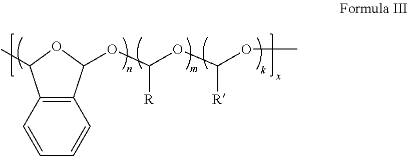
wherein R and R′ are different; and R′ is chosen from substituted or unsubstituted
C₁-C₂₀ alkyl, C₁-C₂₀ alkoxyl, C₂-C₂₀ alkenyl, alkynyl, C₆-C₁₀ aryl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R′ is substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, amino, carboxylic acid, sulfonic acid, sulfinic acid, fluoroacid, phosphoric acid, ester, ether, halide, hydroxy, ketone, nitro, cyano, azido, silyl, sulfonyl, sulfinyl, or thiol;
k is 1 to 100,000;
in is 1 to 100,000;
n is 1 to 100,000; and
x is 1 to 100,000.

35-36. (canceled)

37. The film of claim 6, wherein the copolymer is a copolymer of phthalaldehyde monomers and one or more of acetaldehyde, propanal, butanal, pentanal, hexanal, heptanal, octanal, nonanal, decanal, undecanal, propenal, butenal, pentenal, hexenal, heptenal, octenal, nonenal, decenal, and undecenal.

38-42. (canceled)

43. The film of claim 6, further comprising a freezing point depressing agent, e.g., an adipate, azelate, citrate, ether-ester, glutarate, isobutyrate, phosphate, sebacate, tertiary amine, quaternary ammonium compound, diethylene glycol dibenzoate, dipropylene glycol dibenzoate, tripropylene glycol dibenzoate, butyl benzyl phthalate, phosphonium compound, sulfonium compound, or any combination thereof.

44. (canceled)

45. The film of claim 6, further comprising a chemical amplifier, e.g., an acid amplifier, e.g., wherein the acid amplifier has Formula IV: 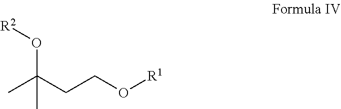
where R₁ is a sulfonic ester, fluoro ester, or carbonic ester; and R₂ is a trigger moiety that comprises hydroxyl, methoxy, acetate, carbonic ester, sulfonic ester, or fluoro ester groups.

46-47. (canceled)

48. The film of claim 6 further comprising a crosslinking agent, e.g., wherein the crosslinking agent comprises a thiol or electrophilic group.

49. (canceled)

50. The film of claim 6, further comprising a crosslinking catalyst.

51. The film of claim 6, further comprising a free radical initiator.

52. A device comprising a surface, wherein the surface is at least partially coated with the film of claim 6, wherein said film may be later removed.

53-54. (canceled)

55. A method of transiently protecting a surface from chemical and or physical modification, comprising coating at least part of the surface with the film of claim 6.

56-77. (canceled)
